(19) United States
(12) Patent Application Publication
(10) Pub. No.: US 2025/0007689 A1
(43) Pub. Date: Jan. 2, 2025

(54) SYSTEM, METHOD AND APPARATUS FOR TOTAL STORAGE ENCRYPTION

(71) Applicants: Ido OUZIEL, Portland, OR (US); Barry E. HUNTLEY, Hillsboro, OR (US); Gilbert NEIGER, Portland, OR (US)

(72) Inventors: Ido OUZIEL, Portland, OR (US); Barry E. HUNTLEY, Hillsboro, OR (US); Gilbert NEIGER, Portland, OR (US)

(21) Appl. No.: 18/375,367

(22) Filed: Sep. 29, 2023

Related U.S. Application Data
(60) Provisional application No. 63/524,159, filed on Jun. 29, 2023.

(51) Int. Cl. H04L 9/06; H04L 9/32

(52) U.S. Cl. CPC H04L 9/0618; H04L 9/0643; H04L 9/3271

(57) ABSTRACT

Examples of support for an instruction allowing for the binding of a platform key to a binary large object (BLOB) are described. In some examples, support is in the form of decoder circuitry to decode an instance of a single instruction, the instance of the single instruction to include an opcode that is to indicate to execution circuitry to perform a binding of information to a platform by encrypting at least a portion of information of an input data structure with a platform-specific wrapping key; and execution circuitry to execute the decoded instance of the single instruction according to the opcode to generate and store an output data structure.

### FIELD

The instant disclosure generally relates to system, method and apparatus for total storage encryption. In one embodiment, the disclosure provides method, system and apparatus for inline encryption mechanism for data stored on non-volatile memory devices.

### BACKGROUND

A system on chip (SOC) is an integrated circuit that integrates all components of a computer or other electronic system. These components include a central processing unit (CPU), memory, input/output (IO) ports and secondary storage, which are all included on a single substrate or microchip. Additionally, SOCs enable the integration of third part components via a standardized on-die interconnect protocol. Such third part components may include non-volatile memory (NVM). There is a need to protect data stored at the NVM (e.g., data at rest).

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 schematically illustrates an exemplary embodiment of a computing device for implementing a disclosed embodiment;

FIG. 2 schematically illustrates an exemplary system topology according to an embodiment of the disclosure;

FIG. 3A illustrates a system architecture for a memory read process at line speed;

FIG. 3B illustrates a system architecture for a memory write process at line speed;

FIG. 4A shows an exemplary inline encryption for writing data onto an NVMe SSD;

FIG. 4B shows an exemplary inline decryption process for writing data onto a memory module external to the NVMe;

FIG. 5 illustrates a key lookup table according to one embodiment of the disclosure in which a single Key Id is used;

FIG. 6 schematically illustrates an exemplary key look up process according to one embodiment of the disclosure.

FIG. 7 schematically illustrates a dual encryption technique according to one embodiment of the disclosure;

FIG. 8A is an exemplary decryption flow diagram according to one embodiment of the disclosure;

FIG. 8B is an exemplary encryption flow diagram according to one embodiment of the disclosure;

FIG. 9 shows an exemplary system for file encryption using inline cryptography according to one embodiment of the disclosure;

FIG. 10 shows sample information for a NVMe command associated with a read operation or a write operation, which may be used in one or more embodiments;

FIG. 11 illustrates a sample PCIe TLP (Transaction Layer Packet), according to an embodiment;

FIG. 12 illustrates information regarding various fields of the TLP of FIG. 11, according to an embodiment;

FIG. 13 is a flow diagram of AES-GCM operations, which may be applied in one or more embodiments;

FIG. 14 illustrates an extended encryption table, according to an embodiment;

FIG. 15 shows a circuit diagram of a coarse-grained separation between an AES-XTS engine and an AES-GCM engine, according to an embodiment; and

FIG. 16 illustrates a transfer format of a buffer, according to an embodiment.

FIG. 17 illustrates examples of instruction execution.

FIG. 18 illustrates an example computing system.

FIG. 19 illustrates a block diagram of an example processor and/or System on a Chip (SoC) that may have one or more cores and an integrated memory controller.

FIG. 20 is a block diagram illustrating a computing system 2000 configured to implement one or more aspects of the examples described herein.

FIG. 21A illustrates examples of a parallel processor.

FIG. 21B illustrates examples of a block diagram of a partition unit.

FIG. 21C illustrates examples of a block diagram of a processing cluster within a parallel processing unit.

FIG. 21D illustrates examples of a graphics multiprocessor in which the graphics multiprocessor couples with the pipeline manager of the processing cluster.

FIGS. 22A-22C illustrate additional graphics multiprocessors, according to examples.

FIG. 23 shows a parallel compute system 2300, according to some examples.

FIGS. 24A-24B illustrate a hybrid logical/physical view of a disaggregated parallel processor, according to examples described herein.

FIG. 25(A) is a block diagram illustrating both an example in-order pipeline and an example register renaming, out-of-order issue/execution pipeline according to examples.

FIG. 25(B) is a block diagram illustrating both an example in-order architecture core and an example register renaming, out-of-order issue/execution architecture core to be included in a processor according to examples.

FIG. 26 illustrates examples of execution unit(s) circuitry, such as execution unit(s) circuitry.

FIG. 27 is a block diagram of a register architecture according to some examples.

FIG. 28 illustrates examples of an instruction format.

FIG. 29 illustrates examples of an addressing information field.

FIG. 30 illustrates examples of a first prefix.

FIGS. 31(A)-(D) illustrate examples of how the R, X, and B fields of the first prefix are used.

FIGS. 32(A)-(B) illustrate examples of a second prefix.

FIG. 33 illustrates examples of a third prefix.

FIGS. 34A-34B illustrate thread execution logic including an array of processing elements employed in a graphics processor core according to examples described herein.

FIG. 35 illustrates an additional execution unit, according to an example.

FIG. 36 is a block diagram illustrating a graphics processor instruction formats 3600 according to some examples.

FIG. 37 is a block diagram of another example of a graphics processor.

FIG. 38A is a block diagram illustrating a graphics processor command format according to some examples.

FIG. 38B is a block diagram illustrating a graphics processor command sequence according to an example.

FIG. 39 is a block diagram illustrating the use of a software instruction converter to convert binary instructions in a source ISA to binary instructions in a target ISA according to examples.

FIG. 40 is a block diagram illustrating an IP core development system 4000 that may be used to manufacture an integrated circuit to perform operations according to some examples.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

NVMe (Non-Volatile Memory express) devices store data at rest (i.e., persistently) and this data has to be encrypted for security. In order to perform encryption in the System on Chip (“SoC”), the cryptographic (also referred to herein as “crypto” interchangeably) controller responsible for encryption in the SoC needs multiple pieces of information regarding the NVMe device including the LBA (Logical Block Address) of the NVMe device where the data is being stored. While some embodiments herein are discussed with reference to an NVMe, embodiments are not limited to NVMe and other types of non-volatile memory may be used.

In various implementations, the information regarding the NVMe device may not be communicated to the host or the crypto controller in the DMA (Direct Memory Access) path.

In other words, when the drive performs a DMA operation, it may not send this information to the host. Most NVMe drives used in personal computers have to use the PCIe (Peripheral Component Interface express (e.g., as maintained and developed by the PCI-SIG (PCI Special Interest Group)) protocol), and the PCIe protocol headers do not provide any mechanism for the drive to send additional information. This makes the problem of inline encryption using NVMe drives very tricky. As discussed herein, inline encryption implies that the encryption and decryption are happening when the data is being read/written from the drive to DRAM or vice-versa. This is in contrast to lookaside encryption, where the NVMe controller writes data to memory and then some other agent reads plaintext data from memory, encrypts it and writes it back to memory or reads ciphertext from memory, decrypts it and writes plaintext to memory. As a result, the drive may not provide the information for encryption.

Total Storage Encryption (TSE) is an architecture that allows encryption of storage at high speed. TSE provides one or more of the following capabilities:
Protection (confidentiality) of data at rest in storage.
NIST Standard AES-XTS Encryption.
A mechanism for software to configure hardware keys (which are not software visible) or software keys.
A consistent key interface to the crypto engine.

Keys for TSE can be programmed directly in plain text or through wrapped Binary Large Objects (BLOBs).
Direct programming: Software programs keys after reset to the TSE engine using a structure in memory. Keys may be exposed in memory.
Wrapped BLOB programming: Wrapped-key BLOBs are generated once at provisioning time, persist across boots and are used directly to program the TSE engine without unwrapping/recovering keys in software.

In some examples, a Platform Bind Key BLOB (PBNDKB) instruction allows software to wrap secret information with a platform-specific wrapping key and bind it to the TSE engine.

A PCONFIG instruction allows software to program keys to the TSE engine either directly from memory or using PBNDKB-generated wrapped BLOBs. The PCONFIG instruction is also used to program a MKTME engine in some examples.

In some examples, CPUID enumerates the existence of the IA32_TSE_CAPABILITY MSR and the PBNDKB instruction. A IA32_TSE_CAPABILITY MSR enumerates supported cryptographic algorithms and keys. For example, if CPUID.(EAX=07H, ECX=1):EBX.TSE[bit 11=1, the processor supports the IA32_TSE_CAPABILITY MSR and the PBNDKB instruction.

TSE is assigned a PCONFIG target identifier. The current PCONFIG target identifiers are as follows:
0: Invalid Target ID
1: MKTME
2: TSE
If TSE is supported on the platform, CPUID.PCONFIG_LEAF will enumerate TSE as a supported target in sub-leaf 0,
ECX=TSE:
TSE_KEY_PROGRAM leaf is available when TSE is enumerated by PCONFIG as a target.
TSE_KEY_PROGRAM_WRAPPED is available when TSE is enumerated by PCONFIG as a target.

The TSE_CAPABILITY MSR (9F1H) enumerates the supported capabilities of TSE. It has the fields shown in Table 11-1.

| Bit | Description |
|---|---|
| 15:0 | Supported encryption algorithms |
| 23:16 | TSE Engine Key Sources Supported |
| 35:24 | Reserved |
| 50:36 | TSE_MAX_KEYS (Indicates the maximum number of keys |
| | that are available |
| 63:51 | Reserved |

In some examples, TSE is supported in virtual environments (e.g., VMX). In some examples, an execution control called “enable PBNDKB” is added to support TSE in bit 9 of the tertiary processor-based execution controls field of a virtual machine control structure (VMCS). If this control is zero, then any execution of the PBNDKB instruction causes an invalid-opcode exception (#UD).

Support for “enabled PBNDKB” may be indicated by bit 9 of the IA32_VMX_PROCBASED_CTLS3 MSR (index 492H). If bit 9 is clear in the IA32_VMX_PROCBASED_CTLS3 MSR, then VM entry fails if “enable PBNDKB” and the “activate tertiary controls” primary processor-based VM-execution control are both 1.

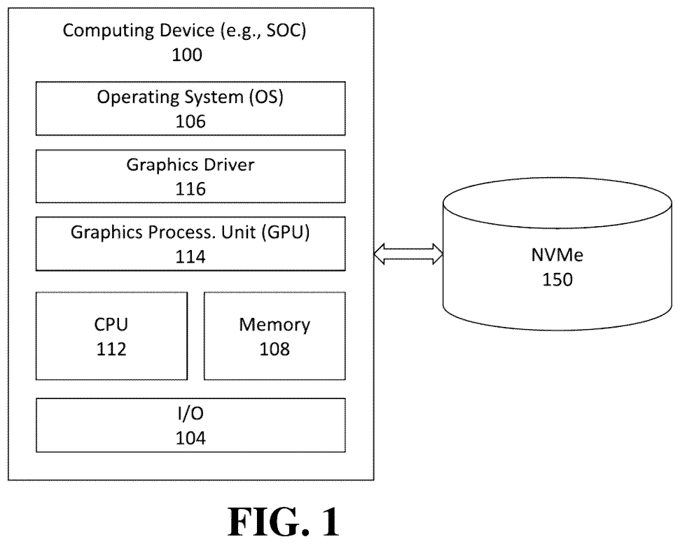

FIG. 1 schematically illustrates an exemplary embodiment of a computing device for implementing a disclosed embodiment. In FIG. 1, computing device 100 comprises a computer platform hosting an integrated circuit (“IC”), such as a SoC, integrating various hardware and/or software components of computing device 100 on a single chip. As illustrated, in one embodiment, computing device 100 may include any number and type of hardware and/or software components, such as (without limitation) graphics processing unit 114 (“GPU” or simply “graphics processor”), graphics driver 116 (also referred to as “GPU driver”, “graphics driver logic”, “driver logic”, user-mode driver (UMD), UMD, user-mode driver framework (UMDF), UMDF, or simply “driver”), central processing unit 112 (“CPU” or simply “application processor”), memory 108, network devices, drivers, or the like, as well as input/output (I/O) sources 104, such as touchscreens, touch panels, touch pads, virtual or regular keyboards, virtual or regular mice, ports, connectors, etc. Computing device 100 may include operating system (OS) 106 serving as an interface between hardware and/or physical resources of computing device 100 and a user. SOC 100 may optionally communicate with NVM 150. Non-volatile memory 150 may be accessed using non-volatile memory express which is the protocol for accessing high-speed storage media. NVMe is used herein to reference both the non-volatile memory (e.g., SSD) and its communication protocol.

It should be noted that FIG. 1 illustrates an exemplary embodiment and additional components may be included without departing from the disclosed principles. For example, embodiments may be implemented as any or a combination of: one or more microchips or integrated circuits interconnected using a motherboard, hardwired logic, software stored by a memory device and executed by a microprocessor, firmware, an application specific integrated circuit (ASIC), and/or a field programmable gate array (FPGA). The terms “logic”, “module”, “component”, “engine”, and “mechanism” may include, by way of example, software or hardware and/or a combination thereof, such as firmware. Additional embodiments may be implemented using one or more memory chips, controllers, CPUs (Central Processing Unit), microchips or integrated circuits interconnected using a motherboard, an application specific integrated circuit (ASIC), and/or a field programmable gate array (FPGA). The term “logic” may include, by way of example, software or hardware and/or combinations of software and hardware.

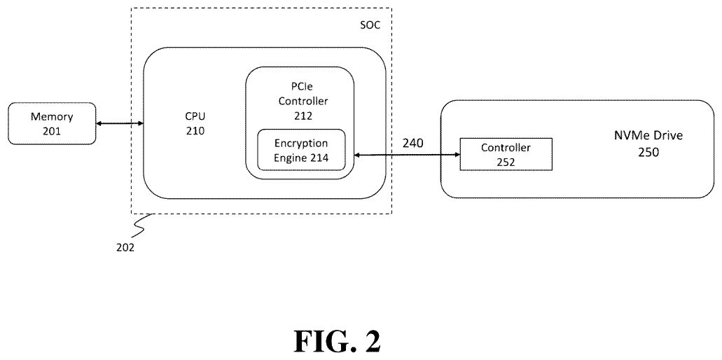

FIG. 2 schematically illustrates an exemplary system topology according to an embodiment of the disclosure. CPU 210 of FIG. 2 includes PCIe controller 212 which in turn comprises encryption engine 214. PCIe 210 conventionally defines an interface standard for connecting high-speed components such as NVMe. As shown, PCIe controller 212 includes encryption engine 214 for encrypting/decrypting inbound and outbound communications. CPU 210 communicates with peripheral component (i.e., NVMe drive 250) through PCIe controller 212. NVMe controller 252 acts as the portal to NVMe driver and may include additional components (not shown) to encrypt/decrypt the inbound/outbound communications. Communications between CPU 210 and NVMe 250 are considered inline communications.

Inline encryption for NVMe drives raises a challenge which is unique to the NVMe drivers. In the exemplary embodiment of FIG. 2, the challenge is that NVMe drive 250 includes NVMe controller 252 in the driver itself. As a result, inline encryption engine 214 in the SOC 202 lacks the required metadata to decide which of the packets must be encrypted/decrypted and the key/tweak material required for their encryption.

Conventional storage device encryption methodologies include XTS-AES standards which use a tweak. In such methodologies, the tweak is generated using Logical Block Address (LBA) and the challenge is that the host does not receive the block address from the drive in the direct memory access (DMA) path. The LBA is managed by the drive internally. A second challenge is that the commands that go to the drive cannot be encrypted since they must be parsed and executed by the drive. As a result, the inline encryption in SoC (i.e., encryption engine 214) needs a mechanism to parse the packets and figure out which ones are data packets and which ones are command packages.

In one embodiment, this deficiency is addressed by generating one or more command streams by NVMe drive (interchangeably, the “driver”). The command streams may comprise LBA to Physical Address mapping. The driver that is generating the command steam may also generate a table for optimized lookup during the DMA transaction. The table may comprise of the block addresses to be used in the tweak generation, the index of the key and other parameters. In one embodiment, the software generates the tweak table using the tweak table interface of the Crypto Controller. The tweak table may be updated per transaction. An inline cryptographic controller (having processor and memory circuitries) that resides in the SoC and can lookup the table at line speeds to obtain the data needed as an input to the encryption/decryption engine. This enables the inline crypto controller to perform the encryption between the NVMe drive (the driver) and the memory at line speeds, for example, according to the PCIe, Gen. 5, standards.

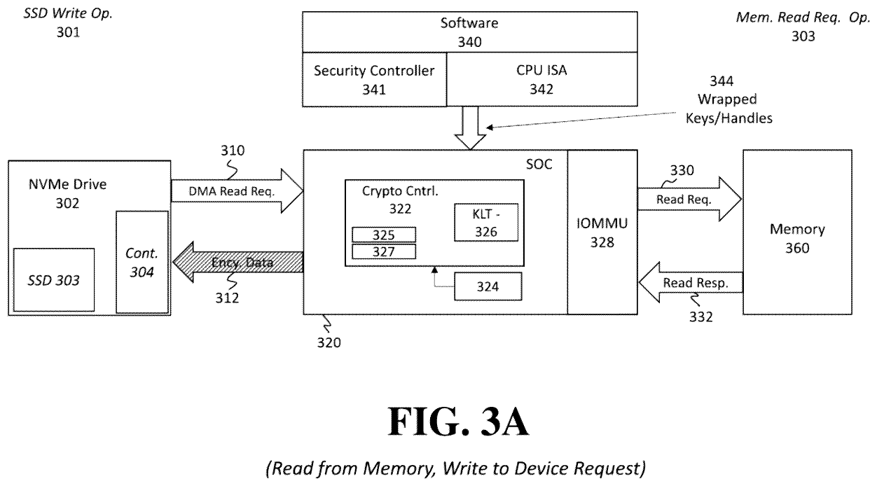

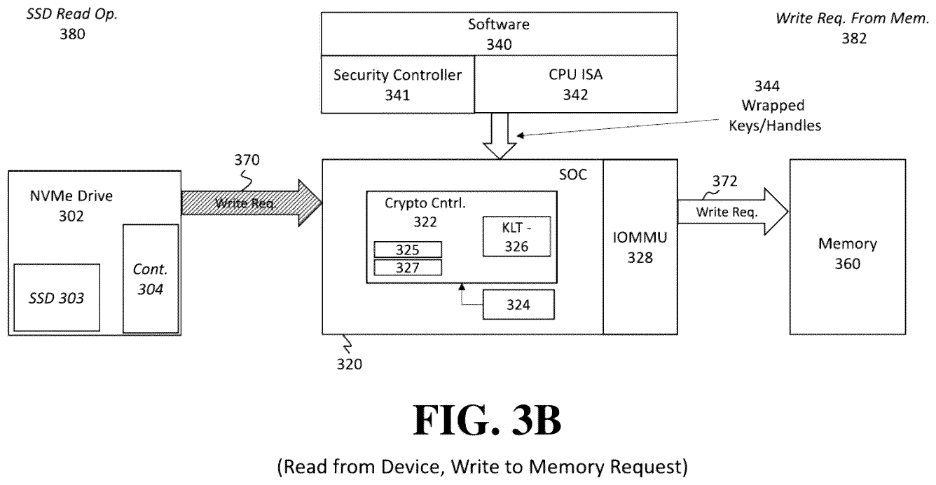

Thus, an embodiment of the disclosure is directed to an inline cryptographic controller which is integrated with an SOC and is placed in the DMA path of the NVMe Drive. The encryption and decryption of data is implemented inside the SOC. FIGS. 3A and 3B illustrate system architecture for memory access at line speeds according to an embodiment of the disclosure.

Specifically, FIG. 3A illustrates a system architecture for a memory read process at line speed as used to read from memory and write to device request. Referring to FIG. 3A, NVMe drive 302 may comprise a solid state drive (SSD) which is transacting a write operation 301 on memory 360 as denoted by memory read operation 303. Memory 360 may comprise a Dynamic Random Access Memory (DRAM).

Conventional SSDs read and write data to a substrate of interconnected flash memory chips which are fabricated in silicon. NVMe SSDs have been gaining popularity due to their speed. NVMe SSDs use NVMe Host Controller Host Controller Interface Specification (NVMHCIS) (not shown) for accessing non-volatile storage media attached via PCIe bus (not shown).

Referring again to FIG. 3A, NVMe drive 302 may require direct memory access (DMA) to memory 360 in order to obtain data. To this end, NVMe drive 302 issues DMA Read Request 310 to SOC 320. The DMA Read Request 310 need not be encrypted.

SOC 320 is interposed between NVMe drive 302 and memory 360. Memory 360 may comprise a Dynamic Random Access Memory (DRAM). SOC 320 is shown with Cryptographic Controller (Crypto Controller) 322, hardware key engine 324 and Input/Output Memory Management Unit (IOMMU) 328. Hardware key engine receives its keys from the CPU ISA 340 (as programmed by software) or from a security controller.

Crypto Controller 322 may comprise one or more processor circuitries and components. In one embodiment, Crypto Controller 322 comprises encryption/decryption engine 325 configured to encrypt or decrypt data according to instructions stored at the crypto memory circuitry and/or lookup tables. Crypto Controller 322 also comprises Key Lookup Table (KLT) 326. KLT 326 is a memory circuitry used to store various lookup tables as further described below.

Crypto Controller 322 may optionally include memory 327. Memory 327 may comprise one or more Static Random Access Memory (SRAM) circuitries in communication with processor circuitries of Crypto Controller 322. Memory circuitry 327 may store one or more instructions to cause the one or more processor circuitries (not shown) in Crypto Controller 322 to execute a plurality of desired tasks. The tasks, may include, for example, receipt and storing of cryptographic information required to encrypt or decrypt data, forming data and/or key tables and communicating encrypted or decrypted data with components external to the SOC 320. Once formed, such tables may be stored at Key Lookup Table (KLT) 326. In one embodiment, the Crypto Memory Circuitry 327 may include KLT 326. In another embodiment the KLT may be in DRAM 360 and the memory 327 inside the crypto controller may serve as a cache.

For simplicity, the following exemplary embodiments reference Crypto Controller 322 generically to include encryption/decryption engine 325 and Memory 327, where applicable.

Crypto controller 322 also includes Input/Output Memory Management Unit (IOMMU) 328 which connects a DMA-capable I/O bus to external Memory 360. In one embodiment, the IOMMU will be inside the SoC 320 but not inside the crypto controller 322. The crypto controller will be between the IOMMU and the memory 360.

Software 340 interfaces SOC 320 via CPU Instruction Set Architecture (ISA) 342. ISA 342 acts as an interface between Software 340 and SoC 320. In one embodiment, Software 340 supports multiple encryption keys. Software 340 may program the Keys. There may be four types of keys: (1) hardware generated, (2) hardware wrapped, (3) plaintext keys, and (4) no-encryption “key”. Security controller 341 is shown as part of Software 340 to comprise one or more processors (circuitry or logical) to implement functions ascribed to Software 340.

In another embodiment, Software 340 may utilize Key Wrap construction 344. The Key Wrap constructions are a class of symmetric encryption algorithms designed to encapsulate (encrypt) cryptographic key material. The Key Wrap algorithm is intended to protect keys while stored in an untrusted storage or when the keys are transmitted over untrusted communications networks. Here, the Key Wrap/Handle construction may be optionally used as the communication is external to SOC 320.

During an exemplary implementation NVMe driver (e.g., SSD) 302 transmits a read request 310 to SOC 320. Read Request 310 is not encrypted as it contains no data. In an optional embodiment, Read Request 310 may be encrypted. Because Read Request 310 is not encrypted, Crypto Controller 322 is not engaged and SOC 320 relays Read Request 330 to Memory 360 via IOMMU 328. Responsive to the request, Memory 360 transmits Read Response 332 to SOC 320 via IOMMU 328.

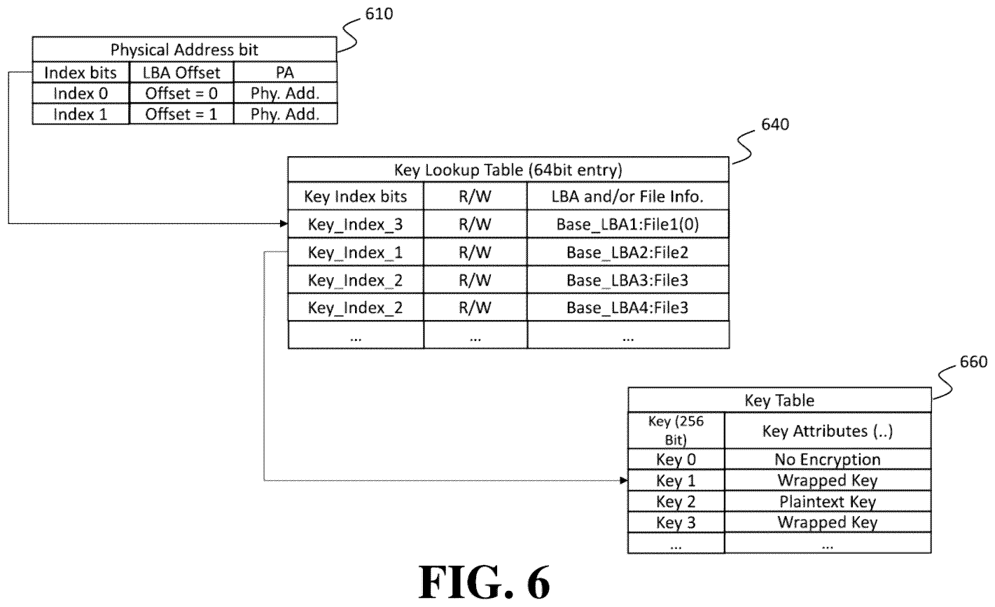

Crypto Controller 322 receives data packets included in Read Response 332 and encrypts the data packets according to the disclosed embodiments. Specifically, data is encrypted according to encryption keys provided by Software 340. As stated, SOC's communication with the end points may be governed by the PCIe protocol which allows, for example, PCIe endpoints to attach up to four 32-bit headers to the messages as described according to an embodiment herein. A PCIe end point has the choice of sending any additional data in these headers. One embodiment uses the TPL Prefix to send the table index and the offset value (e.g., Key Lookup Table or “KLT”). The crypto controller parses and removes this header information and uses the index field to look up a record/entry in a table and the offset field to calculate the actual LBA from the base LBA. Exemplary encryption (or decryption) methods are discussed further below in relation to FIGS. 5, 6 and 7.

In one embodiment, read data is selected by Crypto Controller 322 through software interface (not shown) that identifies which drives should Crypto Controller 322 encrypt and which should not be encrypted. As described further below, Key Lookup Table (KLT) 326 stores one or more tables. In one embodiment, KLT 326 provides information including KeyID, LBA and File Infor (per file) to Crypto Controller 322. In certain embodiments, KLT 326 may comprise a read/write bit (not shown) that allows drive read/write.

The pertinent data provided in Read Request 332 is then encrypted at SOC 320 and communicated to NVMe 302. NVMe Controller 304 receives and stores the encrypted data in the SSD flash memory 303. The data is then written to the NVMe drive 302 as indicated by SSD write operation 301. Because encryption is done at SOC 320, the entire encryption operation is done at inline DMA speed and no delay is introduced due to components external to the SOC 320.

FIG. 3B illustrates a system architecture for a memory write process at line speed. In FIG. 3B, NVMe Drive 302 is intending to write data into memory 360. The process begins with NVMe Drive 302 issuing Write Request 370. Write Request 370 may comprise encrypted data as illustrated by the hatching of arrow 370. Thus, in one embodiment of the disclosure, NVMe Controller 304 encrypts the data to be transmitted in Write Request 370.

SOC 320 receives encrypted Write Request 370 from NVMe Controller 304. Crypto Controller 322 decrypts data from Write Request 370 using key information from Software 340, Key lookup table from KLT 326 and hardcoded cypher keys from Hardware Key Engine 324. The decrypted Write Request is then transmitted to Memory 360 as illustrated by arrow 372. Memory 360 then writes data to allocated memory slots.

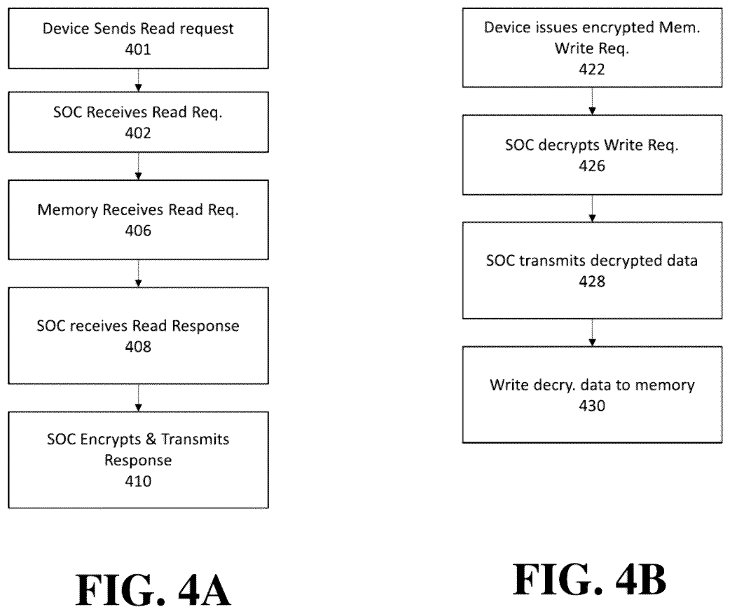

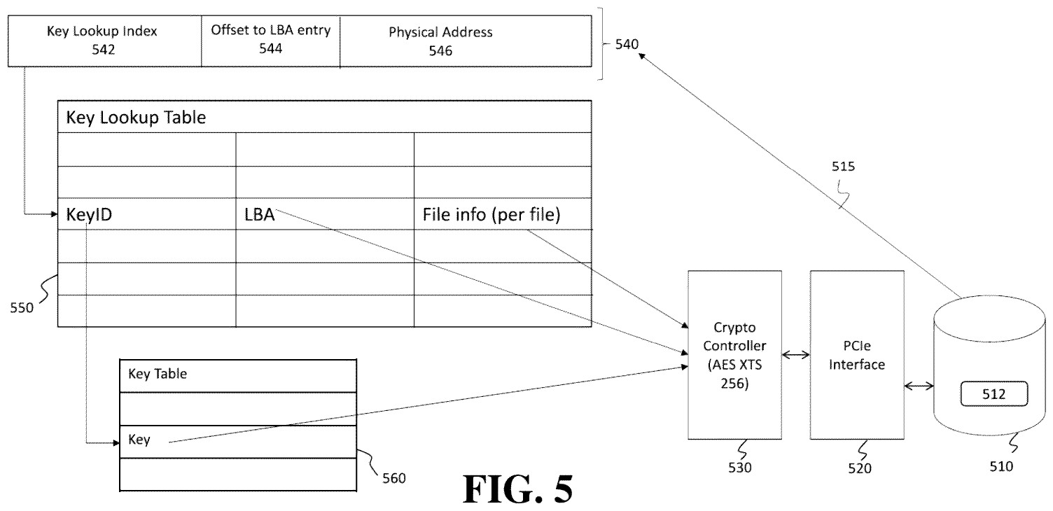

FIG. 4A shows an exemplary inline encryption for writing data onto an NVMe SSD. As described in relation to FIG. 3A, NVMe (SSD) issues a Read Request. This is shown as operation 401 in FIG. 4A. The Read Request may not need encryption as it contains no data. The Read Request is transmitted to SOC using DMA. At operation 402, the SOC receives the Read Request and transmits the same to the external memory. At operation 406, the external memory response to the Read Request with a Read Response containing data. At operation 408, the data (unencrypted) is received at the SOC. At operation 410, SOC's Crypto Controller (not shown) encrypts the data using hardware keys, key index and other cryptographic key information before transmitting the encrypted data to the NVMe. It should be noted that in neither SoC nor NVMe may decrypt the data that is to be stored in flash; rather, the data may be stored as encrypted data.

FIG. 4B shows an exemplary inline decryption process for writing data onto a memory module external to the NVMe. At operation 422, NVMe (SSD) issues a Write Request to the SOC. In one embodiment, the Write Request, which contains data, is encrypted by the NVMe Controller (not shown). The encrypted Write Request is transmitted to the SOC. At operation 426, the SOC decrypts the Write Request at the Crypto Controller of the SOC. The decrypted data contained in the Write Request is then transmitted to the memory as indicated in Operation 428. At operation 430, the memory receives and writes the decrypted date into the appropriate memory slots.

Referring once again to FIGS. 3A and 3B, in one embodiment Software 340 sets up the command stream in Memory 360 and Key Lookup Table in Memory 327 in the Crypto Controller. As stated, the KLT 326 may be integrated with Memory 327 or can be in DRAM 360.

NVMe drive 302 does a DMA of the command stream and the DMA requests can have 64 bits of one of the following three information: physical address, Guest Physical Address, or 10 Virtual Address.

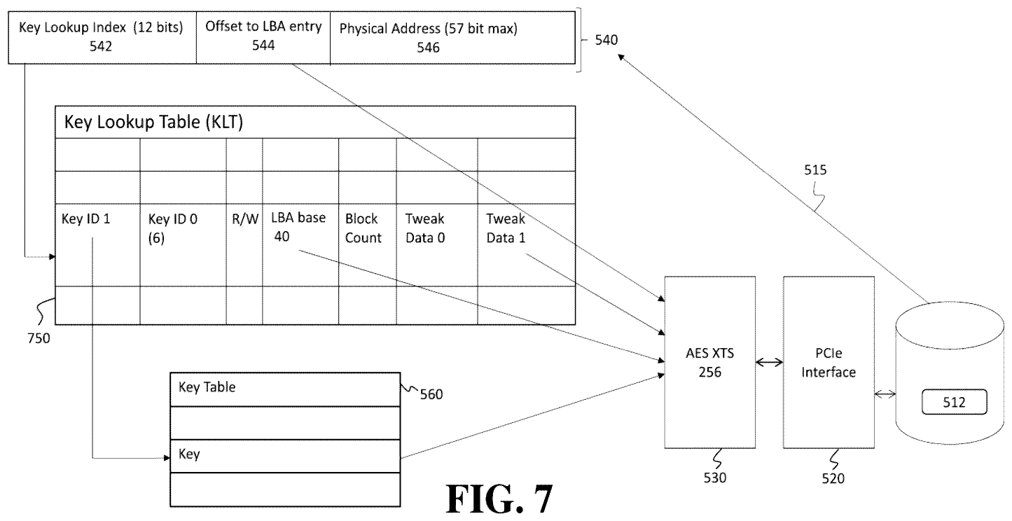

A number of variable of the available address bits may be used to index a table of 4K entries with 8 bytes per entry (i.e., 32 K table). The remaining available bits may be used for offset to the base LBA in the table. This provisioning of the address bits below in reference to FIGS. 5 and 6.

FIG. 5 illustrates a key lookup table according to one embodiment of the disclosure in which a single Key Id is used. In FIG. 6, NVMe drive 510 is shown with controller 512. As discussed in reference to FIGS. 2A and 2B, controller 512 may encrypt/decrypt transactional data. The PCIe Interface 520 represents the interface between the PCIe components of the system. The encryption standard AES-XTS-256 is represented (and applied) by Crypto Controller 530 in FIG. 5. As illustrated by arrow 515, the physical address for DMA (64 bit) is initiated by NVMe drive 515. In one embodiment, the NVMe generates data 540 which may include, among others, key lookup index 542, LBA offset 544 and physical address 546. This data is used by the crypto controller 530 (also 322, FIG. 3A, 3B) to retrieve additional information for encrypting/decrypting data. The Key Lookup Table may be stored at SOC (see, KLT 326, FIG. 3A, 3B) The key lookup index 542 may be used at the KLT 550 to retrieve KeyID, LBA and file information data as shown. Key ID of table 550 may provide the key(s) for encryption/decryption of data.

FIG. 6 schematically illustrates an exemplary key look up process according to one embodiment of the disclosure. In FIG. 6, Table 610 illustrates an exemplary Physical Address Bits table with fields that identify the Index bits, LBA Offset and Physical Address. Using the appropriate key index, the crypto controller may then go to Key Lookup Table which has a 64 bit entry. The Key Lookup Table 640 comprises the following exemplary fields: Key Index bits, Read/Write (R/W) and LBA and/or File Info. The R/W field defines whether information is read or written. The LBA and/or File info field provides the material to generate the tweak. The LBA offset is taken from 610.

Finally, using the information from Table 640, information from Key Table 660 can be invoked. Key Table 660 has two fields: Key (256 bit) and Key Attribute field which identifies the encryption attribute or type which must be used by Crypto Controller. It should be noted that the tables shown in FIG. 6 are illustrative and additional tables and/or fields may be added without departing from the disclosed principles.

The following illustrates an implementation according to one embodiment of the disclosure. In reference with FIGS. 3A, 3B, 5 and 6, when a request from the NVMe drive (302, FIGS. 3A, 3B) is issued, Crypto Controller 322 (FIGS. 3A, 3B) extracts the index from the address bits (Table 610, FIG. 6). The Crypto Controller 322 also obtains the LBA and the Key ID from Key Lookup Table (640, FIG. 6) and then looks up the Key Id. Table for the Keys and the Key attributes (Table 660, Table 6).

Crypto Controller 322 adds the LBA offset in the address bits to the BASE_LBA in the Table 550 (FIG. 5). The final LBA is the sum of the two values. This information provides Crypto Controller 322 with all the inputs for encrypting/decrypting the data (e.g., according to AES-XTS-256) in the PCIe TLP packets sent by (or being sent to) the NVMe driver 302. Based on this information, Crypto Controller 322 encrypts the data packets on the way to the NVMe drive 302 and decrypts the data packets on the way to the memory.

In certain embodiments, depending on the attributes in the Key Table (Table 660, FIG. 6), a controller may optionally decide not to encrypt or decrypt a packet. In some embodiments, Software 340 may mark some packets as non-encrypt (e.g., by pointing to a no-encrypt key entry) to make sure that the NVMe drive 302 has the access to the command packets since the NVMe drive 302 has to process the packet.

The R/W bit shown at Key Lookup Table 640 (FIG. 6) increases the security of the system by making sure that the records are marked as ‘R’ can only be used for decryption while the records marked as ‘W’ are only used for encryption. In one embodiment, the R/W indications correspond to Read and Write to the NVME drive 302. This is the reverse of the Read and Write to the Memory 360.

The above embodiments generally describe single encryption with PCIe-based cryptography. These embodiments are applicable to, for example, data at rest. However, there are government and Cloud Service Provider (CSP) scenarios in which double encryption may be desired. For example, a Virtual Memory (VM) owner may like to protect its data such that the CSP cannot access it while the CSP may wish to restrict the VM owner from moving this data to another CSP. Double encryption also protects the data from the compromise of one of the keys in a CSP scenario or an incorrect implementation of the encryption. This enables VM owner to provide a key while the infrastructure may provide a separate key.

In one embodiment of the disclosure, there are two keys: the first key is at the service level that is provisioned to the VM owner and the second key may be provisioned to the infrastructure provider or CSP. The dual encryption may run at line speeds (e.g., PCIe Gen 5) while enabling two or more (N) keys. For simplicity, the following descriptions are provided with for a dual-key implementation. The dual-key implementation may comprise an infrastructure-key and a service-key. The infrastructure-key may be is owned by the infrastructure provider while the service-Key may be owned by the container- or the VM-owner. The service owner may be prevented from controlling the infrastructure on which its service will. Conversely, the infrastructure owner may be prevented from controlling or determining which of all services they will run.

The system implementation described in relation to the inline encryption mechanism described above may be similarly applicable to multiple encryption keys with disparate owners. That is, in the case of a single inline encryption, the encryption engine gets all the key material and the tweak material from the key table and the key lookup table (KLT). This concept may be extended to provision a second key index in the key table itself.

According to this embodiment, the crypto controller is extended to look for two key indexes in the table, read the keys from the key table and then do two AES key expansions to generate two set of round keys, two set of tweaks and then do 28 rounds of encryption, 14 rounds per key. The LBA for both the tweaks may be the same. However, changing the tweak key may change the tweaks and may result in two different tweaks. As before, the input data may be the data in the PCIe transaction layer packet (TLP) or from memory and the output will be encrypted or decrypted ciphertext/plaintext depending on whether it is a write or read transaction. The crypto controller (322, FIG. 3A, 3B) can process all the keys at line speeds in an inline fashion without ever releasing the keys to system software (340, FIG. 3A, 3B). In one embodiment, software (340, FIG. 3A, 3B) may choose which all keys should be used by the encryption/decryption engine (325, FIG. 3) and in which order by appropriately populating the key table.

In certain embodiments, the data may be encrypted with the first key first and the ciphertext that is generated is then encrypted with the second key. The size of the plaintext, intermediate ciphertext and the final ciphertext may be substantially the same since AES-XTS does not increase or decrease the size of the data. Finally, if the system software (e.g., Software 340, FIG. 3A, 3B) so chooses, it may decide to only decrypt using the second key by only putting the second key in the table (in the first key slot) and leaving the second key slot empty. This allows the software to unbind the data from infrastructure encryption while the service encryption stays. Software can now move this data to another infrastructure and encrypt it using the infrastructure-key of the second infrastructure. This overcomes the challenges of the conventional AES-NI as the latter does not have dual encryption capabilities and would require multiple read/write cycles.

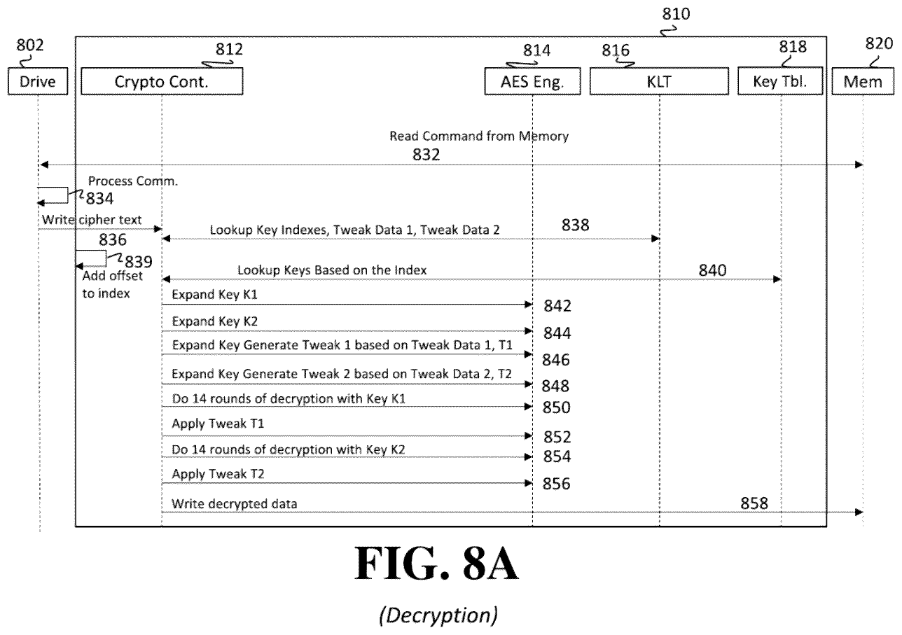

FIG. 7 schematically illustrates a dual encryption technique according to one embodiment of the disclosure. The dual encryption technique of FIG. 7 is similar to the single encryption technique of FIG. 5. Accordingly, similar elements are numbered similarly. Referring to FIG. 7, key lookup table 750 has two key IDs: Key ID 1 and Key ID 0. Each of the two Key IDs may be defined distinctly at Key Table 560. In one embodiment, Key Table 560 may be populated by the Virtual Memory Manager (VMM) running the VM (e.g., NVMe 302, FIG. 3A, 3B). It is also possible that some keys in the Key Table 560 may be populated by the VMM and some keys by the VM. Each key in the Key Table 560 may be associated with a respective Key ID Index and KLT 750 will contain the indexes for at least two keys (e.g., Key ID0, Key ID 1).

In an exemplary implementation of a DMA transaction, the crypto controller reads KLT 750, identifies the keys and performs two key expansions. The key expansions lead to 28 round keys (1 key for each round). The crypto controller caches the round keys (e.g., at memory 327, FIG. 3A, 3B) and encrypts or decrypts the data though encryption/decryption engine 325. Each encryption may have its own tweak data. Thus, in certain embodiments, one encryption may use LBA as the input nonce for the tweak while the other encryption may use file data as the input nonce for the tweak.

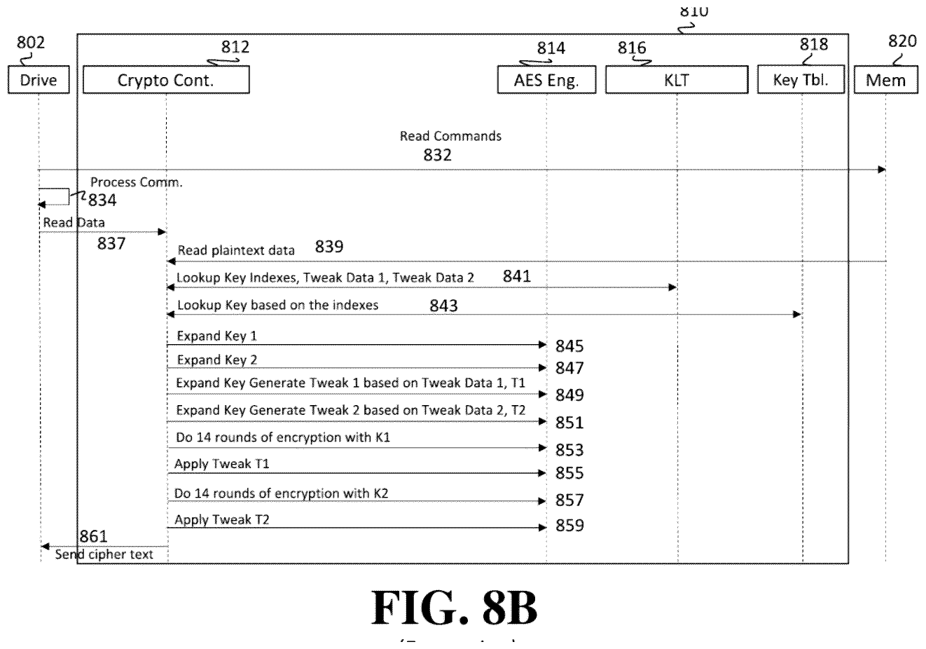

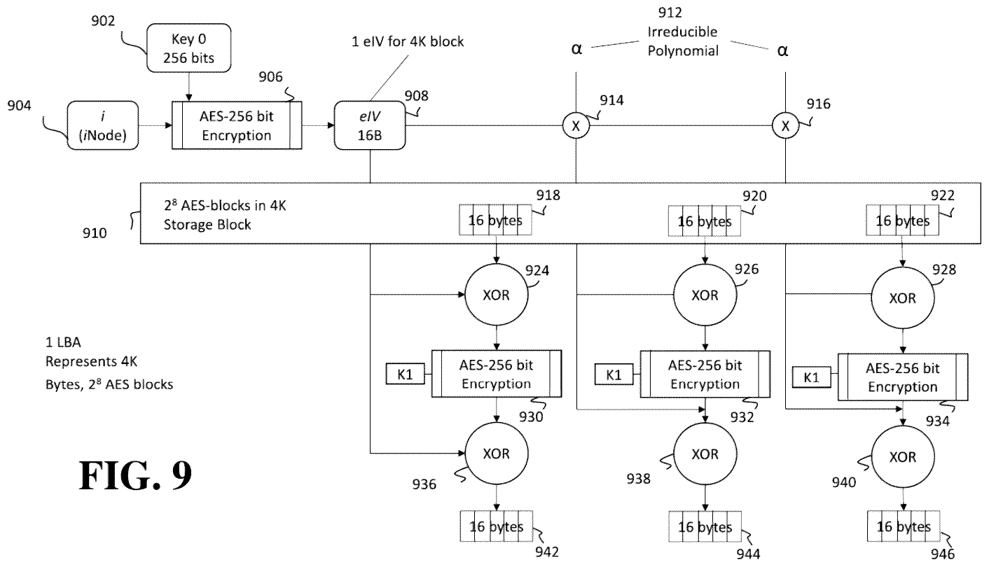

FIG. 8A is an exemplary decryption flow diagram according to one embodiment of the disclosure. The system of FIG. 8A comprises drive 802, SOC 810 and Memory 820. Drive 802 may comprise an NVMe drive. Memory 820 may comprise a DRAM. SOC 810 may comprise Crypto Controller 812, AES Engine 814, KTL 816, and Key Table 818. SOC 810 may comprise several Crypto Cores (not shown). For simplicity, only Crypto Controller 812 is shown. Further, Crypto Controller 812 may comprise an encryption/decryption engine (not shown). AES Engine 816 may be stored in a memory circuitry (see, e.g., memory 327, FIGS. 3A, 3B) associated with SOC 810. AES Eng. may store information for encryption/decryption according to the AESXST standard. Key Lookup Table 816 may store certain information including multiple (N) Key IDs, Read/Write bit, LBA base, Block Count and Tweak data sets corresponding to each of the N keys. Key Table 818 may include key information for each of the N encryption/decryption keys. The exemplary process of FIGS. 8A and 8B relates to N=2.

The process begins at operation 832 when drive 802 sends Memory 820 a read request and obtains the commands. This communication may be a DMA transaction. Read Communication 832 may be a Read Request. At operation 834, Drive 802 processes the received communication. At operation 836, Drive 802 writes Cipher text corresponding to the Read Communication; the write cipher text is the communicated to Crypto Controller 812 of SOC 810. Based on the information contained in the header of the Cipher text, Crypto Controller 812 receives the reads KLT 816 and obtains Key Indexes as well as Tweak Data 1 and 2 as indicated by arrow 838. Using the Key Indexes, Crypto Controller 812 then looks up the corresponding two Keys at Key Table 818 as shown by arrow 840.

Crypto Controller 812 then expands each of Key 1 and Key 2 as schematically illustrated by arrows 842 and 844. This information is communicated to AES Engine 814. Crypto Controller 812 also expands Key Generated Tweak 1 based on Tweak Data 1, T1 (as illustrated by arrow 846) and Key Generated Tweak 2 based on Tweak Data 2, T2 (as illustrated by arrow 848).

Next, using the first Key (K1), Crypto Controller 812 implements 14 rounds of decryption and communicates the results to AES Eng. Crypto Controller 812 applies the first Tweak (T1) as illustrated by arrow 852 and communicates the same to AES Eng. 814. The process for K1 is implemented for the second Key. At operation 854, using the second Key (K2), Crypto Controller 812 implements 14 rounds of decryption and communicates the results to AES Eng. 814. At operation 856, the Crypto Controller 812 applies tweak T2. Finally, at operation 858, the encrypted data is written to memory 820.

FIG. 8B is an exemplary encryption flow diagram according to one embodiment of the disclosure. Certain portions of FIG. 8B are substantially similar to those show in FIG. 8A and are similarly numbered. In FIG. 8B, the encryption process begins when the Drive 802 issues a Read Command 832 which is directed to NVMe 820. At operation 834, Drive 802 processes the Read Command. At operation 837, Drive 802 responds with Read Data 837. Read Data 837 is received at SOC 810 which encrypts Read Data 837.

At operation 839, Crypto Controller 812 reads Plaintext Data 839 from Memory 820. Crypto Controller 812 then looks up the Key Indexes and Tweak Data 1 and 2 (corresponding to each of the two Key Indexes) from KLT 816 as illustrated in Operation 843. At operations 845 and 847, Crypto Controller 812 expands Key 1 and Key 2 and communicates the expanded Keys to AES engine 814. At operation 849, Crypto Controller 812 sends the expand Key Generate Tweak 1 based on Tweak Data 1, T1 to AES Engine 814. The same is performed for Tweak 2 based on Tweak Data 2, T2, as illustrated at operation 851.

At operation 853, Crypto Controller 812 implements 14 rounds of encryption with K1. At operation 855, Crypto Controller 812 applies Tweak T1. Similarly, at operations 857 and 859, Crypto Controller 812 implements 14 rounds of encryption with K2 and applies Tweak T2. This information is communicated to AES Engine 814. At operation 861, Crypto Controller 812 sends cipher text to Drive 802. As discussed in reference to FIG. 3A, the encrypted data 861 is the received at the controller (see FIG. 3A) of NVMe Drive 802.

Inline Encryption for PCIe Devices. Another embodiment of the disclosure relates to file encryption using inline cryptography for PCIe devices. Conventionally, data at rest is protected in two common ways. The first technique is volume level encryption where the entire drive volume is encrypted with the same key and the volume key is then encrypted with a key derived from the user password in order to make sure that the volume is bound to the user. The second technique of encrypting data is rest is file level encryption. In file level encryption, the file system identifies the data blocks of each file and all the data blocks of the file are encrypted with a unique key that is unique to the file. File level encryption is an expensive process due to extensive key management and the need to be able switch keys at block granularity.

File level encryption has several advantages. First, file level encryption allows separation of files across containers and VMs even if the VMs have access to the same volume. Containers are typically not assigned a volume. Second, file level encryption enables the Operating System (OS) to only encrypt data that is sensitive and not encrypt non-sensitive data. Finally, using file level encryption the same encrypted file can be sent over a network to the cloud without having to decrypt the storage and re-encrypt the file for the cloud. Thus, file level encryption is advantageous over volume encryption. Self-encrypting drives conventionally perform volume encryption because the drive does not have any idea of what a file is nor does it know which blocks belong to a particular file. Software performs file level encryption using software encryption or by accelerating the software encryption using AES-NI or some other crypto accelerator.

Thus, certain embodiments of the disclosure relates to file level encryption in an inline fashion such that the software can still choose the keys, blocks and file information but the file is automatically encrypted and decrypted inline. In some embodiments, the software may not have to program a crypto controller or use a crypto accelerator to encrypt the file.

The mechanism for reading and writing a non-encrypted file may be substantially similar to the writing or reading an encrypted file as provided in the above-described embodiments, for example, in relation to FIGS. 3A and 3B. In one embodiment, the disclosed mechanism is modified for file encryption. The inline encryption engine looks up the table (KLT 326, FIG. 3A, 3B) for file metadata and other key entries. The file metadata identifies a file uniquely. Software can then decide what it wants to put in the file metadata. The crypto engine (325, FIG. 3A, 3B) of the SOC may then perform AES-XTS on the file by using the metadata to generate a unique tweak for the file. The unique per-file tweak can generate a unique cipher text even if two identical files are encrypted with the same key. Further, the software overhead is reduced since the software does not have to keep track of the ciphertext and plaintext.

In one embodiment, the disclosure provides a table-based approach where the software (e.g., software 340, FIGS. 3A, 3B) manages a table (KLT 326, FIGS. 3A, 3B) and adds file metadata into the table. The metadata is then consumed by the inline encryption engine that generates a unique per file tweak and performs encryption. Finally, the drive (e.g., NVMe Drive 304, FIGS. 3A, 3B) is ignorant of this encryption because the drive receives an encrypted block of data and it has to store the encrypted block data in the appropriate block on writes and read the same ciphertext on reads.

The disclosed embodiment provides several advantages. First, the file level encryption works well for multiple-users, containers and VMs that share volumes. Second, the inline file level encryption ensures that the files can be encrypted without significant software overhead and the files can even be transferred from the client to the cloud without having to perform multiple layers of decryption and encryption. Third, file level encryption allows the software to select which blocks to encrypt and which ones not to encrypt. Finally, the data portability and security increases since all the data is no longer encrypted with the same key and the data can be easily moved across volumes.

As discussed, an exemplary inline crypto engine encrypts and decrypts the data on the DMA path of the NVMe drive. This encryption and decryption is implemented inside the SOC. In some embodiments, the encryption uses the AES-XTS256 standard. A unique attribute of AES-XTS256 is that it uses two 256-bit keys in which the first key is used for encryption or decryption using the AES rounds and the second key is used for generation of a tweak.

The tweak protects from known plaintext attacks where two pieces of plaintext encrypted using the same key will lead to the same ciphertext. To protect from such attacks, a tweak is conventionally used which is generated by encrypting a nonce with the second key. The generated tweak is subsequently used to XOR the plaintext and the ciphertext of the encryption such that even two plaintexts encrypted with the same key will lead to different cipher texts due to different tweaks.

In one embodiment of the disclosure, this property is extended by using file information data in the tweak nonce. Instead of arbitrarily using the LBA for the input nonce to the tweak, an embodiment of the disclosure uses inode for generating the tweak. The file inode is a data structure that is associated with a file and keeps all the attributes of a file. The inode may either points to a file or to a directory.

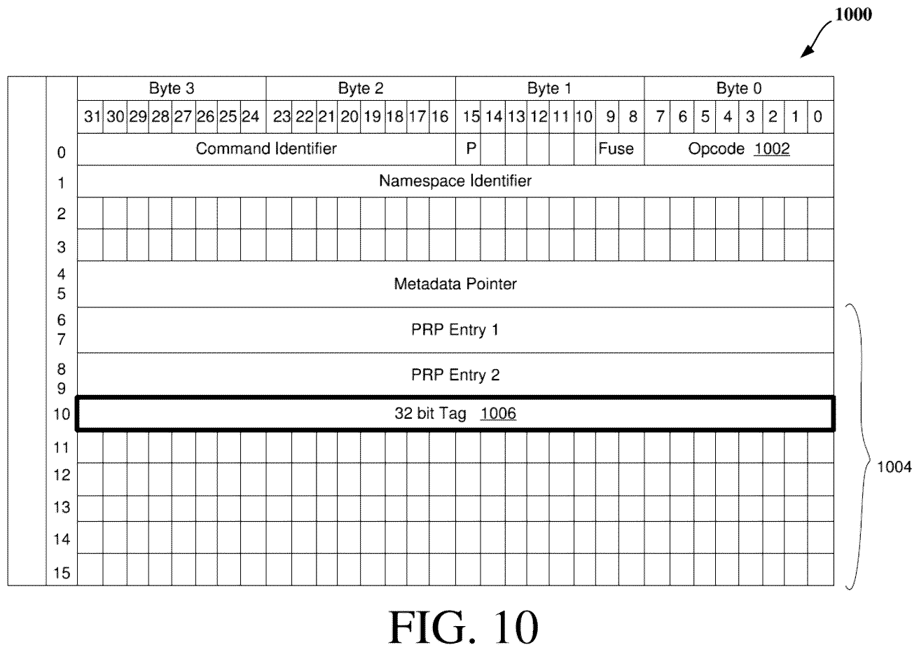

FIG. 9 shows an exemplary system for file encryption using inline cryptography according to one embodiment of the disclosure. As shown in FIG. 9, an exemplary storage block may be 4K in size. This is show as storage blocks DS918, DS920, DS922, DS942, DS944 and DS946. A file will have many storage blocks. FIG. 9 is illustrated with AES-256 bit encryption. However, the disclosed principles may be applied to other encryption techniques without departing from the disclosed principles.

Input 904 to the encryption system of FIG. 9 may be an inode value 902. As discussed, inode value 902 may represent data structure associated with the file under encryption. A first Key (K0, 256 bit) 902 may be used to encrypt as illustrated at 906 to obtain tweak value eIV 908. The eIV 908 may comprise 16 bytes (1 eIVfor 4K block of data). The eIV 908 may be combined by an irreducible polynomial to obtain other 912 to subsequent eIV inputs. In an exemplary embodiment, the irreducible polynomial may be determined based on the standard defined in the IEEE § 1619 (Standard Architecture for Encrypted Shared Storage Media). Alpha is define in IEEE § 1619 standard.

According to one exemplary embodiment, each storage block may use the iNode or {iNode∥Storage Block Number}, where the storage block number is the storage block number in the file. For example, if a file goes across 4 blocks (16K file), it will have block numbers from 0-3. For every storage block, there can be 2⁸+1 encryptions done, or 1 per AES block +1. In one implementation, the +1 encryption is done at the beginning of each block (as shown in FIG. 9) to generate the eIV.

For every 16 bytes (AES blocks 918, 920 and 922), in the storage block 910, the e1V is multiplied with alpha\hat{ }aes_block_id. Thus, if a storage block has 4K AES blocks, it will have 2⁸ AES blocks (910), there will be one eIV generated for the 2⁸ AES blocks and for every AES block, the eIV will get multiplied with alpha\hat{ }aes_block_id and the resulting tweak is XORed with the plaintext (924,926,928) and the ciphertext (936, 938, 940). For each block, FIG. 9 also shows AES-256 bit encryption with K1 (fist Key) in 930, 932 and 934.

Once the above process is repeated for all the storage blocks in the file, we get encrypted file consisting of ciphertext of all the blocks. In one embodiment, the LBA(s) where the file is actually written does not change nor does the size of the file. The result is shown as encrypted data blocks 942, 944 and 946.

The difference between using only iNode versus INode+Block Count is to make the solution sturdier against known plaintext attacks within the file scope. For example, if Block Count is not used, then same plaintext in two different blocks within the same file may lead to same ciphertext which can be vulnerable to known ciphertext attacks. Once the block count of the file is used, the known ciphertext attack are reduced to finding two known ciphertexts within the same block and same alignment which is a much harder exercise.

It should be noted that although iNode is an E×T filesystem concept, all file systems have file metadata structures similar to iNodes. The similar file structures may be used without departing from the disclosed principles.

The disclosed techniques may also be extended to all the files owned by a user or by a VM by using VM metadata or user metadata in the KLT for generation of the tweak. The KLT is directly mapped to physical address space so the VM may directly populate the KLT. This is also virtualizable since the hypervisor can divide the KLT into multiple 4K segments and assign it to each container or VM. There may be no need to change the key table.

It should be noted that although the exemplary embodiments are illustrated in relation to AES-XTS standard, different algorithms can be used according to the disclosed principles without departing therefrom.

PCIe Extensions

As discussed above, inline encryption implies that the encryption and decryption are occurring when the data is being read/written from the drive to DRAM or vice-versa. This is in contrast to lookaside encryption, where the NVMe controller writes data to memory and then some other agent reads plaintext data from memory, encrypts it and writes it back to memory or reads ciphertext from memory, decrypts it and writes plaintext to memory. As a result, the drive may not provide the information for encryption.

In order to handle this problem, a table-based approach may be used and allow the host software to setup the table, which the crypto controller can then look up. This option is feasible, however due to the need for fast lookups, it is impractical for the crypto controller to search the table or parse through a hierarchical table. There is a need for an index into the table and that index needs to be mapped with a transaction. This leads to the problem of sending the index in the transaction. That problem can be solved using unused address bits.

However, there is also a need to solve this problem without using the address bits for platforms that need all their address bits, especially in the data centers of the cloud service providers that need to use all the address bits for addressing large amounts of data.

In order to solve the afore-mentioned problem, an embodiment utilizes a new mechanism. A PCIe end point has the choice of sending additional data in these headers. One embodiment uses the PCIe header(s) to send the table index and the offset value (where this table is sometimes referred to herein as Key Lookup Table or “KLT”). The crypto controller parses and removes this header information and uses the index field to look up a record/entry in a table and the offset field to calculate the actual LBA from the base LBA. This allows various embodiments to support indexes for 64K pending entries (using 16 bits) and offsets of 20 bits (i.e., 1M*4K) or 4 Gigabytes of pending input/output (I/O or IO) transactions in one embodiment. Depending on the implementation, the table/index size can be larger than this example.

Moreover, such embodiments can provide scalability since there is no need to reuse address bits. Also, there is no need to provide additional wires/pins in the system for increasing the address bits, which would keep implementation costs and the required footprint down. Hence, some embodiments provide more flexibility by allowing modifications to send more bits depending on the implementation.

To this end, some embodiments relate to techniques of enforcing inline encryption on NVMe drives using one or more PCIe extension(s). In an embodiment, an index to a table is provided to the NVMe drive from the host (e.g., host software) and the drive then communicates the index in a DMA (or other memory access like a PCIe) request along with an offset value, e.g., in the PCIe TLP (Transaction Layer Packet) prefix.

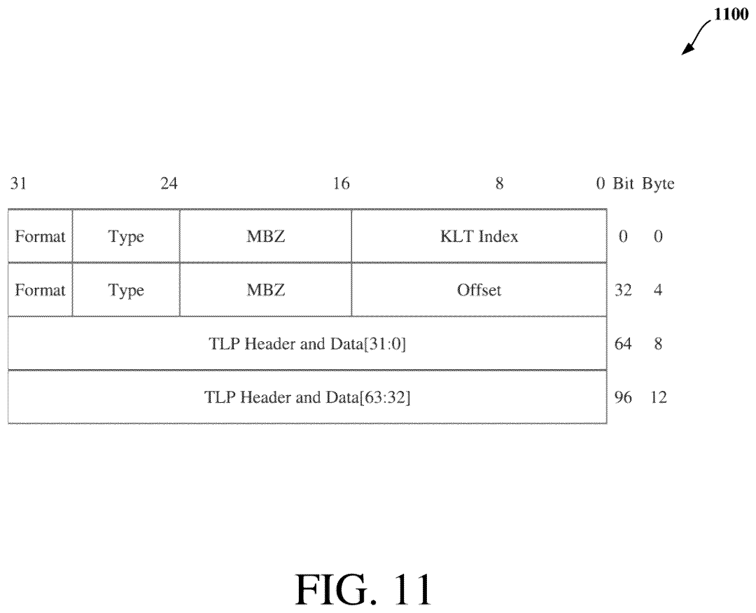

Generally, NVMe commands contain command codes and parameters. FIG. 10 shows sample information for a NVMe command associated with a read operation or a write operation, which may be used in one or more embodiments. The OpCode or Operational Code 1002 indicates whether the command is a read or a write command, while the PRP (Physical Region Page) entries (or pages) 1004 point to the actual data. As shown, 32 bits can be reserved in the NVMe command for a 32-bit tag (maximum in an embodiment) that is sent by the software along with the command. Software populates a 32-bit index (and any other information if needed) in the tag 1006 and the rest of the command stays the same. While some embodiments herein are discussed with reference to a 32-bit tag, other size tags may also be used depending on system capabilities.

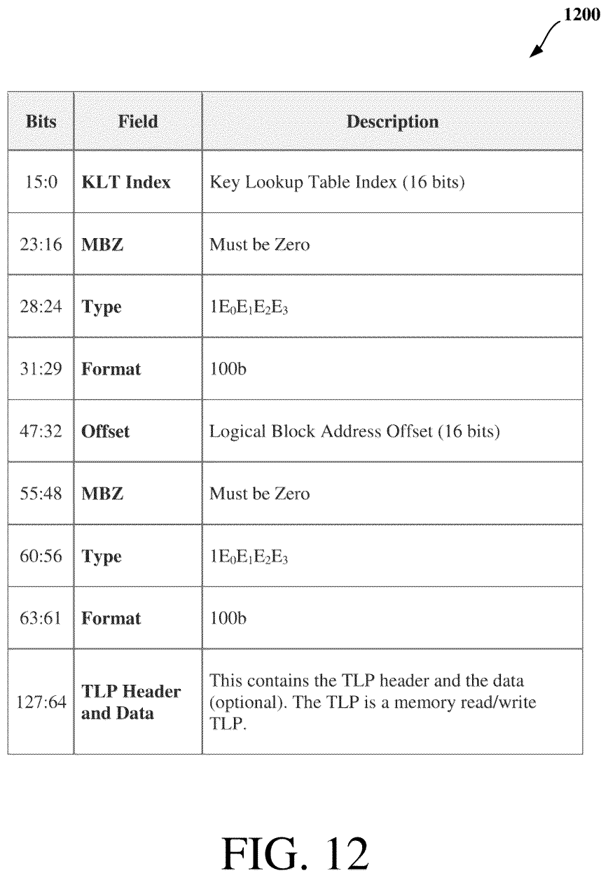

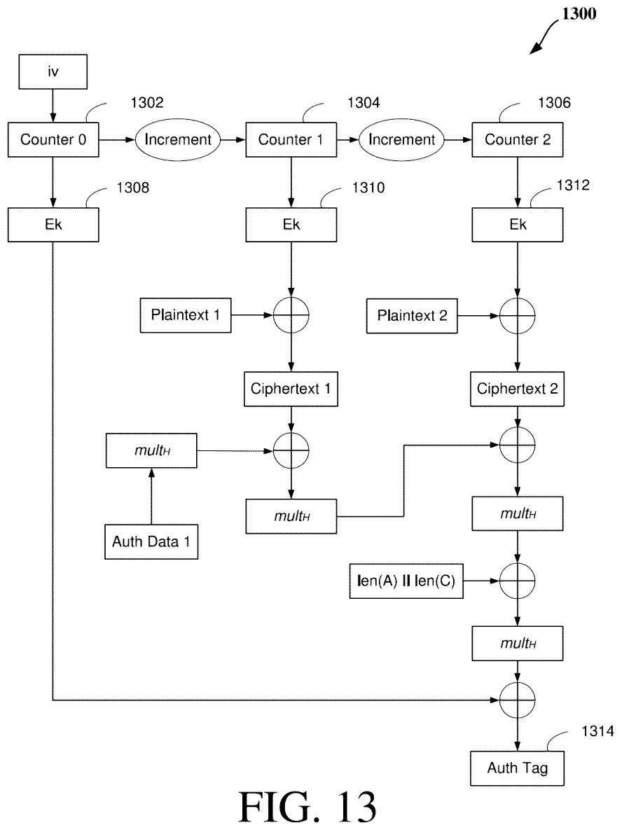

FIG. 11 illustrates a sample PCIe TLP (Transaction Layer Packet) 1100, according to an embodiment. As shown, the TLP 1100 may include various fields. FIG. 12 illustrates information 1200 regarding various fields of the TLP 1100 of FIG. 11, according to an embodiment.

Referring to FIGS. 11 and 12, once the NVMe drive (e.g., the controller of the NVMe drive) receives the 32-bit tag, it takes the first 16 bits and puts them in the index field in the TLP prefix. Thereafter, for every LBA, there is a unique 4K page in the PRP or the PRP list. Depending on the sequence of the LBA from (or following) the first LBA in the command, the drive writes an index of the LBA in the offset field of the TLP prefix. This completes the TLP prefix and now the NVMe drive can send the PCIe request with the TLP prefix to the host. The host receives this TLP prefix and routes it to the crypto controller. The crypto controller extracts the data out of the TLP prefix, reads the information, adds the offset to the index, and encrypts or decrypts the data based on whether it is a write operation or a read operation, respectively.

In at least one embodiment, the NVMe drive can send other metadata also in the TLP prefix. For example, it could send block metadata in the prefix. The block metadata may include some file information that enables the host to determine which entities are allowed to access the block metadata. E₀ E₁ E₂ E₃ correspond to the header type that is used to identify the TLP extension containing the index and/or offset. This might be a proprietary number, and may be centrally (e.g., uniquely) assigned (e.g., by the PCIe standard group or system designer/builder) so that there are no potential conflicts.

### Enabling Integrity Protected Block Storage on NVME Drives

Generally, NVMe (Non-Volatile Memory express) devices store data at rest (i.e., persistently) and this data has to be encrypted and optionally integrity protected for security.

Also, while some embodiments herein are discussed with reference to an NVMe drives, embodiments are not limited to NVMe devices and other types of non-volatile memory may be used, such as a Dynamic Random Access Memory (DRAM) with battery backup.

One way to protect data at rest is using AES-XTS or Advanced Encryption Standard (AES) XEX-based Tweakable-codebook mode with ciphertext Stealing (XTS) that only provides confidentiality of data (e.g., via encryption). With confidentiality protection, a physically present adversary cannot readily read the plaintext (where “plaintext” refers to non-encrypted text). This protection has been sufficient for the industry for a long time. The next frontier of this protection is the integrity of data (in addition to confidentiality). Since the data in the drive is saved at a block granularity (both in file encryption and volume encryption scenario), there is an opportunity to protect integrity of the data at a block granularity, in addition to confidentiality of data. As discussed herein, integrity enforcement detects modification of encrypted data, while confidentiality prevents decryption of encrypted data. For example, if we have a string “foo” and it is encrypted to “bar” using a one way function F( ), confidentiality will ensure that the person who knows “bar” will not be able to derive “foo” from it without knowing the key. Integrity will ensure that if somebody changes the word “bar” to “bat” and then tries to decrypt it using F′( ), F′( ) will throw an error showing that the ciphertext has been modified.

Providing integrity of data has two fundamental challenges. Firstly, integrity needs a MAC (Message Authentication Code) and the computation of a MAC consumes extra compute cycles, and secondly this MAC has to be stored along with the data. This needs extra storage space besides the data block.

To this end, some embodiments provide techniques for efficient enabling of integrity protected block storage on NVME (Non-Volatile Memory express) drives. An embodiment uses an inline encryption mechanism and enables logic/software to select which blocks are secured with integrity protection vs. which blocks are secured with confidentiality only. As discussed herein, inline encryption implies that the encryption and decryption are happening when the data is being read/written from the drive to DRAM or vice-versa. This is in contrast to lookaside encryption, where the NVMe controller writes data to memory and then some other agent reads plaintext data from memory, encrypts it and writes it back to memory or reads ciphertext from memory, decrypts it and writes plaintext to memory. For example, software/logic may use one or more bits in the command structure to indicate enforcement of integrity protection for a block. In order to provide integrity protection, an inline encryption engine can be modified in one embodiment to provide AES Galois/Counter Mode (GCM) (or AES-GCM) in addition to AES-XTS. As an example, a bit in the command stream may indicate whether one or more blocks associated with a command should be integrity protected or encrypted only for confidentiality.

In one embodiment, the MAC is calculated inline along with the encryption and AES-GCM is used for performing the encryption and calculating the MAC. The MAC is transferred to the NVMe drive (e.g., on write operation(s) to the drive) and read from the drive (e.g., on read operation(s) from drive). In an embodiment, the MAC will be included with the original data and no separate read/write operation is necessary to transfer the MAC. NVMe drives already support eight bytes of metadata per block. This allows some embodiments to support 64 bits of MAC for a 4K Byte block size, e.g., at about 0.1% overhead. The NVMe command can then use a metadata pointer to read the metadata along with the rest of the data. One advantage of such an implementation is that there is no need to convert a single read into multiple reads, thereby not impacting throughput.

Moreover, one embodiment provides an inline encryption mechanism that supports AES-GCM in addition to AES-XTS. An integrity TAG is generated using AES-GCM inline (i.e., without additional computation overheads) and the generated tag is then stored in the metadata fields of an NVMe drive. At least one embodiment provides a mechanism for logic/software to decide which blocks should have only confidentiality and which blocks should have integrity too. Hence, one or more embodiments can provide integrity for data and protect the data from more advanced threats (more active threats). Also, data protection may be provided against flash corruption or corruption in the transport channel from the NVMe storage to main memory or DRAM.

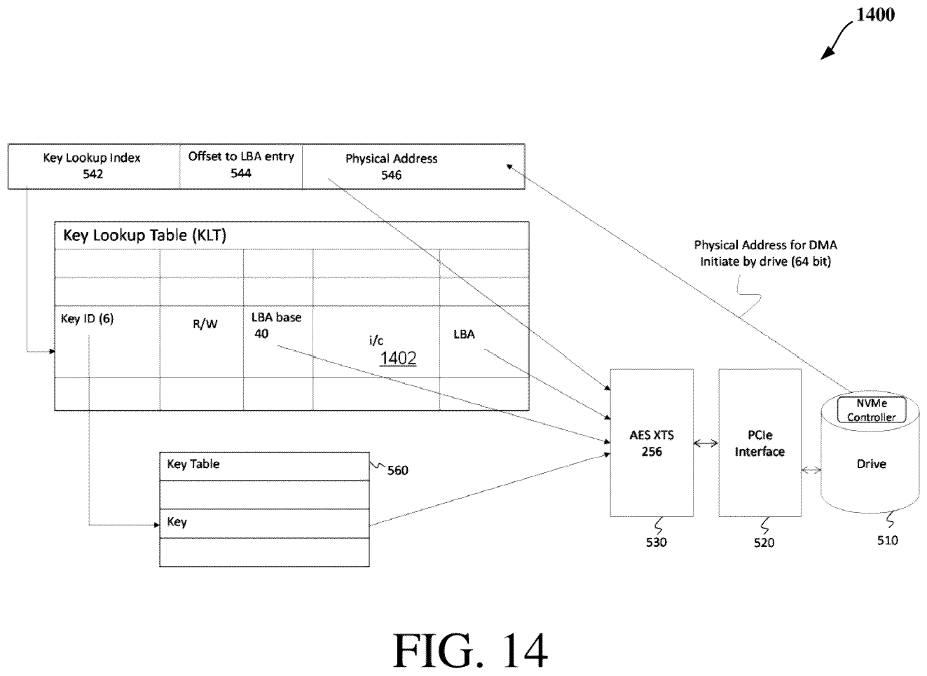

FIG. 13 is a flow diagram of AES-GCM operations, which may be applied in one or more embodiments. The fields referred to in FIG. 13 include:

| IV (input) | Logical Block Address or LBA |
|---|---|
| Counter (internal) | 0→2⁸ entries (4K Byte storage block |
| | size, 16-Byte AES block size) |
| Auth Tag (output) | Truncated to 64-bit tag (truncation |
| | is not shown in FIG. 13) |
| Auth Data (input) | Software/logic chosen (e.g., File |
| | Identifier), taken from LBA/File Info |
| | field in the table |
| Cipher Text (generated) | output |

The table above shows examples for a 4 kB block size; however, embodiments are not limited to 4 KB block size and smaller or larger block sizes may be used depending on the implementation. Also, a 64-bit tag is just for illustrative purposes and larger/smaller tags may be used.

Referring to FIG. 13, input LBA (iv) is used to generate three counters 1302, 1304, and 1306 (where the output of counters 1302 and 1304 are incremented prior to be fed to the next counter as shown). Outputs from the counters are then respectively fed to AES block cipher Eₖ's 1308, 1310, and 1312 (AES), where Eₖ denotes Encryption with key K (e.g., AES 256 bit encryption with key K). While the output of 1308 is provided to the last stage as Auth Tag 1314, the results of encryption by 1310 and 1312 are used to generate ciphertext outputs based on xoring with plaintext inputs. This operation is similar to a stream cipher, and hence different iv can be used for each stream that is encrypted. The ciphertext blocks are considered coefficients of a polynomial which is evaluated at a key-dependent point H, using finite field arithmetic. The Auth Data 1 is then fed through stages of mult_{H} (or Galois Field multiplication) based on Ciphertext 1 and Ciphertext 2 in combination with len(A) and len(C) to provide the Auth Tag 1314, where len (A) is the length of plaintext and len(C) is the length of ciphertext.

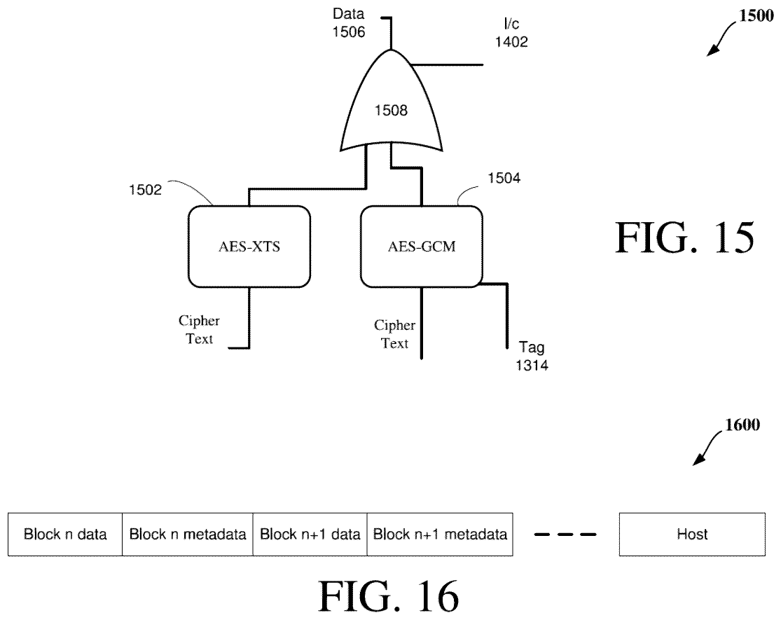

FIG. 14 illustrates an extended encryption table 1400, according to an embodiment. Various components shown in FIG. 14 were previously discussed with reference to FIGS. 5 and/or 7, as indicated by the reference numerals. Encryption table 1400 extends the inline encryption table KLT discussed above to indicate the blocks that need to be encrypted vs. integrity protected. The I/C field 1402 enables the logic/software to decide if a transaction needs to be integrity protected. Also, the inline encryption engine discussed above can be extended to support AES-GCM.

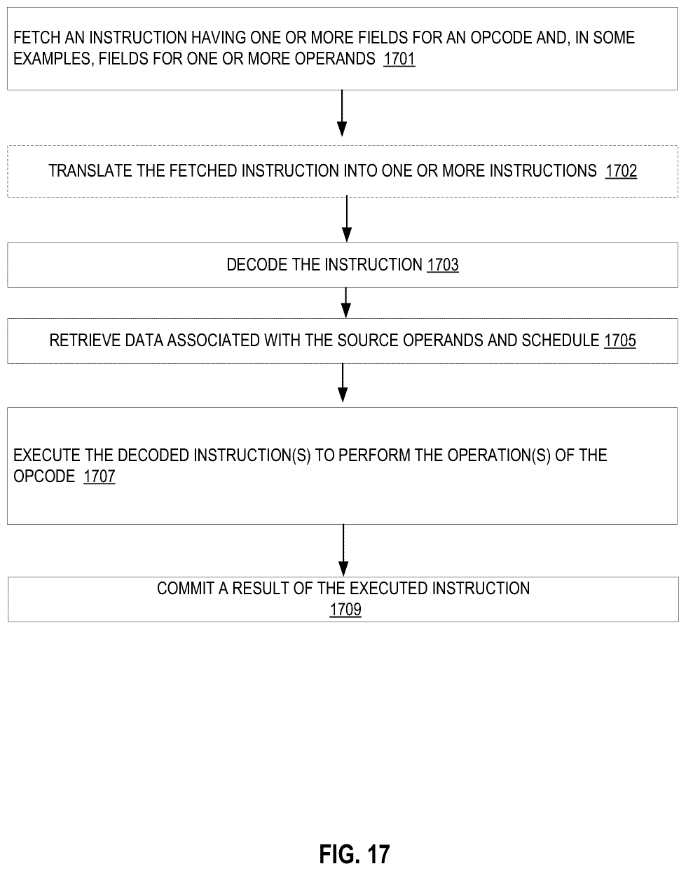

FIG. 15 shows a circuit diagram 1500 of a coarse-grained separation between an AES-XTS engine and an AES-GCM engine, according to an embodiment. In one embodiment, the AES engine may be reused across both the XTS and GCM engines, while the tag generation is separated from the tweak generation. The AES engine(s) may be duplicated for increased throughput in one or more embodiments.

Referring to FIG. 15, the AES engines 1502 and 1504 generate ciphertext that is then output as data 1506 after selection by selection logic 1508 selects between the AES-XTS 1502 output or AES-GCM 1504 output based on the value of c/I 1302. As shown in FIG. 15, AES-GCM engine 1504 receives the tag (e.g., Auth Tag 1314 of FIG. 1314).

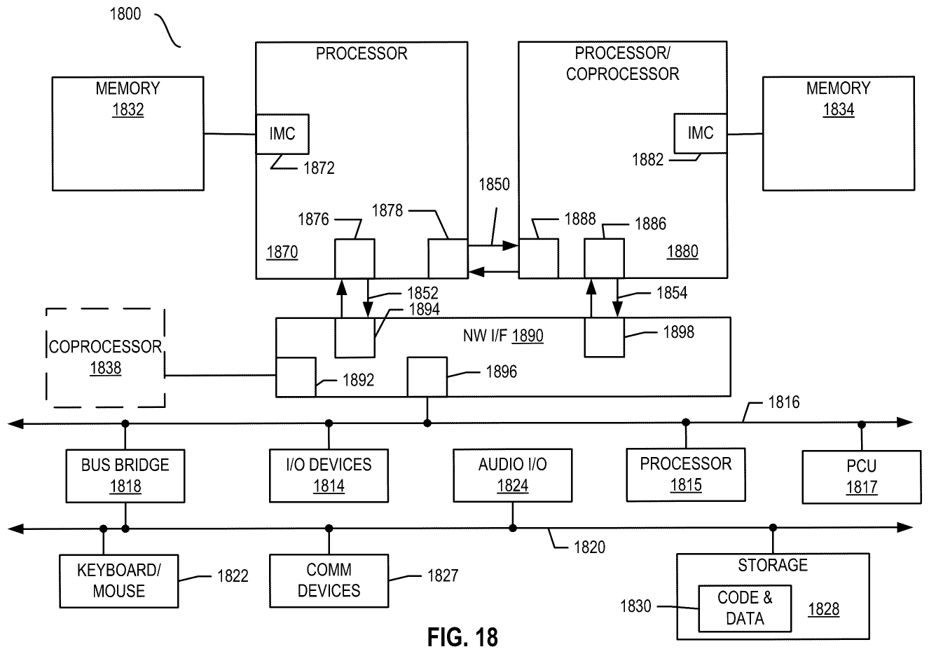

FIG. 16 illustrates a transfer format of a buffer 1600, according to an embodiment. More specifically, FIG. 16 shows how data and/or metadata can be stored and transferred using a single buffer 1600. As shown, the data blocks can be interleaved by metadata blocks. In an embodiment, the value returned by the Auth Tag in FIG. 15 is truncated to 64 bits and stored in the block metadata of FIG. 16.

In some embodiments, protected domains may be defined and/or configured using a processor instruction implemented by a processor such as “platform configuration” (PCONFIG) instruction. The PCONFIG instruction, for example, may be used to define and/or configure a protected domain by programming a new entry—or modifying an existing entry—in a key table of memory a security engine. The key table including keyIDs, keys, and an indication of usage for the keys (or lack thereof). In this manner, protected domains can be defined and configured programmatically (e.g., by management software) using the PCONFIG instruction.

A “platform configuration” (PCONFIG) instruction, for example, may be used to define and/or configure a protected domain by programming a new entry—or modifying an existing entry—in a domain key table of a memory protection controller (e.g., a domain key table of a memory encryption engine). In this manner, protected domains can be defined and configured programmatically using the PCONFIG instruction. Once a protected domain has been configured using the PCONFIG instruction, memory addresses associated with the protected domain are protected in the manner specified by the configuration for the protected domain. For example, when using encryption protection, data is encrypted before being written to memory addresses within the protected domain, and data read from memory addresses within the protected domain is decrypted before being returned to the requesting processor.

In some embodiments, the PCONFIG instruction may require a certain privilege level or privilege ring. For example, the processor may support a hierarchy of privilege levels or privilege rings to restrict access to certain resources. In some embodiments, privilege ring 0 may be the least restrictive level, while privilege rings with higher numbers may be increasingly more restrictive. For example, privilege ring 0 may be used for system management software (e.g., the operating system kernel and device drivers), while privilege ring 3 may be used for userland applications. Accordingly, in some embodiments, the PCONFIG instruction may be a ring-0 instruction that can only be used by software executing in the highest privilege ring (e.g., management software used to configure protected domains). Alternatively, or additionally, the PCONFIG instruction may be a ring-3 instruction that can be used by any userland application to configure its own protected domain.

The opcode of the PCONFIG instruction is to indicate execution circuitry is to execute one or more functions for configuring platform features. In some embodiments, there are explicit operands for the PCONFIG instruction, but there are multiple implicit operands. In particular, a first register (e.g., EAX) stores an indication of a leaf function to be invoked and one or more other registers (e.g., RBX, RCX, and/or RDX) are used for leaf-specific purposes. Note that leaves allow for the single instruction to perform different functions based on the values of these registers.

In some examples, executions of PCONFIG may fail for platform-specific reasons. An execution reports failure by setting the ZF flag and loading EAX with a non-zero failure reason; a successful execution clears ZF and EAX.

In some examples, each PCONFIG. leaf function applies to a specific hardware block called a PCONFIG target. The leaf function is supported only if the processor supports that target. Each target is associated with a numerical target identifier, and CPUID leaf 1BH (PCONFIG information) enumerates the identifiers of the supported targets. An attempt to execute an undefined leaf function, or a leaf function that applies to an unsupported target identifier, results in a general-protection exception (#GP).

The table below illustrates an example of PCONFIG. leaf encodings that could be used to enable support for multiple leaf functions. Although only one leaf function is defined (the KEY_PROGRAM leaf), additional leaf functions can be defined using the reserved leaf encodings in order to extend the functionality of the PCONFIG instruction.

PCONFIG Leaf Function Encodings

| LEAF | ENCODING | DESCRIPTION |
|---|---|---|
| KEY_PROGRAM | 0x00000000 | This leaf function is used to |
| | | program the key associated with |
| | | a domain. |
| OTHER | 0x00000001- | Additional leaf functions can be |
| | 0xFFFFFFFF | defined using these reserved leaf |
| | | encodings for future extensions to |
| | | the functionality of the PCONFIG |
| | | instruction. |

The key program leaf function (KEY_PROGRAM) of the PCONFIG instruction can be used to program a key for a protected domain (e.g., a total memory encryption multi-key (TME-MK). In some embodiments, the parameters used by the key program leaf function may be specified in a key program structure (KEY_PROGRAM_STRUCT), and the address of the key program structure may be specified in a hardware register (e.g., the EBX or RBX register). Software uses this leaf function to manage the encryption key associated with a particular key identifier (KeyID). The leaf function uses a data structure called the TME-MK key programming structure (MKTME_KEY_PROGRAM_STRUCT). Software provides the address of the structure (as an offset in the DS segment) in EBX (or RBX).

The table below illustrates an example embodiment of the key program structure (KEY_PROGRAM_STRUCT).

Key Program Structure (KEY_PROGRAM_STRUCT)

| | SIZE | |
|---|---|---|
| FIELD | (bytes) | DESCRIPTION |
| KEYID | 2 | This field identifies the KeyID of a |
| | | domain that is being programmed. |
| KEYID_CTRL | 4 | Bits [7:0] = command |
| | | Bits [23:8] = crypto algorithm |
| | | Bits [31:24] = reserved |
| RESERVED | 58 | This field may be used to select an |
| | | encryption algorithm to use for the |
| | | domain (based on the available |
| | | encryption algorithms). |
| KEYID_FIELD_1 | 64 | Software supplied KeyID data key or |
| | | entropy for KeyID data key |
| KEYID_FIELD_2 | 64 | Software supplied KeyID tweak key or |
| | | entropy for KeyID tweak key |

As shown the key program structure identifies the KeyID of the particular domain being programmed, and it also specifies a key programming command. In some embodiments, for example, the key program leaf function may support multiple key programming commands, and the desired command may be specified in the key program structure. Moreover, in some embodiments, the key program structure may also include reserved field(s) that can be used for subsequent extensions to the key program leaf function.

The table below illustrates examples of key programming commands that may be supported by the key program leaf function.

Key Programming Commands

| KEY DOMAIN (KD) | | |
|---|---|---|
| COMMAND | ENCODING | DESCRIPTION |
| Set Key Direct | 0 | This command sets the key for a domain directly |
| (KD_SET_KEY_DIRECT) | | using the key specified in the key program |
| | | structure (KEY_PROGRAM_STRUCT). The key is |
| | | provided by the software that initiates this key |
| | | programming command. |
| | | The domain is then protected in custom |
| | | encryption mode. |
| Set Key Random | 1 | This command sets the key for a domain using a |
| (KD_SET_KEY_RANDOM) | | randomly generated key. |
| | | For example, a key may be randomly generated |
| | | by a processor and/or a random number |
| | | generator, and thus may not be known by (or |
| | | shared with) the software that initiates the key |
| | | programming command. |
| | | The domain is then protected in custom |
| | | encryption mode. |
| Clear Key | 2 | This command clears the key that was |
| (KD_CLEAR_KEY) | | previously set for a domain. |
| | | The domain is then protected in default |
| | | encryption mode. |
| No Key | 3 | This command disables memory encryption for |
| (KD_NO_KEY) | | a domain. |
| | | The domain is then protected in plaintext mode. |

After the key program leaf function is executed, a return value or status code may be specified in a hardware register to indicate whether the key program function was successful. The table below illustrates examples of the status codes that may be returned by the key program leaf function.

Status codes returned by key program leaf function (KEY_PROGRAM)

| STATUS CODE | ENCODING | DESCRIPTION |
|---|---|---|
| PROG_SUCCESS | 0 | The domain is programmed successfully. |
| INVALID_PROG_CMD | 1 | The key programming command is invalid. |
| ENTROPY_ERROR | 2 | The entropy of a randomly generated key is insufficient. |
| INVALID_KEYID | 3 | The domain KeyID is invalid. |
| INVALID_ENC_ALG | 4 | An invalid encryption algorithm is selected. |
| DEVICE_BUSY | 5 | A lock for the domain key table cannot be obtained. |

In some examples, the use of the KEYID_FIELD1 depends upon selected key-programming command:
If the direct key-programming command is used (KEYID_SET_KEY_DIRECT), this field carries the software supplied data key to be used for the KeyID.
If the random key-programming command is used (KEYID_SET_KEY_RANDOM), this field carries the software-supplied entropy to be mixed in the CPU generated random data key.
This field is ignored when one of the other key-programming commands is used.

It is software's responsibility to ensure that the key supplied for the direct key-programming option or the entropy supplied for the random key-programming option does not result in weak keys. There are no explicit checks in the instruction to detect or prevent weak keys.

In some examples, the use of the KEYID_FIELD2 depends upon selected key-programming command:
If the direct key-programming command is used (KEYID_SET_KEY_DIRECT), this field carries the software supplied tweak key to be used for the KeyID.
If the random key-programming command is used (KEYID_SET_KEY_RANDOM), this field carries the software-supplied entropy to be mixed in the CPU generated random tweak key.
This field is ignored when one of the other key-programming commands is used.

It is software's responsibility to ensure that the key supplied for the direct key-programming option or the entropy supplied for the random key-programming option does not result in weak keys. In some examples, there are no explicit checks in the instruction to detect or prevent weak keys.

In some examples, all KeyIDs default to TME behavior (encrypt with TME key or bypass encryption) on activation of TME-MK. Software can at any point decide to change the key for a KeyID using this leaf function. Changing the key for a KeyID does not change the state of the TLB caches or memory pipeline. Software is responsible for taking appropriate actions to ensure correct behavior.

The key table used by TME-MK is shared by all logical processors in a platform. For this reason, execution of this leaf function must gain exclusive access to the key table before updating it. The leaf function does this by acquiring a lock (implemented in the platform) and retaining that lock until the execution completes.

Leaf Function TSE_KEY_PROGRAM

PCONFIG. leaf function 1 (e.g., selected by loading EAX with value 1) is used for direct key programming for total storage encryption (TSE). This leaf function is called TSE_KEY_PROGRAM and it pertains to the TSE target, which has target identifier 2. The leaf function can be used only in 64-bit mode. It uses the RBX register for additional input information.

In some examples, software uses this leaf function to manage the encryption key associated with a particular key identifier (KeyID). The leaf function uses a data structure called the TSE key programming structure (e.g., TSE_KEY_PROGRAM_STRUCT). Software provides the linear address of the structure in RBX. The format of the structure is given below:

| | Offset | Size | |
|---|---|---|---|
| Field | (bytes) | (bytes) | Comments |
| KEYID | 0 | 2 | Key Identifier |
| KEYID_CTRL | 2 | 4 | KeyID control: |
| | | | Bits 7:0; key-programming |
| | | | command |
| | | | Bits 23:8; encryption algorithm |
| | | | Bits 31:24; Reserved, must be zero |
| Ignored | 6 | 58 | Not used |
| KEY_FIELD_1 | 64 | 64 | Software supplied data key |
| KEY_FIELD_2 | 128 | 64 | Software supplied tweak key |

Examples of descriptions of each of the fields in MKTME_KEY_PROGRAM_STRUCT is provided below:
KEYID: The key identifier (KeyID) being programmed to the TSE engine. The leaf function causes a general protection exception (#GP) if the KeyID exceeds the maximum enumerated in the TSE_MAX_KEYS field (bits 50:36) of the IA32_TSE_CAPABILITY MSR (MSR index 9F1H).
KEYID_CTRL: The KEYID_CTRL field comprises two sub-fields used by software to control the encryption performed for the selected KeyID:
   Key-programming command (COMMAND; bits 7:0). This 8-bit field should contain one of the following values:
      TSE_SET_KEY_DIRECT (value 0). With this command, software programs directly the encryption key to be used for the selected KeyID.
      TSE_NO_ENCRYPT (value 1). With this command, software indicates that no encryption should be used for the selected KeyID.
If any other value is used, the leaf function causes a #GP.
   Encryption algorithm (ENC_ALG, bits 23:8). IA32_TSE_CAPABILITY[15:0] indicates which encryption algorithms are supported by the platform. The 16-bit ENC_ALG field should specify one of the algorithms indicated in IA32_TSE_CAPABILITY. The leaf function causes a
#GP if ENC_ALG does not set exactly one bit or if it sets a bit whose corresponding bit is not set in IA32_TSE_CAPABILITY.
KEY_FIELD_1: If the direct key-programming command is used (TSE_SET_KEY_DIRECT), this field carries the software supplied data key to be used for the KeyID. Otherwise, the field is ignored.
KEY_FIELD_2: If the direct key-programming command is used (TSE_SET_KEY_DIRECT), this field carries the software supplied tweak key to be used for the KeyID. Otherwise, the field is ignored.

In some examples, the TSE key table is shared by all logical processors in a platform. For this reason, execution of this leaf function must gain exclusive access to the key table before updating it. The leaf function does this by acquiring a lock (implemented in the platform) and retaining that lock until the execution completes. An execution of the leaf function may fail to acquire the lock if it is already in use. In this situation, the leaf function will load EAX with failure reason 5 (DEVICE_BUSY). When this happens, the keytable is not updated, and software should retry execution of PCONFIG.

Leaf Function TSE_KEY_PROGRAM_WRAPPED

PCONFIG. leaf function 2 (e.g., selected by loading EAX with value 2) is used for wrapped key programming for total storage encryption (TSE). This leaf function is called TSE_KEY_PROGRAM_WRAPPED and it pertains to the TSE target, which has target identifier 2.

The leaf function can be used only in 64-bit mode. It uses the RBX and RCX registers for additional input information.

Software uses this leaf function to manage the encryption key associated with a particular key identifier (KeyID).

The leaf function uses control input provided in RBX. The format of that input is given in the table below:

| Field | Bit Positions | Comments |
|---|---|---|
| KEYID | 15:0 | Key identifier |
| Reserved | 23:16 | Reserved, must be zero |
| ENC_ALG | 39:24 | Encryption algorithm |
| Reserved | 63:40 | Reserved, must be zero |

Examples of descriptions of the fields in the control input is provided below:
KEYID: The key identifier (KeyID) being programmed to the TSE engine. The leaf function causes a general-protection exception (#GP) if the KeyID exceeds the maximum enumerated in the TSE_MAX_KEYs field (bits 50:36) of the IA32_TSE_CAPABILITY MSR (MSR index 9F1H).
ENC_ALG: The encryption algorithm selected for the KeyID. IA32_TSE_CAPABILITY[15:0] indicates which encryption algorithms are supported bythe platform. The 16-bit ENC_ALG field should specify one of the algorithms indicated in IA32_TSE_CAPABILITY. The leaf function causes a #GP if ENC_ALG does not set exactly one bit or if it sets a bit whose corresponding bit is not set in IA32_TSE_CAPABILITY.

The leaf function also uses a 256-byte data structure called the bind structure. This structure should be the output of the PBINDKBinstruction, subsequently modified by software (see below). Software provides the linear address of the structure (e.g., in RCX). An example format of the structure is given below.

| | Offset | Size | |
|---|---|---|---|
| Field | (bytes) | (bytes) | Comments |
| MAC | 0 | 16 | MAC produced by PBNDKB of its bind-input |
| | | | structure |
| Reserved | 16 | 8 | Reserved, must be zero |
| IV | 24 | 12 | Initialization vector |
| Reserved | 36 | 28 | Reserved, must be zero |
| BTENCDATA | 64 | 64 | Encrypted data (data key and tweak key) |
| BTDATA | 128 | 128 | Additional control and data (not encrypted) |

Example description of each of the fields in TSE_BIND_STRUCT is provided below:
MAC: A MAC produced by PBNDKB of its input bind structure. The PCONFIG. leaf function will recompute the MAC and confirm that it matches this value.
IV: The initialization vector that PBNDKB used for encryption. The PCONFIG. leaf function will use this in its decryption of encrypted data and computation of the MAC.
BTENCDATA: Data which had been encrypted by PBNDKB, containing the data and tweak keys to be used by TSE.
BTDATA: Data that was input to PBNDKB that was output without encryption. It has the following format:
   a. USER_SUPP_CHALLENGE (bytes 31:0): PBNDKB uses a value provided by software in its input bind structure but writes zero to this field in the output bind structure to be used by PCONFIG. Software should configure this field with the proper value before executing this PCONFIG. leaf function.
   b. KEY_GENERATION_CTRL (byte 32): PBNDKB uses this value to determine whether to generate random keys. The PCONFIG. leaf function does not use this field.
   c. The remaining 95 bytes are reserved and must be zero.

In some examples, the leaf function uses the entire BTDATA field when it computes the MAC.

The leaf function determines a 256-bit wrapping key by computing an HMAC based on SHA-256 using 256-bit platform-specific key and the USER_SUPP_CHALLENGE in the BTDATA field of the TSE_BIND_STRUCT.

Using the wrapping key, the leaf function uses an AES GCM authenticated decryption function to decrypt BTENC-DATA and compute a MAC. The decryption function uses the following inputs in some examples:
The 64-byte BTENCDATA from TSE_BIND_STRUCT to be decrypted.
The 256-bit wrapping key.
The 96-bit IV from TSE_BIND_STRUCT.
Additional authenticated data that is the concatenation of bytes 63:16 and bytes 255:128 of the TSE_BIND_-STRUCT. These 176 bytes will comprise 8 bytes of zeroes, the 12-byte IV, 28 bytes of zeroes, and 128 bytes of BTDATA of which the upper 95 bytes are zero).
The length of the additional authenticated data (176).

In some examples, the decryption function produces a structure with 64 bytes of decrypted data and a 16-byte MAC. The decrypted data comprises a 256-bit data key and a 256-bit tweak key.

If the MAC produced by the decryption function differs from that provided in the TSE_BIND_STRUCT, the leaf function will load EAX with a failure reason 7(UNWRAP_FAILURE). Otherwise, the leaf function will attempt to program the TSE key table for the selected KeyID with the keys contained in the decrypted data.

In some examples, the TSE key table is shared by all logical processors in a platform. For this reason, execution of this leaf function must gain exclusive access to the key table before updating it. The leaf function does this by acquiring a lock (implemented in the platform) and retaining that lock until the execution completes. An execution of the leaf function may fail to acquire the lock if it is already in use. In this situation, the leaf function will load EAX with a failure reason (DEVICE_BUSY). When this happens, the key table is not updated, and software should retrye xecution of PCONFIG.

While the illustrated embodiment uses the PCONFIG processor instruction to perform domain configuration, other embodiments may use alternative and/or additional approaches for domain configuration. For example, in some embodiments, domain configuration may be performed using hardware registers. For example, a PCONFIG model-specific register (MSR) may be implemented for performing domain configuration, allowing software to invoke the PCONFIG operation by writing to the PCONFIG MSR (e.g., executing a WRMSR instruction with the index for the PCONFIG MSR passed in a register, such as the ECX register). Moreover, certain parameters for the PCONFIG operation (and its associated leaf functions and commands) may be passed in hardware registers. For example, the address of the key program structure (KEY_PROGRAM_STRUCT) can be passed in a hardware register, such as the EDX register, EAX register, or both of those registers (e.g., for 64-bit memory addresses). The PCONFIG operation can then be performed in a similar manner as described above.

Moreover, in some embodiments, a PCONFIG operation may utilize wrapped blobs for domain key programming. In this manner, domain keys can be programmed without revealing the keys to management software. In some embodiments, for example, additional PCONFIG. leaf functions may be implemented to enable keys to be wrapped and then subsequently programmed to memory security engine after being unwrapped.

In some embodiments, a memory encryption capability register (ME_CAPABILITY_MSR) may be used to allow software to discover the memory encryption capabilities. For example, software can read the ME_CAPABILITY_MSR (e.g., using a read MSR (RDMSR) instruction) to identify the supported encryption types and/or algorithms, the maximum number of encryption keys that can be used concurrently, the maximum number of bits used for keyID, and so forth. The ME_CAPABILITY_MSR may be used to identify supported encryption algorithms, a maximum number of keyIDs, a maximum number of keys, etc.

The memory encryption activation register (ME_ACTIVATE_MSR) may be used to activate the cryptographic memory protection (e.g., MKTME). This MSR may include a field to engage a read-only lock (which locks at least this register), a field to enable memory encryption, a field to select a key for default encryption, afield to specify what happens to a default key upon resuming from standby, field to identify a default encryption algorithm to use, a field to identify a number of bits to use for keyIDs, and a field to restrict encryption algorithms that can be used.

Example pseudocode for implementing the PCONFIG instruction is provided below:

```
(* #UD if PCONFIG is not enumerated or CPL > 0 *)
IF CPUID.7.0:EDX[18] = OR CPL > 0 THEN #UD; FI;
(* #GP(0) for an unsupported
leaf function *) IF EAX > 2
THEN #GP(0); FI;
CASE (EAX) (* operation based on selected leaf function *) 0 (MKTME_KEY_PROGRAM):
  IF CPUID function 1BH does not enumerate support for the
  TME-MK target (value 1) THEN #GP(0); FI;
(* Confirm that TME-MK is properly enabled by the IA32_TME_ACTIVATE MSR *)
(* The MSR must be locked, encryption enabled, and a non-zero number of KeyID bits specified
*)
IF IA32_TME_ACTIVATE[0] = 0 OR IA32_TME_ACTIVATE[1] = 0 OR
IA32_TME_ACTIVATE[35:32] = 0
THEN #GP(0); FI;
IF DS:RBX is not 256-byte aligned
THEN #GP(0); FI;
Load TMP_KEY_PROGRAM_STRUCT from 192 bytes at linear address DS:RBX;
IF TMP_KEY_PROGRAM_STRUCT.KEYID_CTRL sets any reserved bits
THEN #GP(0); FI;
(* Check for a valid command *)
IF TMP_KEY_PROGRAM_STRUCT. KEYID_CTRL.COMMAND > 3
THEN #GP(0); FI;
(* Check that the KEYID being operated upon is a valid KEYID *)
IF TMP_KEY_PROGRAM_STRUCT.KEYID = 0 OR
TMP_KEY_PROGRAM_STRUCT.KEYID > 2\hat{ }IA32_TME_ACTIVATE.MK_TME_KEYID_BITS − 1 OR
TMP_KEY_PROGRAM_STRUCT.KEYID > IA32_TME_CAPABILITY.MK_TME_MAX_KEYS
THEN #GP(0); FI;
(* Check that only one encryption algorithm is requested for the KeyID and it is one of the
activated algorithms *)
IF TMP_KEY_PROGRAM_STRUCT.KEYID_CTRL.ENC_ALG does not set exactly one bit OR
(TMP_KEY_PROGRAM_STRUCT.KEYID_CTRL.ENC_ALG & IA32_TME_ACTIVATE[63:48]) = 0
THEN #GP(0); FI;
Attempt to acquire lock to gain exclusive access to platform key table for TME-MK;
IF attempt is unsuccessful
THEN (* PCONFIG failure *)
RFLAGS.ZF := 1;
RAX := DEVICE_BUSY; (* failure reason 5 *)
GOTO EXIT;
FI;
CASE (TMP_KEY_PROGRAM_STRUCT.KEYID_CTRL.COMMAND) OF
0 (KEYID_SET_KEY_DIRECT):
Update TME-MK table for TMP_KEY_PROGRAM_STRUCT.KEYID as follows:
Encrypt with the selected key
Use the encryption algorithm selected by
TMP_KEY_PROGRAM_STRUCT.KEYID_CTRL.ENC_ALG
(* The number of bytes used by the next two lines depends on selected encryption
algorithm *)
DATA_KEY is TMP_KEY_PROGRAM_STRUCT.KEY_FIELD_1
TWEAK_KEY is TMP_KEY_PROGRAM_STRUCT.KEY_FIELD_2
BREAK;
1 (KEYID_SET_KEY_RANDOM):
Load TMP_RND_DATA_KEY with a random key using hardware RNG; (* key size depends on
selected encryption algorithm *)
IF there was insufficient entropy
THEN (* PCONFIG failure *)
RFLAGS.ZF := 1;
RAX := ENTROPY_ERROR; (* failure reason 2 *)
Release lock on platform key table;
GOTO EXIT;
FI;
Load TMP_RND_TWEAK_KEY with a random key using hardware RNG; (* key size depends on
selected encryption algorithm *)
IF there was insufficient entropy
THEN (* PCONFIG failure *)
RFLAGS.ZF := 1;
RAX := ENTROPY_ERROR; (* failure reason 2 *)
Release lock on platform key table;
GOTO EXIT;
FI;
(* Combine software-supplied entropy to the data key and tweak key *)
(* The number of bytes used by the next two lines depends on selected encryption
algorithm *)
TMP_RND_DATA_KEY := TMP_RND_KEY XOR TMP_KEY_PROGRAM_STRUCT.KEY_FIELD_1;
TMP_RND_TWEAK_KEY := TMP_RND_TWEAK_KEY XOR
TMP_KEY_PROGRAM_STRUCT.KEY_FIELD_2;
Update TME-MK table for TMP_KEY_PROGRAM_STRUCT.KEYID as follows:
Encrypt with the selected key
Use the encryption algorithm selected by
TMP_KEY_PROGRAM_STRUCT.KEYID_CTRL.ENC_ALG
(* The number of bytes used by the next two lines depends on selected encryption
algorithm *)
DATA_KEY is TMP_RND_DATA_KEY
TWEAK_KEY is TMP_RND_TWEAK_KEY
BREAK;
2 (KEYID_CLEAR_KEY):
Update TME-MK table for TMP_KEY_PROGRAM_STRUCT.KEYID as follows:
Encrypt (or not) using the current configuration for TME
The specified encryption algorithm and key values are not used.
BREAK;
3 (KEYID_NO_ENCRYPT):
Update TME-MK table for TMP_KEY_PROGRAM_STRUCT.KEYID as follows:
Do not encrypt
The specified encryption algorithm and key values are not used.
BREAK;
ESAC;
Release lock on platform key table for TME-MK;
1 (TSE_KEY_PROGRAM):
IF CPUID function 1BH does not enumerate support for the TSE target (value 2)
THEN #GP(0); FI;
IF not in 64-bit mode
THEN #GP(0); FI;
IF RBX is not 256-byte aligned
THEN #GP(0); FI;
Load TMP_KEY_STRUCT from 192 bytes at linear address in RBX;
IF TMP_KEY_STRUCT.KEYID_CTRL sets any reserved bits
THEN #GP(0); FI;
(* Check for a valid command *)
IF TMP_KEY_STRUCT. KEYID_CTRL.COMMAND > 1
THEN #GP(0); FI;
(* Check that the KEYID being operated upon is a valid KEYID *)
IF TMP_KEY_STRUCT.KEYID > IA32_TSE_CAPABILITY.TSE_MAX_KEYS
THEN #GP(0); FI;
(* Check that only one encryption algorithm is requested for the KeyID and it is one of the
activated algorithms *)
IF TMP_KEY_STRUCT.KEYID_CTRL.ENC_ALG does not set exactly one bit OR
(TMP_KEY_STRUCT.KEYID_CTRL.ENC_ALG & IA32_TSE_CAPABILITY[15:0]) = 0
THEN #GP(0); FI;
Attempt to acquire lock to gain exclusive access to platform key table for TSE;
IF attempt is unsuccessful
THEN (* PCONFIG failure *)
RFLAGS.ZF := 1;
RAX := DEVICE_BUSY; (* failure reason 5 *)
GOTO EXIT;
FI;
CASE (TMP_KEY_STRUCT.KEYID_CTRL.COMMAND) OF
0 (TSE_SET_KEY_DIRECT):
Update TSE table for TMP_KEY_STRUCT.KEYID as follows:
Encrypt with the selected key
Use the encryption algorithm selected by TMP_KEY_STRUCT.KEYID_CTRL.ENC_ALG
(* The number of bytes used by the next two lines depends on selected encryption
algorithm *)
DATA_KEY is TMP_KEY_STRUCT.KEY_FIELD_1
TWEAK_KEY is TMP_KEY_STRUCT.KEY_FIELD_2
BREAK;
1 (TSE_NO_ENCRYPT):
Update TSE table for TMP_KEY_STRUCT.KEYID as follows:
Do not encrypt
The specified encryption algorithm and key values are not used.
BREAK;
ESAC;
Release lock on platform key table for TSE;
2 (TSE_KEY_PROGRAM_WRAPPED):
IF CPUID function 1BH does not enumerate support for the TSE target (value 2)
THEN #GP(0); FI;
IF not in 64-bit mode OR RBX[23:16] != 0 OR RBX[63:40] != 0 OR RCX is not 256-byte aligned
THEN #GP(0); FI;
(* Check that the KEYID being operated upon is a valid KEYID *)
IF RBX[15:0] > IA32_TSE_CAPABILITY.TSE_MAX_KEYS
THEN #GP(0); FI;
(* Check that only one encryption algorithm is requested for the KeyID and it is one of the
activated algorithms *)
IF RBX[39:24] does not set exactly one bit OR (RBX[39:24] & IA32_TSE_CAPABILITY[15:0]) = 0
THEN #GP(0); FI;
Load TMP_BIND_STRUCT from 256 bytes at linear address in RCX;
(* Check TMP_BIND_STRUCT for illegal values *)
IF bytes 23:16 and bytes 63:36 of TMP_BIND_STRUCT are not all zero
THEN #GP(0); FI;
IF TMP_BIND_STRUCT.BTDATA.KEY_GENERATION_CTRL > 1
THEN #GP(0); FI;
IF bytes 128:33 of TMP_BIND_STRUCT.BTDATA are not all zero
THEN #GP(0); FI;
(* Compute wrapping key *)
PLATFORM_KEY := 256-bit platform-specific key;
WRAPPING_KEY := HMAC_SHA256(PLATFORM_KEY,
TMP_BIND_STRUCT.BTDATA.USER_SUPP_CHALLENGE);
(* Compose 176 bytes of additional authenticated data for use by authenticated decryption
*)
AAD := Concatenation of bytes 63:16 and bytes 255:128 of TMP_BIND_STRUCT;
DECRYPT_STRUCT := AES256_GCM_ENC(TMP_BIND_STRUCT.BTENCDATA, WRAPPING_KEY,
TMP_BIND_STRUCT.IV, AAD, 176);
(* Fail if MAC mismatch *)
IF TMP_BIND_STRUCT.MAC != DECRYPT_STRUCT.MAC
THEN
RFLAGS.ZF := 1;
RAX := UNWRAP_FAILURE; (* failure reason 7 *)
GOTO EXIT;
FI;
Attempt to acquire lock to gain exclusive access to platform key table for TSE;
IF attempt is unsuccessful
THEN (* PCONFIG failure *)
RFLAGS.ZF := 1;
RAX := DEVICE_BUSY; (* failure reason 5 *)
GOTO EXIT;
FI;
Update TSE table for RBX[15:0] as follows:
Encrypt with the selected key
Use the encryption algorithm selected by RBX[39:24]
(* The number of bytes used by the next two lines depends on selected encryption
algorithm *)
DATA_KEY is DECRYPT_STRUCT.DEC_DATA.KEY_FIELD_1
TWEAK_KEY is DECRYPT_STRUCT.DEC_DATA.KEY_FIELD_2
Release lock on platform key table for TSE;
ESAC;
RAX := 0;
RFLAGS.ZF := 0;
EXIT:
RFLAGS.CF := 0;
RFLAGS.PF := 0;
RFLAGS.AF := 0;
RFLAGS.OF := 0;
RFLAGS.SF := 0;
```

In some examples, a platform bind key to binary large object (PBNDKB) instruction allows software to bind information to a platform by encrypting it with a platform-specific wrapping key. The encrypted data may later be used by the PCONFIG instruction to configure the total storage encryption (TSE) engine.

In some examples, the PCONFIG instruction has an opcode of 0F 01 C7.

In some examples, the instruction can be executed only in 64-bit mode. The registers RBX and RCX provide input information to the instruction. Executions of PBNDKB may fail for platform-specific reasons. An execution reports failure by setting the ZF flag and loading EAX with a non-zero failure reason; a successful execution clears ZF and EAX.

The instruction operates on 256-byte data structures called bind structures. It reads a bind structure at the linear address in RBX and writes a modified bind structure to the linear address in RCX. The addresses in RBX and RCX must be different from each other and must be 256-byte aligned. Note that RBX and RCX are implicit operands in some examples. Implicit operands are not encoded in the instruction itself.

The instruction encrypts a portion of the input bind structure and generates a MAC of parts of that structure. The encrypted data and MAC are written out as part of the output bind structure. Examples of a bind structure are shown below:

| | Offset | Size | |
|---|---|---|---|
| Field | (bytes) | (bytes) | Comments |
| MAC | 0 | 16 | Output by PBNDKB as a MAC based |
| | | | on the input bind structure |
| Reserved | 16 | 8 | Reserved, must be zero on input, |
| | | | output as zero |
| IV | 24 | 12 | Initialization vector generated and |
| | | | output by PBNDKB |
| Reserved | 36 | 28 | Reserved, must be zero on input, |
| | | | output as zero |
| BTENCDATA | 64 | 64 | Encryption data (plaintext on input; |
| | | | ciphertext on output) |
| BTDATA | 128 | 128 | Additional control and data (modified |
| | | | but not encrypted) |

MAC: A MAC produced by PBNDKB of parts of its input bind structure. This field in the input bind structure is not used.
IV: PBNDKB randomly generates a 96-bit initialization vector and uses it as input to an authenticated encryption function. The generated IV is written to the output bind structure. If there is insufficient entropy for the random-number generator, PBNDKB will fail and report the failure by loading EAX with a value (ENTROPY_ERROR). This field in the input bind structure is not used.
BTENCDATA: In the input bind structure, the field contains the data to be encrypted. The data consist of two 256-bit keys, a data key and a tweak key. If the value of the KEY_GENERATION_CTRL field of the BTDATA (see below) is 1, PBNDKB randomizes the values of these keys before encrypting them. (If there is insufficient entropy for the random-number generator, PBNDKB will fail and report the failure by loading EAX with a value (ENTROPY_ERROR).) PBNDKB writes the encrypted data to this field in the output bind structure.
BTDATA: This field contains additional control and data that are not encrypted. It has the following format in some examples:
   USER_SUPP_CHALLENGE (bytes 31:0): PBNDKB uses this value in the input bind structure to determine the wrapping key (see below). It writes zero to this field in the output bind structure.
   KEY_GENERATION_CTRL (byte 32): PBNDKB uses this value in the input bind structure to determine whether to randomize the keys being encrypted. The value must be 0 or 1 (otherwise, a #GP occurs).
   The remaining 95 bytes are reserved and must be zero.

In some examples, PBNDKB determines a 256-bit wrapping key by computing an HMAC based on SHA-256 using 256-bit platform-specific key and the USER_SUPP_CHALLENGE in the BTDATA field in the input bind structure.

In some examples, PBNDKB then uses the wrapping key and an AES GCM authenticated encryption function to encrypt BTENCDATA and produce a MAC. The encryption function uses the following inputs:
The 64-byte BTENCDATA to be decrypted (which may have been randomized; see above).
The 256-bit wrapping key.
The 96-bit IV randomly generated by PBNDKB.
176 bytes of additional authenticated data that are the concatenation of 8 bytes of zeroes, the IV, 28 bytes of zeroes, and the BTDATA in the input bind structure.
The length of the additional authenticated data (176).

In some examples, The encryption function produces a structure with 64 bytes of encrypted data and a 16-byte MAC. PBNDKB saves these values to the corresponding fields in its output bind structure. Other fields are copied from the input bind structure, except the IV (which receives the randomly generated value) and the USER_SUPP_CHALLENGE in the BTDATA, which is written as zero.

Example pseudocode for the execution of PBNDKB is shown below:

```
(* #UD if PBNDKB is not enumerated, CPL > 0, or not in 64-bit mode*) IF CPUID.7.1.EBX[1] = 0 OR
CPL > 0 OR not in 64-bit mode
THEN #UD; FI;
(* #GP if pointers are not aligned or overlapping *)
IF RBX = RCX OR RBX is not 256-byte aligned OR RCX is not 256-byte aligned
  THEN #GP(0); FI;
Load TMP_BIND_STRUCT from 256 bytes at linear address in RBX;
(* Check TMP_BIND_STRUCT for illegal values *)
IF bytes 23:16 and bytes 63:36 of TMP_BIND_STRUCT are not all zero
  THEN #GP(0);
FI;
IF TMP_BIND_STRUCT.BTDATA.KEY_GENERATION_CTRL > 1
  THEN #GP(0);
FI;
IF bytes 128:33 of TMP_BIND_STRUCT.BTDATA are not all zero
  THEN #GP(0);
FI;
(* Randomize input keys if requested *)
IF TMP_BIND_STRUCT.BTDATA.KEY_GENERATION_CONTROL= 1 THEN
  Load RNG_DATA_KEY with a random 256-bit value using hardware RNG;
  Load RNG_TWEAK_KEY with a random 256-bit value using hardware RNG;
  IF there was insufficient entropy
  THEN (* PBNDKB failure *)
    RFLAGS.ZF := 1;
    RAX := ENTROPY_ERROR; (* failure reason 2 *)
  GOTO EXIT;
  FI;
(* XOR the input keys with the random keys; this does not modify input bind structure in memory
*)
TMP_BIND_STRUCT.BTENCDATA.DATA_KEY := RNG_DATA_KEY XOR
TMP_BIND_STRUCT.BTENCDATA.DATA_KEY;
TMP_BIND_STRUCT.BTENCDATA.TWEAK_KEY := RNG_TWEAK_KEY XOR
TMP_BIND_STRUCT.BTENCDATA.TWEAK_KEY;
FI;
(* Compute wrapping key from platform key and user challenge *)
PLATFORM_KEY := 256-bit platform-specific key;
// HMAC_256 = hash-based message authentication code (HMAC) computed using
//SHA256
WRAPPING_KEY := HMAC_SHA256(PLATFORM_KEY,
TMP_BIND_STRUCT.BTDATA.USER_SUPP_CHALLENGE);
(* Generate random data for initialization vector *)
Load TMP_IV with a random 96-bit value using hardware RNG;
IF there was insufficient entropy
  THEN (* PBNDKB failure *)
  RFLAGS.ZF := 1;
  RAX := ENTROPY_ERROR; (* failure reason 2 *)
  GOTO EXIT;
FI;
(* Compose 176 bytes of additional authenticated data for use by
authenticated decryption *)
AAD := Concatenation of bytes 63:16 and bytes 255:128 of TMP_BIND_STRUCT;
// USE AES256 Glois/Counter Mode to encrypt
// TMP_BIND_STRUCT.BTENDATA = input data
ENCRYPT_STRUCT := AES256_GCM_ENC(TMP_BIND_STRUCT.BTENCDATA, WRAPPING_KEY,
TMP_IV, AAD, 176);
OUT_BIND_STRUCT.MAC := ENCRYPT_STRUCT.MAC;
OUT_BIND_STRUCT[bytes 23:16] := 0;
OUT_BIND_STRUCT.IV := TMP_IV;
OUT_BIND_STRUCT[bytes 63:36] := 0;
//
OUT_BIND_STRUCT.BTENCDATA := ENCRYPT_STRUCT.ENC_DATA;
OUT_BIND_STRUCT.BTDATA.USER_SUPP_CHALLENGE := 0;
OUT_BIND_STRUCT.BTDATA.KEY_GENERATION_CTRL :=
IN_BIND_STRUCT.BTDATA.KEY_GENERATION_CTRL;
(* Save OUT_BIND_STRUCT to memory *)
Store OUT_BIND_STRUCT to 256 bytes at linear address in RCX;
(* Indicate successful completion *) RAX := 0;
RFLAGS.ZF := 0;
EXIT: RFLAGS.CF := 0;
RFLAGS.PF := 0;
RFLAGS.AF := 0;
RFLAGS.OF := 0;
RFLAGS.SF := 0;
```

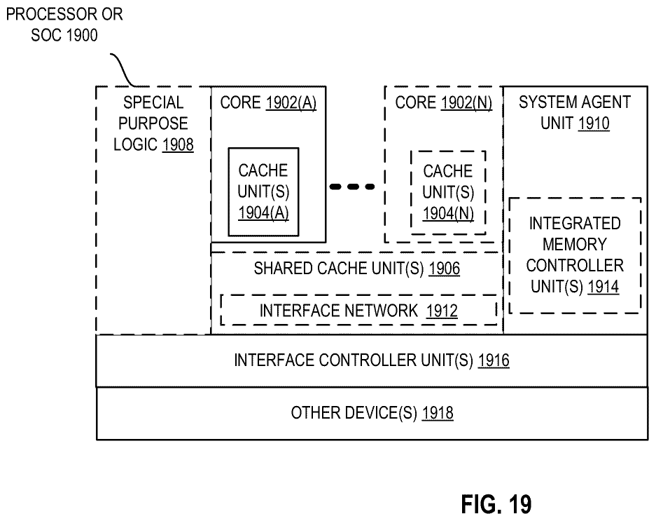

FIG. 17 illustrates embodiments of processing an instruction. At 1701, a single instruction is fetched. For example, a PCONFIG or PBNDKB instruction is fetched.

The fetched single instruction (or translated instruction(s)) is/are decoded at 1703. For example, the fetched PCONFIG instruction is decoded by decode circuitry such as that detailed herein.

Data values associated with the source operand(s) of the decoded instruction is retrieved at 1705. For example, when one or more of the source operands are memory operands, the data from the indicated memory location is retrieved. Note that in some examples one or more source operands are implicit.

At 1707, the decoded instruction (or translated instruction(s)) is/are executed by execution circuitry (hardware) such as that detailed herein according to the opcode. In some examples, the execution uses execution circuitry for the instruction to perform the operations of the pseudocode for PCONFIC or PBNDKB.

In some embodiments, the instruction is committed or retired at 1709.

Some examples utilize instruction formats described herein. Some examples are implemented in one or more computer architectures, cores, accelerators, etc. Some examples are generated or are IP cores. Some examples utilize emulation and/or translation.

### Example Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

### Example Systems

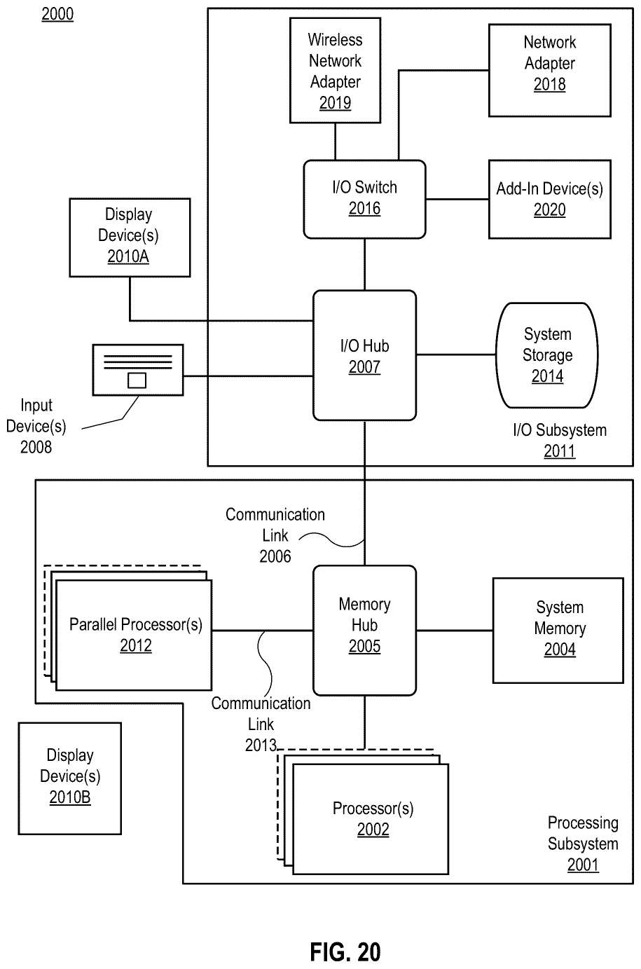

FIG. 18 illustrates an example computing system. Multiprocessor system 1800 is an interfaced system and includes a plurality of processors or cores including a first processor 1870 and a second processor 1880 coupled via an interface 1850 such as a point-to-point (P-P) interconnect, a fabric, and/or bus. In some examples, the first processor 1870 and the second processor 1880 are homogeneous. In some examples, first processor 1870 and the second processor 1880 are heterogenous. Though the example system 1800 is shown to have two processors, the system may have three or more processors, or may be a single processor system. In some examples, the computing system is a system on a chip (SoC).

Processors 1870 and 1880 are shown including integrated memory controller (IMC) circuitry 1872 and 1882, respectively. Processor 1870 also includes interface circuits 1876 and 1878; similarly, second processor 1880 includes interface circuits 1886 and 1888. Processors 1870, 1880 may exchange information via the interface 1850 using interface circuits 1878, 1888. IMCs 1872 and 1882 couple the processors 1870, 1880 to respective memories, namely a memory 1832 and a memory 1834, which may be portions of main memory locally attached to the respective processors.

Processors 1870, 1880 may each exchange information with a network interface (NW I/F) 1890 via individual interfaces 1852, 1854 using interface circuits 1876, 1894, 1886, 1898. The network interface 1890 (e.g., one or more of an interconnect, bus, and/or fabric, and in some examples is a chipset) may optionally exchange information with a coprocessor 1838 via an interface circuit 1892. In some examples, the coprocessor 1838 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 1870, 1880 or outside of both processors, yet connected with the processors via an interface such as P-P interconnect, such that either or both processors' local cache information may be stored in the shared cache if a processor is placed into a low power mode.

Network interface 1890 may be coupled to a first interface 1816 via interface circuit 1896. In some examples, first interface 1816 may be an interface such as a Peripheral Component Interconnect (PCI) interconnect, a PCI Express interconnect or another I/O interconnect. In some examples, first interface 1816 is coupled to a power control unit (PCU) 1817, which may include circuitry, software, and/or firmware to perform power management operations with regard to the processors 1870, 1880 and/or co-processor 1838. PCU 1817 provides control information to a voltage regulator (not shown) to cause the voltage regulator to generate the appropriate regulated voltage. PCU 1817 also provides control information to control the operating voltage generated. In various examples, PCU 1817 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1817 is illustrated as being present as logic separate from the processor 1870 and/or processor 1880. In other cases, PCU 1817 may execute on a given one or more of cores (not shown) of processor 1870 or 1880. In some cases, PCU 1817 may be implemented as a microcontroller (dedicated or general-purpose) or other control logic configured to execute its own dedicated power management code, sometimes referred to as P-code. In yet other examples, power management operations to be performed by PCU 1817 may be implemented externally to a processor, such as by way of a separate power management integrated circuit (PMIC) or another component external to the processor. In yet other examples, power management operations to be performed by PCU 1817 may be implemented within BIOS or other system software.

Various I/O devices 1814 may be coupled to first interface 1816, along with a bus bridge 1818 which couples first interface 1816 to a second interface 1820. In some examples, one or more additional processor(s) 1815, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 1816. In some examples, second interface 1820 may be a low pin count (LPC) interface. Various devices may be coupled to second interface 1820 including, for example, a keyboard and/or mouse 1822, communication devices 1827 and storage circuitry 1828. Storage circuitry 1828 may be one or more non-transitory machine-readable storage media as described below, such as a disk drive or other mass storage device which may include instructions/code and data 1830 and may implement the storage 'ISAB03 in some examples. Further, an audio I/O 1824 may be coupled to second interface 1820. Note that other architectures than the point-to-point architecture described above are possible. For example, instead of the point-to-point architecture, a system such as multiprocessor system 1800 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

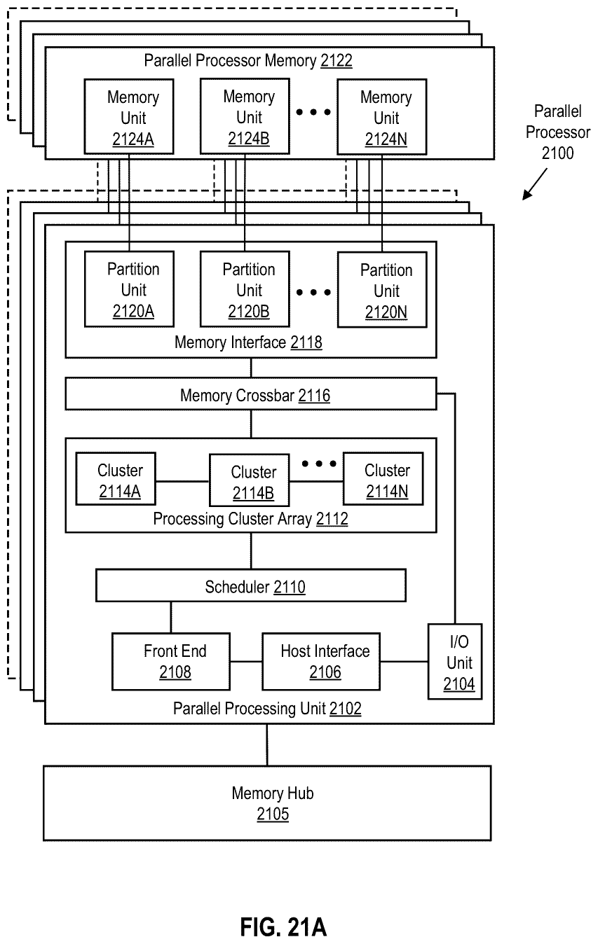

FIG. 19 illustrates a block diagram of an example processor and/or SoC 1900 that may have one or more cores and an integrated memory controller. The solid lined boxes illustrate a processor 1900 with a single core 1902(A), system agent unit circuitry 1910, and a set of one or more interface controller unit(s) circuitry 1916, while the optional addition of the dashed lined boxes illustrates an alternative processor 1900 with multiple cores 1902(A)-(N), a set of one or more integrated memory controller unit(s) circuitry 1914 in the system agent unit circuitry 1910, and special purpose logic 1908, as well as a set of one or more interface controller units circuitry 1916. Note that the processor 1900 may be one of the processors 1870 or 1880, or co-processor 1838 or 1815 of FIG. 18.

Thus, different implementations of the processor 1900 may include: 1) a CPU with the special purpose logic 1908 being integrated graphics and/or scientific (throughput) logic (which may include one or more cores, not shown), and the cores 1902(A)-(N) being one or more general purpose cores (e.g., general purpose in-order cores, general purpose out-of-order cores, or a combination of the two); 2) a coprocessor with the cores 1902(A)-(N) being a large number of special purpose cores intended primarily for graphics and/or scientific (throughput); and 3) a coprocessor with the cores 1902(A)-(N) being a large number of general purpose in-order cores. Thus, the processor 1900 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 1900 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1904(A)-(N) within the cores 1902(A)-(N), a set of one or more shared cache unit(s) circuitry 1906, and external memory (not shown) coupled to the set of integrated memory controller unit(s) circuitry 1914. The set of one or more shared cache unit(s) circuitry 1906 may include one or more mid-level caches, such as level 2 (L2), level 3 (L3), level 4 (L4), or other levels of cache, such as a last level cache (LLC), and/or combinations thereof. While in some examples interface network circuitry 1912 (e.g., a ring interconnect) interfaces the special purpose logic 1908 (e.g., integrated graphics logic), the set of shared cache unit(s) circuitry 1906, and the system agent unit circuitry 1910, alternative examples use any number of well-known techniques for interfacing such units. In some examples, coherency is maintained between one or more of the shared cache unit(s) circuitry 1906 and cores 1902(A)-(N). In some examples, interface controller units circuitry 1916 couple the cores 1902 to one or more other devices 1918 such as one or more I/O devices, storage, one or more communication devices (e.g., wireless networking, wired networking, etc.), etc.

In some examples, one or more of the cores 1902(A)-(N) are capable of multi-threading. The system agent unit circuitry 1910 includes those components coordinating and operating cores 1902(A)-(N). The system agent unit circuitry 1910 may include, for example, power control unit (PCU) circuitry and/or display unit circuitry (not shown). The PCU may be or may include logic and components needed for regulating the power state of the cores 1902(A)-(N) and/or the special purpose logic 1908 (e.g., integrated graphics logic). The display unit circuitry is for driving one or more externally connected displays.

The cores 1902(A)-(N) may be homogenous in terms of instruction set architecture (ISA). Alternatively, the cores 1902(A)-(N) may be heterogeneous in terms of ISA; that is, a subset of the cores 1902(A)-(N) may be capable of executing an ISA, while other cores may be capable of executing only a subset of that ISA or another ISA.

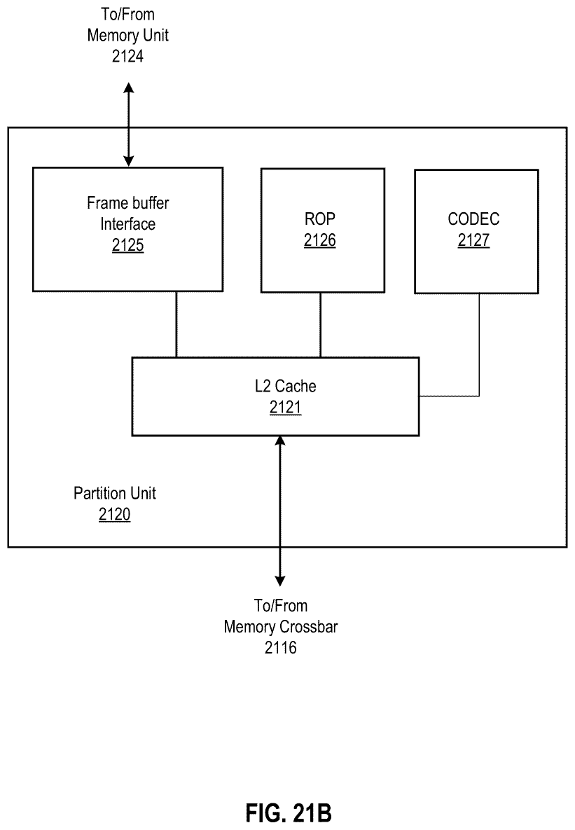

FIG. 20 is a block diagram illustrating a computing system 2000 configured to implement one or more aspects of the examples described herein. The computing system 2000 includes a processing subsystem 2001 having one or more processor(s) 2002 and a system memory 2004 communicating via an interconnection path that may include a memory hub 2005. The memory hub 2005 may be a separate component within a chipset component or may be integrated within the one or more processor(s) 2002. The memory hub 2005 couples with an I/O subsystem 2011 via a communication link 2006. The I/O subsystem 2011 includes an I/O hub 2007 that can enable the computing system 2000 to receive input from one or more input device(s) 2008. Additionally, the I/O hub 2007 can enable a display controller, which may be included in the one or more processor(s) 2002, to provide outputs to one or more display device(s) 2010A. In some examples the one or more display device(s) 2010A coupled with the I/O hub 2007 can include a local, internal, or embedded display device.

The processing subsystem 2001, for example, includes one or more parallel processor(s) 2012 coupled to memory hub 2005 via a bus or other communication link 2013. The communication link 2013 may be one of any number of standards-based communication link technologies or protocols, such as, but not limited to PCI Express, or may be a vendor specific communications interface or communications fabric. The one or more parallel processor(s) 2012 may form a computationally focused parallel or vector processing system that can include a large number of processing cores and/or processing clusters, such as a many integrated core (MIC) processor. For example, the one or more parallel processor(s) 2012 form a graphics processing subsystem that can output pixels to one of the one or more display device(s) 2010A coupled via the I/O hub 2007. The one or more parallel processor(s) 2012 can also include a display controller and display interface (not shown) to enable a direct connection to one or more display device(s) 2010B.

Within the I/O subsystem 2011, a system storage unit 2014 can connect to the I/O hub 2007 to provide a storage mechanism for the computing system 2000. An I/O switch 2016 can be used to provide an interface mechanism to enable connections between the I/O hub 2007 and other components, such as a network adapter 2018 and/or wireless network adapter 2019 that may be integrated into the platform, and various other devices that can be added via one or more add-in device(s) 2020. The add-in device(s) 2020 may also include, for example, one or more external graphics processor devices, graphics cards, and/or compute accelerators. The network adapter 2018 can be an Ethernet adapter or another wired network adapter. The wireless network adapter 2019 can include one or more of a Wi-Fi, Bluetooth, near field communication (NFC), or other network device that includes one or more wireless radios.

The computing system 2000 can include other components not explicitly shown, including USB or other port connections, optical storage drives, video capture devices, and the like, which may also be connected to the I/O hub 2007. Communication paths interconnecting the various components in FIG. 20 may be implemented using any suitable protocols, such as PCI (Peripheral Component Interconnect) based protocols (e.g., PCI-Express), or any other bus or point-to-point communication interfaces and/or protocol(s), such as the NVLink high-speed interconnect, Compute Express Link™ (CXL™) (e.g., CXL.mem), Infinity Fabric (IF), Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Intel QuickPath Interconnect (QPI), Intel Ultra Path Interconnect (UPI), Intel On-Chip System Fabric (IOSF), Omnipath, HyperTransport, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof, or wired or wireless interconnect protocols known in the art. In some examples, data can be copied or stored to virtualized storage nodes using a protocol such as non-volatile memory express (NVMe) over Fabrics (NVMe-oF) or NVMe.

The one or more parallel processor(s) 2012 may incorporate circuitry optimized for graphics and video processing, including, for example, video output circuitry, and constitutes a graphics processing unit (GPU). Alternatively or additionally, the one or more parallel processor(s) 2012 can incorporate circuitry optimized for general purpose processing, while preserving the underlying computational architecture, described in greater detail herein. Components of the computing system 2000 may be integrated with one or more other system elements on a single integrated circuit. For example, the one or more parallel processor(s) 2012, memory hub 2005, processor(s) 2002, and I/O hub 2007 can be integrated into a system on chip (SoC) integrated circuit. Alternatively, the components of the computing system 2000 can be integrated into a single package to form a system in package (SIP) configuration. In some examples at least a portion of the components of the computing system 2000 can be integrated into a multi-chip module (MCM), which can be interconnected with other multi-chip modules into a modular computing system.

It will be appreciated that the computing system 2000 shown herein is illustrative and that variations and modifications are possible. The connection topology, including the number and arrangement of bridges, the number of processor(s) 2002, and the number of parallel processor(s) 2012, may be modified as desired. For instance, system memory 2004 can be connected to the processor(s) 2002 directly rather than through a bridge, while other devices communicate with system memory 2004 via the memory hub 2005 and the processor(s) 2002. In other alternative topologies, the parallel processor(s) 2012 are connected to the I/O hub 2007 or directly to one of the one or more processor(s) 2002, rather than to the memory hub 2005. In other examples, the I/O hub 2007 and memory hub 2005 may be integrated into a single chip. It is also possible that two or more sets of processor(s) 2002 are attached via multiple sockets, which can couple with two or more instances of the parallel processor(s) 2012.

Some of the particular components shown herein are optional and may not be included in all implementations of the computing system 2000. For example, any number of add-in cards or peripherals may be supported, or some components may be eliminated. Furthermore, some architectures may use different terminology for components similar to those illustrated in FIG. 20. For example, the memory hub 2005 may be referred to as a Northbridge in some architectures, while the I/O hub 2007 may be referred to as a Southbridge.

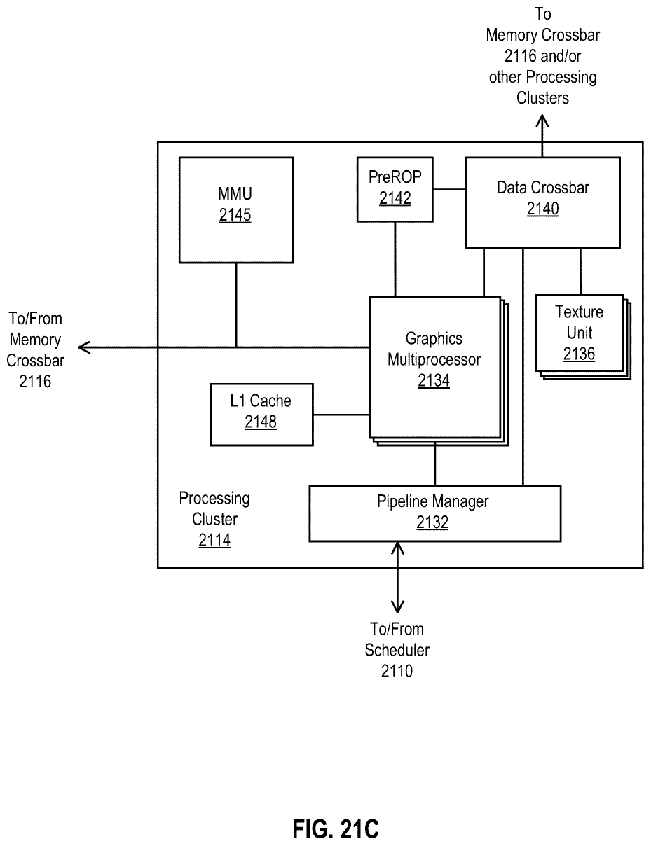

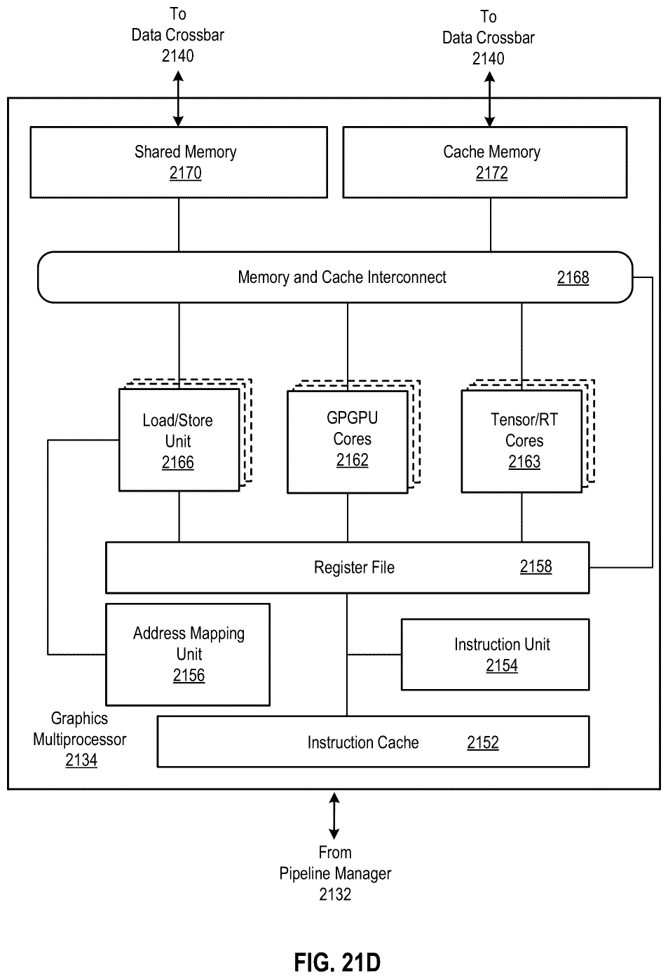

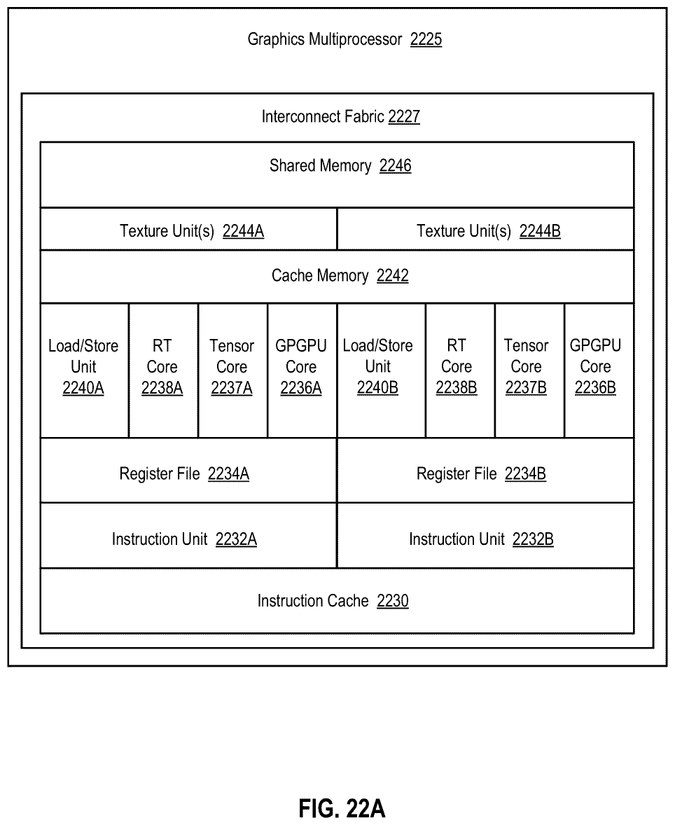

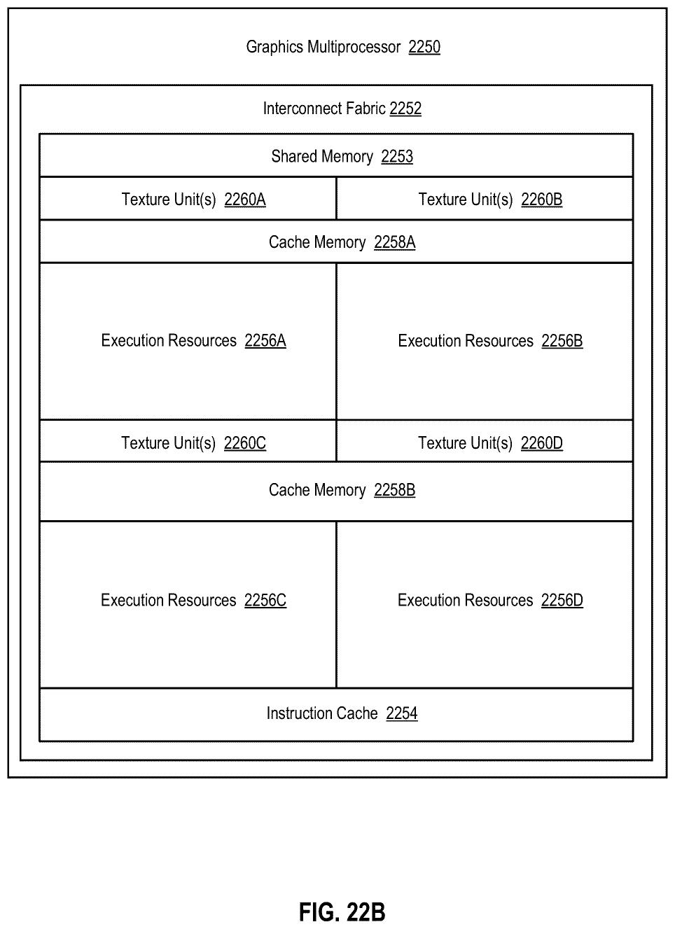

FIG. 21A illustrates examples of a parallel processor 2100. The parallel processor 2100 may be a GPU, GPGPU or the like as described herein. The various components of the parallel processor 2100 may be implemented using one or more integrated circuit devices, such as programmable processors, application specific integrated circuits (ASICs), or field programmable gate arrays (FPGA). The illustrated parallel processor 2100 may be one or more of the parallel processor(s) 2012 shown in FIG. 20.

The parallel processor 2100 includes a parallel processing unit 2102. The parallel processing unit includes an I/O unit 2104 that enables communication with other devices, including other instances of the parallel processing unit 2102. The I/O unit 2104 may be directly connected to other devices. For instance, the I/O unit 2104 connects with other devices via the use of a hub or switch interface, such as memory hub 2005. The connections between the memory hub 2005 and the I/O unit 2104 form a communication link 2013. Within the parallel processing unit 2102, the I/O unit 2104 connects with a host interface 2106 and a memory crossbar 2116, where the host interface 2106 receives commands directed to performing processing operations and the memory crossbar 2116 receives commands directed to performing memory operations.

When the host interface 2106 receives a command buffer via the I/O unit 2104, the host interface 2106 can direct work operations to perform those commands to a front end 2108. In some examples the front end 2108 couples with a scheduler 2110, which is configured to distribute commands or other work items to a processing cluster array 2112. The scheduler 2110 ensures that the processing cluster array 2112 is properly configured and in a valid state before tasks are distributed to the processing clusters of the processing cluster array 2112. The scheduler 2110 may be implemented via firmware logic executing on a microcontroller. The microcontroller implemented scheduler 2110 is configurable to perform complex scheduling and work distribution operations at coarse and fine granularity, enabling rapid preemption and context switching of threads executing on the processing cluster array 2112. Preferably, the host software can prove workloads for scheduling on the processing cluster array 2112 via one of multiple graphics processing doorbells. In other examples, polling for new workloads or interrupts can be used to identify or indicate availability of work to perform. The workloads can then be automatically distributed across the processing cluster array 2112 by the scheduler 2110 logic within the scheduler microcontroller.

The processing cluster array 2112 can include up to “N” processing clusters (e.g., cluster 2114A, cluster 2114B, through cluster 2114N). Each cluster 2114A-2114N of the processing cluster array 2112 can execute a large number of concurrent threads. The scheduler 2110 can allocate work to the clusters 2114A-2114N of the processing cluster array 2112 using various scheduling and/or work distribution algorithms, which may vary depending on the workload arising for each type of program or computation. The scheduling can be handled dynamically by the scheduler 2110 or can be assisted in part by compiler logic during compilation of program logic configured for execution by the processing cluster array 2112. Optionally, different clusters 2114A-2114N of the processing cluster array 2112 can be allocated for processing different types of programs or for performing different types of computations.

The processing cluster array 2112 can be configured to perform various types of parallel processing operations. For example, the processing cluster array 2112 is configured to perform general-purpose parallel compute operations. For example, the processing cluster array 2112 can include logic to execute processing tasks including filtering of video and/or audio data, performing modeling operations, including physics operations, and performing data transformations.

The processing cluster array 2112 is configured to perform parallel graphics processing operations. In such examples in which the parallel processor 2100 is configured to perform graphics processing operations, the processing cluster array 2112 can include additional logic to support the execution of such graphics processing operations, including, but not limited to texture sampling logic to perform texture operations, as well as tessellation logic and other vertex processing logic. Additionally, the processing cluster array 2112 can be configured to execute graphics processing related shader programs such as, but not limited to vertex shaders, tessellation shaders, geometry shaders, and pixel shaders. The parallel processing unit 2102 can transfer data from system memory via the I/O unit 2104 for processing. During processing the transferred data can be stored to on-chip memory (e.g., parallel processor memory 2122) during processing, then written back to system memory.

In examples in which the parallel processing unit 2102 is used to perform graphics processing, the scheduler 2110 may be configured to divide the processing workload into approximately equal sized tasks, to better enable distribution of the graphics processing operations to multiple clusters 2114A-2114N of the processing cluster array 2112. In some of these examples, portions of the processing cluster array 2112 can be configured to perform different types of processing. For example, a first portion may be configured to perform vertex shading and topology generation, a second portion may be configured to perform tessellation and geometry shading, and a third portion may be configured to perform pixel shading or other screen space operations, to produce a rendered image for display. Intermediate data produced by one or more of the clusters 2114A-2114N may be stored in buffers to allow the intermediate data to be transmitted between clusters 2114A-2114N for further processing.

During operation, the processing cluster array 2112 can receive processing tasks to be executed via the scheduler 2110, which receives commands defining processing tasks from front end 2108. For graphics processing operations, processing tasks can include indices of data to be processed, e.g., surface (patch) data, primitive data, vertex data, and/or pixel data, as well as state parameters and commands defining how the data is to be processed (e.g., what program is to be executed). The scheduler 2110 may be configured to fetch the indices corresponding to the tasks or may receive the indices from the front end 2108. The front end 2108 can be configured to ensure the processing cluster array 2112 is configured to a valid state before the workload specified by incoming command buffers (e.g., batch-buffers, push buffers, etc.) is initiated.

Each of the one or more instances of the parallel processing unit 2102 can couple with parallel processor memory 2122. The parallel processor memory 2122 can be accessed via the memory crossbar 2116, which can receive memory requests from the processing cluster array 2112 as well as the I/O unit 2104. The memory crossbar 2116 can access the parallel processor memory 2122 via a memory interface 2118. The memory interface 2118 can include multiple partition units (e.g., partition unit 2120A, partition unit 2120B, through partition unit 2120N) that can each couple to a portion (e.g., memory unit) of parallel processor memory 2122. The number of partition units 2120A-2120N may be configured to be equal to the number of memory units, such that a first partition unit 2120A has a corresponding first memory unit 2124A, a second partition unit 2120B has a corresponding second memory unit 2124B, and an Nth partition unit 2120N has a corresponding Nth memory unit 2124N. In other examples, the number of partition units 2120A-2120N may not be equal to the number of memory devices.

The memory units 2124A-2124N can include various types of memory devices, including dynamic random-access memory (DRAM) or graphics random access memory, such as synchronous graphics random access memory (SGRAM), including graphics double data rate (GDDR) memory. Optionally, the memory units 2124A-2124N may also include 3D stacked memory, including but not limited to high bandwidth memory (HBM). Persons skilled in the art will appreciate that the specific implementation of the memory units 2124A-2124N can vary and can be selected from one of various conventional designs. Render targets, such as frame buffers or texture maps may be stored across the memory units 2124A-2124N, allowing partition units 2120A-2120N to write portions of each render target in parallel to efficiently use the available bandwidth of parallel processor memory 2122. In some examples, a local instance of the parallel processor memory 2122 may be excluded in favor of a unified memory design that utilizes system memory in conjunction with local cache memory.

Optionally, anyone of the clusters 2114A-2114N of the processing cluster array 2112 has the ability to process data that will be written to any of the memory units 2124A-2124N within parallel processor memory 2122. The memory crossbar 2116 can be configured to transfer the output of each cluster 2114A-2114N to any partition unit 2120A-2120N or to another cluster 2114A-2114N, which can perform additional processing operations on the output. Each cluster 2114A-2114N can communicate with the memory interface 2118 through the memory crossbar 2116 to read from or write to various external memory devices. In one of the examples with the memory crossbar 2116 the memory crossbar 2116 has a connection to the memory interface 2118 to communicate with the I/O unit 2104, as well as a connection to a local instance of the parallel processor memory 2122, enabling the processing units within the different processing clusters 2114A-2114N to communicate with system memory or other memory that is not local to the parallel processing unit 2102. Generally, the memory crossbar 2116 may, for example, be able to use virtual channels to separate traffic streams between the clusters 2114A-2114N and the partition units 2120A-2120N.

While a single instance of the parallel processing unit 2102 is illustrated within the parallel processor 2100, any number of instances of the parallel processing unit 2102 can be included. For example, multiple instances of the parallel processing unit 2102 can be provided on a single add-in card, or multiple add-in cards can be interconnected. For example, the parallel processor 2100 can be an add-in device, such as add-in device 2020 of FIG. 20, which may be a graphics card such as a discrete graphics card that includes one or more GPUs, one or more memory devices, and device-to-device or network or fabric interfaces. The different instances of the parallel processing unit 2102 can be configured to inter-operate even if the different instances have different numbers of processing cores, different amounts of local parallel processor memory, and/or other configuration differences. Optionally, some instances of the parallel processing unit 2102 can include higher precision floating point units relative to other instances. Systems incorporating one or more instances of the parallel processing unit 2102 or the parallel processor 2100 can be implemented in a variety of configurations and form factors, including but not limited to desktop, laptop, or handheld personal computers, servers, workstations, game consoles, and/or embedded systems. An orchestrator can form composite nodes for workload performance using one or more of: disaggregated processor resources, cache resources, memory resources, storage resources, and networking resources.

In some examples, the parallel processing unit 2102 can be partitioned into multiple instances. Those multiple instances can be configured to execute workloads associated with different clients in an isolated manner, enabling a pre-determined quality of service to be provided for each client. For example, each cluster 2114A-2114N can be compartmentalized and isolated from other clusters, allowing the processing cluster array 2112 to be divided into multiple compute partitions or instances. In such configuration, workloads that execute on an isolated partition are protected from faults or errors associated with a different workload that executes on a different partition. The partition units 2120A-2120N can be configured to enable a dedicated and/or isolated path to memory for the clusters 2114A-2114N associated with the respective compute partitions. This datapath isolation enables the compute resources within a partition can communicate with one or more assigned memory units 2124A-2124N without being subjected to inference by the activities of other partitions.

FIG. 21B is a block diagram of a partition unit 2120. The partition unit 2120 may be an instance of one of the partition units 2120A-2120N of FIG. 21A. As illustrated, the partition unit 2120 includes an L2 cache 2121, a frame buffer interface 2125, and a ROP 2126 (raster operations unit). The L2 cache 2121 is a read/write cache that is configured to perform load and store operations received from the memory crossbar 2116 and ROP 2126. Read misses and urgent write-back requests are output by L2 cache 2121 to frame buffer interface 2125 for processing. Updates can also be sent to the frame buffer via the frame buffer interface 2125 for processing. In some examples the frame buffer interface 2125 interfaces with one of the memory units in parallel processor memory, such as the memory units 2124A-2124N of FIG. 21A (e.g., within parallel processor memory 2122). The partition unit 2120 may additionally or alternatively also interface with one of the memory units in parallel processor memory via a memory controller (not shown).

In graphics applications, the ROP 2126 is a processing unit that performs raster operations such as stencil, z test, blending, and the like. The ROP 2126 then outputs processed graphics data that is stored in graphics memory. In some examples the ROP 2126 includes or couples with a CODEC 2127 that includes compression logic to compress depth or color data that is written to memory or the L2 cache 2121 and decompress depth or color data that is read from memory or the L2 cache 2121. The compression logic can be lossless compression logic that makes use of one or more of multiple compression algorithms. The type of compression that is performed by the CODEC 2127 can vary based on the statistical characteristics of the data to be compressed. For example, in some examples, delta color compression is performed on depth and color data on a per-tile basis. In some examples the CODEC 2127 includes compression and decompression logic that can compress and decompress compute data associated with machine learning operations. The CODEC 2127 can, for example, compress sparse matrix data for sparse machine learning operations. The CODEC 2127 can also compress sparse matrix data that is encoded in a sparse matrix format (e.g., coordinate list encoding (COO), compressed sparse row (CSR), compress sparse column (CSC), etc.) to generate compressed and encoded sparse matrix data. The compressed and encoded sparse matrix data can be decompressed and/or decoded before being processed by processing elements or the processing elements can be configured to consume compressed, encoded, or compressed and encoded data for processing.

The ROP 2126 may be included within each processing cluster (e.g., cluster 2114A-2114N of FIG. 21A) instead of within the partition unit 2120. In such example, read and write requests for pixel data are transmitted over the memory crossbar 2116 instead of pixel fragment data. The processed graphics data may be displayed on a display device, such as one of the one or more display device(s) 2010A-2010B of FIG. 20, routed for further processing by the processor(s) 2002, or routed for further processing by one of the processing entities within the parallel processor 2100 of FIG. 21A.

FIG. 21C is a block diagram of a processing cluster 2114 within a parallel processing unit. For example, the processing cluster is an instance of one of the processing clusters 2114A-2114N of FIG. 21A. The processing cluster 2114 can be configured to execute many threads in parallel, where the term “thread” refers to an instance of a particular program executing on a particular set of input data. Optionally, single-instruction, multiple-data (SIMD) instruction issue techniques may be used to support parallel execution of a large number of threads without providing multiple independent instruction units. Alternatively, single-instruction, multiple-thread (SIMT) techniques may be used to support parallel execution of a large number of generally synchronized threads, using a common instruction unit configured to issue instructions to a set of processing engines within each one of the processing clusters. Unlike a SIMD execution regime, where all processing engines typically execute identical instructions, SIMT execution allows different threads to more readily follow divergent execution paths through a given thread program. Persons skilled in the art will understand that a SIMD processing regime represents a functional subset of a SIMT processing regime.

Operation of the processing cluster 2114 can be controlled via a pipeline manager 2132 that distributes processing tasks to SIMT parallel processors. The pipeline manager 2132 receives instructions from the scheduler 2110 of FIG. 21A and manages execution of those instructions via a graphics multiprocessor 2134 and/or a texture unit 2136. The illustrated graphics multiprocessor 2134 is an exemplary instance of a SIMT parallel processor. However, various types of SIMT parallel processors of differing architectures may be included within the processing cluster 2114. One or more instances of the graphics multiprocessor 2134 can be included within a processing cluster 2114. The graphics multiprocessor 2134 can process data and a data crossbar 2140 can be used to distribute the processed data to one of multiple possible destinations, including other shader units. The pipeline manager 2132 can facilitate the distribution of processed data by specifying destinations for processed data to be distributed via the data crossbar 2140.

Each graphics multiprocessor 2134 within the processing cluster 2114 can include an identical set of functional execution logic (e.g., arithmetic logic units, load-store units, etc.). The functional execution logic can be configured in a pipelined manner in which new instructions can be issued before previous instructions are complete. The functional execution logic supports a variety of operations including integer and floating-point arithmetic, comparison operations, Boolean operations, bit-shifting, and computation of various algebraic functions. The same functional-unit hardware could be leveraged to perform different operations and any combination of functional units may be present.

The instructions transmitted to the processing cluster 2114 constitute a thread. A set of threads executing across the set of parallel processing engines is a thread group. A thread group executes the same program on different input data. Each thread within a thread group can be assigned to a different processing engine within a graphics multiprocessor 2134. A thread group may include fewer threads than the number of processing engines within the graphics multiprocessor 2134. When a thread group includes fewer threads than the number of processing engines, one or more of the processing engines may be idle during cycles in which that thread group is being processed. A thread group may also include more threads than the number of processing engines within the graphics multiprocessor 2134. When the thread group includes more threads than the number of processing engines within the graphics multiprocessor 2134, processing can be performed over consecutive clock cycles. Optionally, multiple thread groups can be executed concurrently on the graphics multiprocessor 2134.

The graphics multiprocessor 2134 may include an internal cache memory to perform load and store operations. Optionally, the graphics multiprocessor 2134 can forego an internal cache and use a cache memory (e.g., level 1 (L1) cache 2148) within the processing cluster 2114. Each graphics multiprocessor 2134 also has access to level 2 (L2) caches within the partition units (e.g., partition units 2120A-2120N of FIG. 21A) that are shared among all processing clusters 2114 and may be used to transfer data between threads. The graphics multiprocessor 2134 may also access off-chip global memory, which can include one or more of local parallel processor memory and/or system memory. Any memory external to the parallel processing unit 2102 may be used as global memory. Embodiments in which the processing cluster 2114 includes multiple instances of the graphics multiprocessor 2134 can share common instructions and data, which may be stored in the L1 cache 2148.

Each processing cluster 2114 may include an MMU 2145 (memory management unit) that is configured to map virtual addresses into physical addresses. In other examples, one or more instances of the MMU 2145 may reside within the memory interface 2118 of FIG. 21A. The MMU 2145 includes a set of page table entries (PTEs) used to map a virtual address to a physical address of a tile and optionally a cache line index. The MMU 2145 may include address translation lookaside buffers (TLB) or caches that may reside within the graphics multiprocessor 2134 or the L1 cache 2148 of processing cluster 2114. The physical address is processed to distribute surface data access locality to allow efficient request interleaving among partition units. The cache line index may be used to determine whether a request for a cache line is a hit or miss.

In graphics and computing applications, a processing cluster 2114 may be configured such that each graphics multiprocessor 2134 is coupled to a texture unit 2136 for performing texture mapping operations, e.g., determining texture sample positions, reading texture data, and filtering the texture data. Texture data is read from an internal texture L1 cache (not shown) or in some examples from the L1 cache within graphics multiprocessor 2134 and is fetched from an L2 cache, local parallel processor memory, or system memory, as needed. Each graphics multiprocessor 2134 outputs processed tasks to the data crossbar 2140 to provide the processed task to another processing cluster 2114 for further processing or to store the processed task in an L2 cache, local parallel processor memory, or system memory via the memory crossbar 2116. A preROP 2142 (pre-raster operations unit) is configured to receive data from graphics multiprocessor 2134, direct data to ROP units, which may be located with partition units as described herein (e.g., partition units 2120A-2120N of FIG. 21A). The preROP 2142 unit can perform optimizations for color blending, organize pixel color data, and perform address translations.

It will be appreciated that the core architecture described herein is illustrative and that variations and modifications are possible. Any number of processing units, e.g., graphics multiprocessor 2134, texture units 2136, preROPs 2142, etc., may be included within a processing cluster 2114. Further, while only one processing cluster 2114 is shown, a parallel processing unit as described herein may include any number of instances of the processing cluster 2114. Optionally, each processing cluster 2114 can be configured to operate independently of other processing clusters 2114 using separate and distinct processing units, L1 caches, L2 caches, etc.

FIG. 21D shows an example of the graphics multiprocessor 2134 in which the graphics multiprocessor 2134 couples with the pipeline manager 2132 of the processing cluster 2114. The graphics multiprocessor 2134 has an execution pipeline including but not limited to an instruction cache 2152, an instruction unit 2154, an address mapping unit 2156, a register file 2158, one or more general purpose graphics processing unit (GPGPU) cores 2162, and one or more load/store units 2166. The GPGPU cores 2162 and load/store units 2166 are coupled with cache memory 2172 and shared memory 2170 via a memory and cache interconnect 2168. The graphics multiprocessor 2134 may additionally include tensor and/or ray-tracing cores 2163 that include hardware logic to accelerate matrix and/or ray-tracing operations.

The instruction cache 2152 may receive a stream of instructions to execute from the pipeline manager 2132. The instructions are cached in the instruction cache 2152 and dispatched for execution by the instruction unit 2154. The instruction unit 2154 can dispatch instructions as thread groups (e.g., warps), with each thread of the thread group assigned to a different execution unit within GPGPU core 2162. An instruction can access any of a local, shared, or global address space by specifying an address within a unified address space. The address mapping unit 2156 can be used to translate addresses in the unified address space into a distinct memory address that can be accessed by the load/store units 2166.

The register file 2158 provides a set of registers for the functional units of the graphics multiprocessor 2134. The register file 2158 provides temporary storage for operands connected to the data paths of the functional units (e.g., GPGPU cores 2162, load/store units 2166) of the graphics multiprocessor 2134. The register file 2158 may be divided between each of the functional units such that each functional unit is allocated a dedicated portion of the register file 2158. For example, the register file 2158 may be divided between the different warps being executed by the graphics multiprocessor 2134.

The GPGPU cores 2162 can each include floating point units (FPUs) and/or integer arithmetic logic units (ALUs) that are used to execute instructions of the graphics multiprocessor 2134. In some implementations, the GPGPU cores 2162 can include hardware logic that may otherwise reside within the tensor and/or ray-tracing cores 2163. The GPGPU cores 2162 can be similar in architecture or can differ in architecture. For example and in some examples, a first portion of the GPGPU cores 2162 include a single precision FPU and an integer ALU while a second portion of the GPGPU cores include a double precision FPU. Optionally, the FPUs can implement the IEEE 754-2008 standard for floating point arithmetic or enable variable precision floating point arithmetic. The graphics multiprocessor 2134 can additionally include one or more fixed function or special function units to perform specific functions such as copy rectangle or pixel blending operations. One or more of the GPGPU cores can also include fixed or special function logic.

The GPGPU cores 2162 may include SIMD logic capable of performing a single instruction on multiple sets of data. Optionally, GPGPU cores 2162 can physically execute SIMD4, SIMD8, and SIMD16 instructions and logically execute SIMD1, SIMD2, and SIMD32 instructions. The SIMD instructions for the GPGPU cores can be generated at compile time by a shader compiler or automatically generated when executing programs written and compiled for single program multiple data (SPMD) or SIMT architectures. Multiple threads of a program configured for the SIMT execution model can be executed via a single SIMD instruction. For example and in some examples, eight SIMT threads that perform the same or similar operations can be executed in parallel via a single SIMD8 logic unit.

The memory and cache interconnect 2168 is an interconnect network that connects each of the functional units of the graphics multiprocessor 2134 to the register file 2158 and to the shared memory 2170. For example, the memory and cache interconnect 2168 is a crossbar interconnect that allows the load/store unit 2166 to implement load and store operations between the shared memory 2170 and the register file 2158. The register file 2158 can operate at the same frequency as the GPGPU cores 2162, thus data transfer between the GPGPU cores 2162 and the register file 2158 is very low latency. The shared memory 2170 can be used to enable communication between threads that execute on the functional units within the graphics multiprocessor 2134. The cache memory 2172 can be used as a data cache for example, to cache texture data communicated between the functional units and the texture unit 2136. The shared memory 2170 can also be used as a program managed cached. The shared memory 2170 and the cache memory 2172 can couple with the data crossbar 2140 to enable communication with other components of the processing cluster. Threads executing on the GPGPU cores 2162 can programmatically store data within the shared memory in addition to the automatically cached data that is stored within the cache memory 2172.

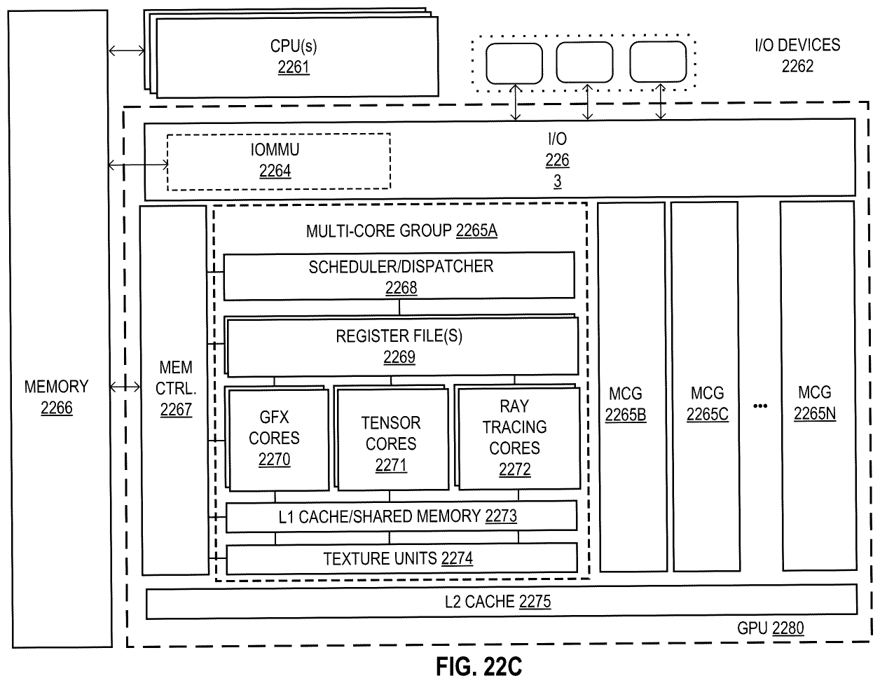

FIGS. 22A-22C illustrate additional graphics multiprocessors, according to examples. FIG. 22A-22B illustrate graphics multiprocessors 2225, 2250, which are related to the graphics multiprocessor 2134 of FIG. 21C and may be used in place of one of those. Therefore, the disclosure of any features in combination with the graphics multiprocessor 2134 herein also discloses a corresponding combination with the graphics multiprocessor(s) 2225, 2250, but is not limited to such. FIG. 22C illustrates a graphics processing unit (GPU) 2280 which includes dedicated sets of graphics processing resources arranged into multi-core groups 2265A-2265N, which correspond to the graphics multiprocessors 2225, 2250. The illustrated graphics multiprocessors 2225, 2250 and the multi-core groups 2265A-2265N can be streaming multiprocessors (SM) capable of simultaneous execution of a large number of execution threads.

The graphics multiprocessor 2225 of FIG. 22A includes multiple additional instances of execution resource units relative to the graphics multiprocessor 2134 of FIG. 21D. For example, the graphics multiprocessor 2225 can include multiple instances of the instruction unit 2232A-2232B, register file 2234A-2234B, and texture unit(s) 2244A-2244B. The graphics multiprocessor 2225 also includes multiple sets of graphics or compute execution units (e.g., GPGPU core 2236A-2236B, tensor core 2237A-2237B, ray-tracing core 2238A-2238B) and multiple sets of load/store units 2240A-2240B. The execution resource units have a common instruction cache 2230, texture and/or data cache memory 2242, and shared memory 2246.

The various components can communicate via an interconnect fabric 2227. The interconnect fabric 2227 may include one or more crossbar switches to enable communication between the various components of the graphics multiprocessor 2225. The interconnect fabric 2227 may be a separate, high-speed network fabric layer upon which each component of the graphics multiprocessor 2225 is stacked. The components of the graphics multiprocessor 2225 communicate with remote components via the interconnect fabric 2227. For example, the cores 2236A-2236B, 2237A-2237B, and 2238A-2238B can each communicate with shared memory 2246 via the interconnect fabric 2227. The interconnect fabric 2227 can arbitrate communication within the graphics multiprocessor 2225 to ensure a fair bandwidth allocation between components.

The graphics multiprocessor 2250 of FIG. 22B includes multiple sets of execution resources 2256A-2256D, where each set of execution resource includes multiple instruction units, register files, GPGPU cores, and load store units, as illustrated in FIG. 21D and FIG. 22A. The execution resources 2256A-2256D can work in concert with texture unit(s) 2260A-2260D for texture operations, while sharing an instruction cache 2254, and shared memory 2253. For example, the execution resources 2256A-2256D can share an instruction cache 2254 and shared memory 2253, as well as multiple instances of a texture and/or data cache memory 2258A-2258B. The various components can communicate via an interconnect fabric 2252 similar to the interconnect fabric 2227 of FIG. 22A.

Persons skilled in the art will understand that the architecture described in FIG. 1, 21A-21D, and 22A-22B are descriptive and not limiting as to the scope of the present examples. Thus, the techniques described herein may be implemented on any properly configured processing unit, including, without limitation, one or more mobile application processors, one or more desktop or server central processing units (CPUs) including multi-core CPUs, one or more parallel processing units, such as the parallel processing unit 2102 of FIG. 21A, as well as one or more graphics processors or special purpose processing units, without departure from the scope of the examples described herein.

The parallel processor or GPGPU as described herein may be communicatively coupled to host/processor cores to accelerate graphics operations, machine-learning operations, pattern analysis operations, and various general-purpose GPU (GPGPU) functions. The GPU may be communicatively coupled to the host processor/cores over a bus or other interconnect (e.g., a high-speed interconnect such as PCIe, NVLink, or other known protocols, standardized protocols, or proprietary protocols). In other examples, the GPU may be integrated on the same package or chip as the cores and communicatively coupled to the cores over an internal processor bus/interconnect (i.e., internal to the package or chip). Regardless of the manner in which the GPU is connected, the processor cores may allocate work to the GPU in the form of sequences of commands/instructions contained in a work descriptor. The GPU then uses dedicated circuitry/logic for efficiently processing these commands/instructions.

FIG. 22C illustrates a graphics processing unit (GPU) 2280 which includes dedicated sets of graphics processing resources arranged into multi-core groups 2265A-2265N. While the details of only a single multi-core group 2265A are provided, it will be appreciated that the other multi-core groups 2265B-2265N may be equipped with the same or similar sets of graphics processing resources. Details described with respect to the multi-core groups 2265A-2265N may also apply to any graphics multiprocessor 2134, 2225, 2250 described herein.

As illustrated, a multi-core group 2265A may include a set of graphics cores 2270, a set of tensor cores 2271, and a set of ray tracing cores 2272. A scheduler/dispatcher 2268 schedules and dispatches the graphics threads for execution on the various cores 2270, 2271, 2272. A set of register files 2269 store operand values used by the cores 2270, 2271, 2272 when executing the graphics threads. These may include, for example, integer registers for storing integer values, floating point registers for storing floating point values, vector registers for storing packed data elements (integer and/or floating-point data elements) and tile registers for storing tensor/matrix values. The tile registers may be implemented as combined sets of vector registers.

One or more combined level 1 (L1) caches and shared memory units 2273 store graphics data such as texture data, vertex data, pixel data, ray data, bounding volume data, etc., locally within each multi-core group 2265A. One or more texture units 2274 can also be used to perform texturing operations, such as texture mapping and sampling. A Level 2 (L2) cache 2275 shared by all or a subset of the multi-core groups 2265A-2265N stores graphics data and/or instructions for multiple concurrent graphics threads. As illustrated, the L2 cache 2275 may be shared across a plurality of multi-core groups 2265A-2265N. One or more memory controllers 2267 couple the GPU 2280 to a memory 2266 which may be a system memory (e.g., DRAM) and/or a dedicated graphics memory (e.g., GDDR6 memory).

Input/output (I/O) circuitry 2263 couples the GPU 2280 to one or more I/O devices 2262 such as digital signal processors (DSPs), network controllers, or user input devices. An on-chip interconnect may be used to couple the I/O devices 2262 to the GPU 2280 and memory 2266. One or more I/O memory management units (IOMMUs) 2264 of the I/O circuitry 2263 couple the I/O devices 2262 directly to the system memory 2266. Optionally, the IOMMU 2264 manages multiple sets of page tables to map virtual addresses to physical addresses in system memory 2266. The I/O devices 2262, CPU(s) 2261, and GPU(s) 2280 may then share the same virtual address space.

In one implementation of the IOMMU 2264, the IOMMU 2264 supports virtualization. In this case, it may manage a first set of page tables to map guest/graphics virtual addresses to guest/graphics physical addresses and a second set of page tables to map the guest/graphics physical addresses to system/host physical addresses (e.g., within system memory 2266). The base addresses of each of the first and second sets of page tables may be stored in control registers and swapped out on a context switch (e.g., so that the new context is provided with access to the relevant set of page tables). While not illustrated in FIG. 22C, each of the cores 2270, 2271, 2272 and/or multi-core groups 2265A-2265N may include translation lookaside buffers (TLBs) to cache guest virtual to guest physical translations, guest physical to host physical translations, and guest virtual to host physical translations.

The CPU(s) 2261, GPUs 2280, and I/O devices 2262 may be integrated on a single semiconductor chip and/or chip package. The illustrated memory 2266 may be integrated on the same chip or may be coupled to the memory controllers 2267 via an off-chip interface. In one implementation, the memory 2266 comprises GDDR6 memory which shares the same virtual address space as other physical system-level memories, although the underlying principles described herein are not limited to this specific implementation.

The tensor cores 2271 may include a plurality of execution units specifically designed to perform matrix operations, which are the fundamental compute operation used to perform deep learning operations. For example, simultaneous matrix multiplication operations may be used for neural network training and inferencing. The tensor cores 2271 may perform matrix processing using a variety of operand precisions including single precision floating-point (e.g., 32 bits), half-precision floating point (e.g., 16 bits), integer words (16 bits), bytes (8 bits), and half-bytes (4 bits). For example, a neural network implementation extracts features of each rendered scene, potentially combining details from multiple frames, to construct a high-quality final image.

In deep learning implementations, parallel matrix multiplication work may be scheduled for execution on the tensor cores 2271. The training of neural networks, in particular, requires a significant number of matrix dot product operations. In order to process an inner-product formulation of an N×N×N matrix multiply, the tensor cores 2271 may include at least N dot-product processing elements. Before the matrix multiply begins, one entire matrix is loaded into tile registers and at least one column of a second matrix is loaded each cycle for N cycles. Each cycle, there are N dot products that are processed.

Matrix elements may be stored at different precisions depending on the particular implementation, including 16-bit words, 8-bit bytes (e.g., INT8) and 4-bit half-bytes (e.g., INT4). Different precision modes may be specified for the tensor cores 2271 to ensure that the most efficient precision is used for different workloads (e.g., such as inferencing workloads which can tolerate quantization to bytes and half-bytes). Supported formats additionally include 64-bit floating point (FP64) and non-IEEE floating point formats such as the bfloat16 format (e.g., Brain floating point), a 16-bit floating point format with one sign bit, eight exponent bits, and eight significand bits, of which seven are explicitly stored. One example includes support for a reduced precision tensor-float (TF32) mode, which performs computations using the range of FP32 (8-bits) and the precision of FP16 (10-bits). Reduced precision TF32 operations can be performed on FP32 inputs and produce FP32 outputs at higher performance relative to FP32 and increased precision relative to FP16. In some examples, one or more 8-bit floating point formats (FP8) are supported.

In some examples the tensor cores 2271 support a sparse mode of operation for matrices in which the vast majority of values are zero. The tensor cores 2271 include support for sparse input matrices that are encoded in a sparse matrix representation (e.g., coordinate list encoding (COO), compressed sparse row (CSR), compress sparse column (CSC), etc.). The tensor cores 2271 also include support for compressed sparse matrix representations in the event that the sparse matrix representation may be further compressed. Compressed, encoded, and/or compressed and encoded matrix data, along with associated compression and/or encoding metadata, can be read by the tensor cores 2271 and the non-zero values can be extracted. For example, for a given input matrix A, a non-zero value can be loaded from the compressed and/or encoded representation of at least a portion of matrix A. Based on the location in matrix A for the non-zero value, which may be determined from index or coordinate metadata associated with the non-zero value, a corresponding value in input matrix B may be loaded. Depending on the operation to be performed (e.g., multiply), the load of the value from input matrix B may be bypassed if the corresponding value is a zero value. In some examples, the pairings of values for certain operations, such as multiply operations, may be pre-scanned by scheduler logic and only operations between non-zero inputs are scheduled. Depending on the dimensions of matrix A and matrix B and the operation to be performed, output matrix C may be dense or sparse. Where output matrix C is sparse and depending on the configuration of the tensor cores 2271, output matrix C may be output in a compressed format, a sparse encoding, or a compressed sparse encoding.

The ray tracing cores 2272 may accelerate ray tracing operations for both real-time ray tracing and non-real-time ray tracing implementations. In particular, the ray tracing cores 2272 may include ray traversal/intersection circuitry for performing ray traversal using bounding volume hierarchies (BVHs) and identifying intersections between rays and primitives enclosed within the BVH volumes. The ray tracing cores 2272 may also include circuitry for performing depth testing and culling (e.g., using a Z buffer or similar arrangement). In one implementation, the ray tracing cores 2272 perform traversal and intersection operations in concert with the image denoising techniques described herein, at least a portion of which may be executed on the tensor cores 2271. For example, the tensor cores 2271 may implement a deep learning neural network to perform denoising of frames generated by the ray tracing cores 2272. However, the CPU(s) 2261, graphics cores 2270, and/or ray tracing cores 2272 may also implement all or a portion of the denoising and/or deep learning algorithms.

In addition, as described above, a distributed approach to denoising may be employed in which the GPU 2280 is in a computing device coupled to other computing devices over a network or high-speed interconnect. In this distributed approach, the interconnected computing devices may share neural network learning/training data to improve the speed with which the overall system learns to perform denoising for different types of image frames and/or different graphics applications.

The ray tracing cores 2272 may process all BVH traversal and/or ray-primitive intersections, saving the graphics cores 2270 from being overloaded with thousands of instructions per ray. For example, each ray tracing core 2272 includes a first set of specialized circuitry for performing bounding box tests (e.g., for traversal operations) and/or a second set of specialized circuitry for performing the ray-triangle intersection tests (e.g., intersecting rays which have been traversed). Thus, for example, the multi-core group 2265A can simply launch a ray probe, and the ray tracing cores 2272 independently perform ray traversal and intersection and return hit data (e.g., a hit, no hit, multiple hits, etc.) to the thread context. The other cores 2270, 2271 are freed to perform other graphics or compute work while the ray tracing cores 2272 perform the traversal and intersection operations.

Optionally, each ray tracing core 2272 may include a traversal unit to perform BVH testing operations and/or an intersection unit which performs ray-primitive intersection tests. The intersection unit generates a “hit”, “no hit”, or “multiple hit” response, which it provides to the appropriate thread. During the traversal and intersection operations, the execution resources of the other cores (e.g., graphics cores 2270 and tensor cores 2271) are freed to perform other forms of graphics work.

In some examples described below, a hybrid rasterization/ray tracing approach is used in which work is distributed between the graphics cores 2270 and ray tracing cores 2272.

The ray tracing cores 2272 (and/or other cores 2270, 2271) may include hardware support for a ray tracing instruction set such as Microsoft's DirectX Ray Tracing (DXR) which includes a DispatchRays command, as well as ray-generation, closest-hit, any-hit, and miss shaders, which enable the assignment of unique sets of shaders and textures for each object. Another ray tracing platform which may be supported by the ray tracing cores 2272, graphics cores 2270 and tensor cores 2271 is Vulkan API (e.g., Vulkan version 1.1.85 and later). Note, however, that the underlying principles described herein are not limited to any particular ray tracing ISA.

In general, the various cores 2272, 2271, 2270 may support a ray tracing instruction set that includes instructions/functions for one or more of ray generation, closest hit, any hit, ray-primitive intersection, per-primitive and hierarchical bounding box construction, miss, visit, and exceptions. More specifically, some examples includes ray tracing instructions to perform one or more of the following functions:
Ray Generation—Ray generation instructions may be executed for each pixel, sample, or other user-defined work assignment.
Closest Hit—A closest hit instruction may be executed to locate the closest intersection point of a ray with primitives within a scene.
Any Hit—An any hit instruction identifies multiple intersections between a ray and primitives within a scene, potentially to identify a new closest intersection point.
Intersection—An intersection instruction performs a ray-primitive intersection test and outputs a result.
Per-primitive Bounding box Construction—This instruction builds a bounding box around a given primitive or group of primitives (e.g., when building a new BVH or other acceleration data structure).
Miss—Indicates that a ray misses all geometry within a scene, or specified region of a scene.
Visit—Indicates the child volumes a ray will traverse.
Exceptions—Includes various types of exception handlers (e.g., invoked for various error conditions).

In some examples the ray tracing cores 2272 may be adapted to accelerate general-purpose compute operations that can be accelerated using computational techniques that are analogous to ray intersection tests. A compute framework can be provided that enables shader programs to be compiled into low level instructions and/or primitives that perform general-purpose compute operations via the ray tracing cores. Exemplary computational problems that can benefit from compute operations performed on the ray tracing cores 2272 include computations involving beam, wave, ray, or particle propagation within a coordinate space. Interactions associated with that propagation can be computed relative to a geometry or mesh within the coordinate space. For example, computations associated with electromagnetic signal propagation through an environment can be accelerated via the use of instructions or primitives that are executed via the ray tracing cores. Diffraction and reflection of the signals by objects in the environment can be computed as direct ray-tracing analogies.

Ray tracing cores 2272 can also be used to perform computations that are not directly analogous to ray tracing. For example, mesh projection, mesh refinement, and volume sampling computations can be accelerated using the ray tracing cores 2272. Generic coordinate space calculations, such as nearest neighbor calculations can also be performed. For example, the set of points near a given point can be discovered by defining a bounding box in the coordinate space around the point. BVH and ray probe logic within the ray tracing cores 2272 can then be used to determine the set of point intersections within the bounding box. The intersections constitute the origin point and the nearest neighbors to that origin point. Computations that are performed using the ray tracing cores 2272 can be performed in parallel with computations performed on the graphics cores 2272 and tensor cores 2271. A shader compiler can be configured to compile a compute shader or other general-purpose graphics processing program into low level primitives that can be parallelized across the graphics cores 2270, tensor cores 2271, and ray tracing cores 2272.

Building larger and larger silicon dies is challenging for a variety of reasons. As silicon dies become larger, manufacturing yields become smaller and process technology requirements for different components may diverge. On the other hand, in order to have a high-performance system, key components should be interconnected by high speed, high bandwidth, low latency interfaces. These contradicting needs pose a challenge to high performance chip development.

Embodiments described herein provide techniques to disaggregate an architecture of a system on a chip integrated circuit into multiple distinct chiplets that can be packaged onto a common chassis. In some examples, a graphics processing unit or parallel processor is composed from diverse silicon chiplets that are separately manufactured. A chiplet is an at least partially packaged integrated circuit that includes distinct units of logic that can be assembled with other chiplets into a larger package. A diverse set of chiplets with different IP core logic can be assembled into a single device. Additionally the chiplets can be integrated into a base die or base chiplet using active interposer technology. The concepts described herein enable the interconnection and communication between the different forms of IP within the GPU. The development of IPs on different process may be mixed. This avoids the complexity of converging multiple IPs, especially on a large SoCwith several flavors IPs, to the same process.

Enabling the use of multiple process technologies improves the time to market and provides a cost-effective way to create multiple product SKUs. For customers, this means getting products that are more tailored to their requirements in a cost effective and timely manner. Additionally, the disaggregated IPs are more amenable to being power gated independently, components that are not in use on a given workload can be powered off, reducing overall power consumption.

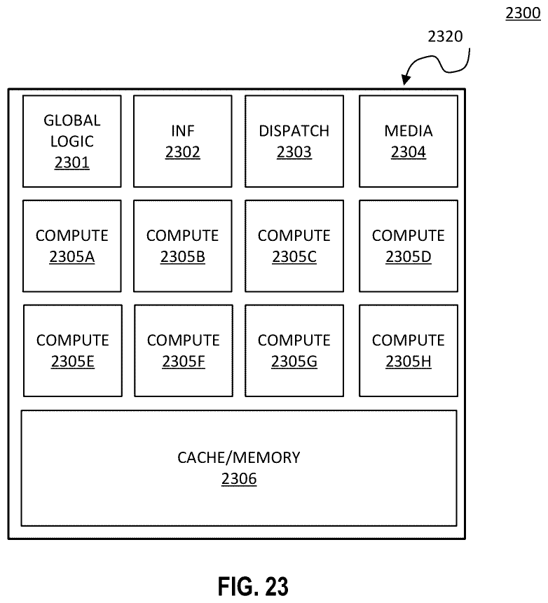

FIG. 23 shows a parallel compute system 2300, according to some examples. In some examples the parallel compute system 2300 includes a parallel processor 2320, which can be a graphics processor or compute accelerator as described herein. The parallel processor 2320 includes a global logic unit 2301, an interface 2302, a thread dispatcher 2303, a media unit 2304, a set of compute units 2305A-2305H, and a cache/memory units 2306.

The global logic unit 2301, in some examples, includes global functionality for the parallel processor 2320, including device configuration registers, global schedulers, power management logic, and the like. The interface 2302 can include a front-end interface for the parallel processor 2320. The thread dispatcher 2303 can receive workloads from the interface 2302 and dispatch threads for the workload to the compute units 2305A-2305H. If the workload includes any media operations, at least a portion of those operations can be performed by the media unit 2304. The media unit can also offload some operations to the compute units 2305A-2305H. The cache/memory units 2306 can include cache memory (e.g., L3 cache) and local memory (e.g., HBM, GDDR) for the parallel processor 2320.

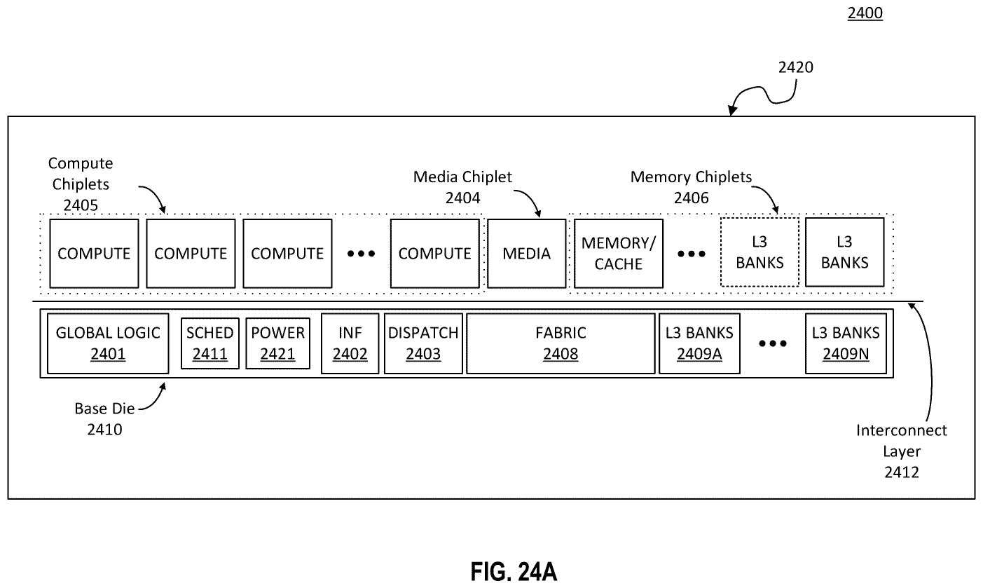

FIGS. 24A-24B illustrate a hybrid logical/physical view of a disaggregated parallel processor, according to examples described herein. FIG. 24A illustrates a disaggregated parallel compute system 2400. FIG. 24B illustrates a chiplet 2430 of the disaggregated parallel compute system 2400.

As shown in FIG. 24A, a disaggregated compute system 2400 can include a parallel processor 2420 in which the various components of the parallel processor SOC are distributed across multiple chiplets. Each chiplet can be a distinct IP core that is independently designed and configured to communicate with other chiplets via one or more common interfaces. The chiplets include but are not limited to compute chiplets 2405, a media chiplet 2404, and memory chiplets 2406. Each chiplet can be separately manufactured using different process technologies. For example, compute chiplets 2405 may be manufactured using the smallest or most advanced process technology available at the time of fabrication, while memory chiplets 2406 or otherchiplets (e.g., 1/O, networking, etc.) may be manufactured using a larger or less advanced process technologies.

The various chiplets can be bonded to a base die 2410 and configured to communicate with each other and logic within the base die 2410 via an interconnect layer 2412. In some examples, the base die 2410 can include global logic 2401, which can include scheduler 2411 and power management 2421 logic units, an interface 2402, a dispatch unit 2403, and an interconnect fabric module 2408 coupled with or integrated with one or more L3 cache banks 2409A-2409N. The interconnect fabric 2408 can be an inter-chiplet fabric that is integrated into the base die 2410. Logic chiplets can use the fabric 2408 to relay messages between the various chiplets. Additionally, L3 cache banks 2409A-2409N in the base die and/or L3 cache banks within the memory chiplets 2406 can cache data read from and transmitted to DRAM chiplets within the memory chiplets 2406 and to system memory of a host.

In some examples the global logic 2401 is a microcontroller that can execute firmware to perform scheduler 2411 and power management 2421 functionality for the parallel processor 2420. The microcontroller that executes the global logic can be tailored for the target use case of the parallel processor 2420. The scheduler 2411 can perform global scheduling operations for the parallel processor 2420. The power management 2421 functionality can be used to enable or disable individual chiplets within the parallel processor when those chiplets are not in use.

The various chiplets of the parallel processor 2420 can be designed to perform specific functionality that, in existing designs, would be integrated into a single die. A set of compute chiplets 2405 can include clusters of compute units (e.g., execution units, streaming multiprocessors, etc.) that include programmable logic to execute compute or graphics shader instructions. A media chiplet 2404 can include hardware logic to accelerate media encode and decode operations. Memory chiplets 2406 can include volatile memory (e.g., DRAM) and one or more SRAM cache memory banks (e.g., L3 banks).

As shown in FIG. 24B, each chiplet 2430 can include common components and application specific components. Chiplet logic 2436 within the chiplet 2430 can include the specific components of the chiplet, such as an array of streaming multiprocessors, compute units, or execution units described herein. The chiplet logic 2436 can couple with an optional cache or shared local memory 2438 or can include a cache or shared local memory within the chiplet logic 2436. The chiplet 2430 can include a fabric interconnect node 2442 that receives commands via the inter-chiplet fabric. Commands and data received via the fabric interconnect node 2442 can be stored temporarily within an interconnect buffer 2439. Data transmitted to and received from the fabric interconnect node 2442 can be stored in an interconnect cache 2440. Power control 2432 and clock control 2434 logic can also be included within the chiplet. The power control 2432 and clock control 2434 logic can receive configuration commands via the fabric can configure dynamic voltage and frequency scaling for the chiplet 2430. In some examples, each chiplet can have an independent clock domain and power domain and can be clock gated and power gated independently of other chiplets.

At least a portion of the components within the illustrated chiplet 2430 can also be included within logic embedded within the base die 2410 of FIG. 24A. For example, logic within the base die that communicates with the fabric can include a version of the fabric interconnect node 2442. Base die logic that can be independently clock or power gated can include a version of the power control 2432 and/or clock control 2434 logic.

Thus, while various examples described herein use the term SOC to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various examples of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).”

Example Core Architectures—In-order and out-of-order core block diagram.

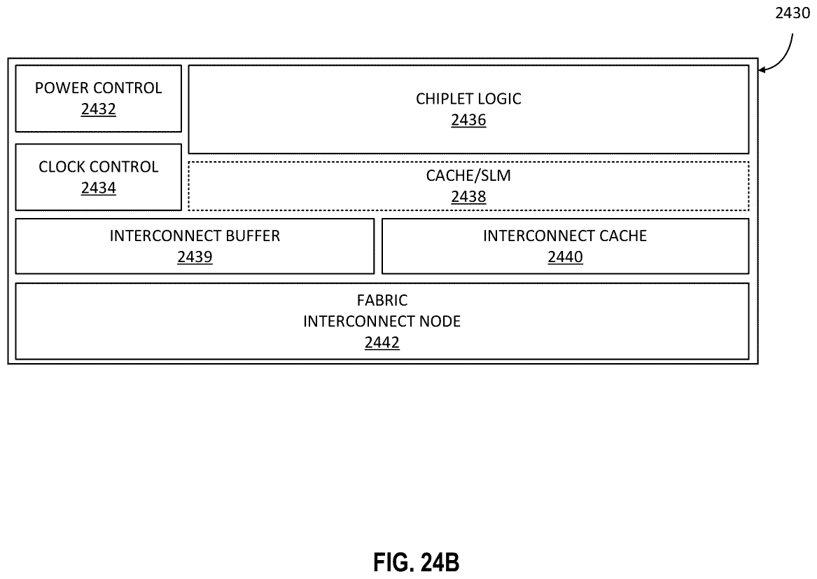

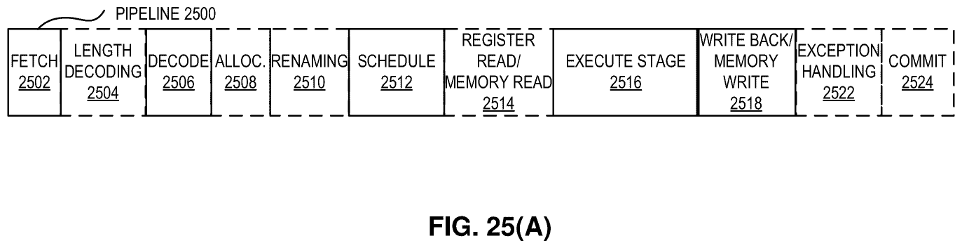

FIG. 25(A) is a block diagram illustrating both an example in-order pipeline and an example register renaming, out-of-order issue/execution pipeline according to examples. FIG. 25(B) is a block diagram illustrating both an example in-order architecture core and an example register renaming, out-of-order issue/execution architecture core to be included in a processor according to examples. The solid lined boxes in FIGS. 25(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 25(A), a processor pipeline 2500 includes a fetch stage 2502, an optional length decoding stage 2504, a decode stage 2506, an optional allocation (Alloc) stage 2508, an optional renaming stage 2510, a schedule (also known as a dispatch or issue) stage 2512, an optional register read/memory read stage 2514, an execute stage 2516, a write back/memory write stage 2518, an optional exception handling stage 2522, and an optional commit stage 2524. One or more operations can be performed in each of these processor pipeline stages. For example, during the fetch stage 2502, one or more instructions are fetched from instruction memory, and during the decode stage 2506, the one or more fetched instructions may be decoded, addresses (e.g., load store unit (LSU) addresses) using forwarded register ports may be generated, and branch forwarding (e.g., immediate offset or a link register (LR)) may be performed. In some examples, the decode stage 2506 and the register read/memory read stage 2514 may be combined into one pipeline stage. In some examples, during the execute stage 2516, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 25(B) may implement the pipeline 2500 as follows: 1) the instruction fetch circuitry 2538 performs the fetch and length decoding stages 2502 and 2504; 2) the decode circuitry 2540 performs the decode stage 2506; 3) the rename/allocator unit circuitry 2552 performs the allocation stage 2508 and renaming stage 2510; 4) the scheduler(s) circuitry 2556 performs the schedule stage 2512; 5) the physical register file(s) circuitry 2558 and the memory unit circuitry 2570 perform the register read/memory read stage 2514; the execution cluster(s) 2560 perform the execute stage 2516; 6) the memory unit circuitry 2570 and the physical register file(s) circuitry 2558 perform the write back/memory write stage 2518; 7) various circuitry may be involved in the exception handling stage 2522; and 8) the retirement unit circuitry 2554 and the physical register file(s) circuitry 2558 perform the commit stage 2524.

FIG. 25(B) shows a processor core 2590 including front-end unit circuitry 2530 coupled to execution engine unit circuitry 2550, and both are coupled to memory unit circuitry 2570. The core 2590 may be a reduced instruction set architecture computing (RISC) core, a complex instruction set architecture computing (CISC) core, a very long instruction word (VLIW) core, or a hybrid or alternative core type. As yet another option, the core 2590 may be a special-purpose core, such as, for example, a network or communication core, compression engine, coprocessor core, general purpose computing graphics processing unit (GPGPU) core, graphics core, or the like.

The front-end unit circuitry 2530 may include branch prediction circuitry 2532 coupled to instruction cache circuitry 2534, which is coupled to an instruction translation lookaside buffer (TLB) 2536, which is coupled to instruction fetch circuitry 2538, which is coupled to decode circuitry 2540. In some examples, the instruction cache circuitry 2534 is included in the memory unit circuitry 2570 rather than the front-end circuitry 2530. The decode circuitry 2540 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 2540 may further include address generation unit (AGU, not shown) circuitry. In some examples, the AGU generates an LSU address using forwarded register ports, and may further perform branch forwarding (e.g., immediate offset branch forwarding, LR register branch forwarding, etc.). The decode circuitry 2540 may be implemented using various different mechanisms. Examples of suitable mechanisms include, but are not limited to, look-up tables, hardware implementations, programmable logic arrays (PLAs), microcode read only memories (ROMs), etc. In some examples, the core 2590 includes a microcode ROM (not shown) or other medium that stores microcode for certain macroinstructions (e.g., in decode circuitry 2540 or otherwise within the front-end circuitry 2530). In some examples, the decode circuitry 2540 includes a micro-operation (micro-op) or operation cache (not shown) to hold/cache decoded operations, micro-tags, or micro-operations generated during the decode or other stages of the processor pipeline 2500. The decode circuitry 2540 may be coupled to rename/allocator unit circuitry 2552 in the execution engine circuitry 2550.

The execution engine circuitry 2550 includes the rename/allocator unit circuitry 2552 coupled to retirement unit circuitry 2554 and a set of one or more scheduler(s) circuitry 2556. The scheduler(s) circuitry 2556 represents any number of different schedulers, including reservations stations, central instruction window, etc. In some examples, the scheduler(s) circuitry 2556 can include arithmetic logic unit (ALU) scheduler/scheduling circuitry, ALU queues, address generation unit (AGU) scheduler/scheduling circuitry, AGU queues, etc. The scheduler(s) circuitry 2556 is coupled to the physical register file(s) circuitry 2558. Each of the physical register file(s) circuitry 2558 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In some examples, the physical register file(s) circuitry 2558 includes vector registers unit circuitry, writemask registers unit circuitry, and scalar register unit circuitry. These register units may provide architectural vector registers, vector mask registers, general-purpose registers, etc. The physical register file(s) circuitry 2558 is coupled to the retirement unit circuitry 2554 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 2554 and the physical register file(s) circuitry 2558 are coupled to the execution cluster(s) 2560. The execution cluster(s) 2560 includes a set of one or more execution unit(s) circuitry 2562 and a set of one or more memory access circuitry 2564. The execution unit(s) circuitry 2562 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 2556, physical register file(s) circuitry 2558, and execution cluster(s) 2560 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 2564). It should also be understood that where separate pipelines are used, one or more of these pipelines may be out-of-order issue/execution and the rest in-order.

In some examples, the execution engine unit circuitry 2550 may perform load store unit (LSU) address/data pipelining to an Advanced Microcontroller Bus (AMB) interface (not shown), and address phase and writeback, data phase load, store, and branches.

The set of memory access circuitry 2564 is coupled to the memory unit circuitry 2570, which includes data TLB circuitry 2572 coupled to data cache circuitry 2574 coupled to level 2 (L2) cache circuitry 2576. In some examples, the memory access circuitry 2564 may include load unit circuitry, store address unit circuitry, and store data unit circuitry, each of which is coupled to the data TLB circuitry 2572 in the memory unit circuitry 2570. The instruction cache circuitry 2534 is further coupled to the level 2 (12) cache circuitry 2576 in the memory unit circuitry 2570. In some examples, the instruction cache 2534 and the data cache 2574 are combined into a single instruction and data cache (not shown) in L2 cache circuitry 2576, level 3 (13) cache circuitry (not shown), and/or main memory. The L2 cache circuitry 2576 is coupled to one or more other levels of cache and eventually to a main memory.

The core 2590 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In some examples, the core 2590 includes logic to support a packed data instruction set architecture extension (e.g., AVX1, AVX2), thereby allowing the operations used by many multimedia applications to be performed using packed data.

### Example Execution Unit(s) Circuitry.

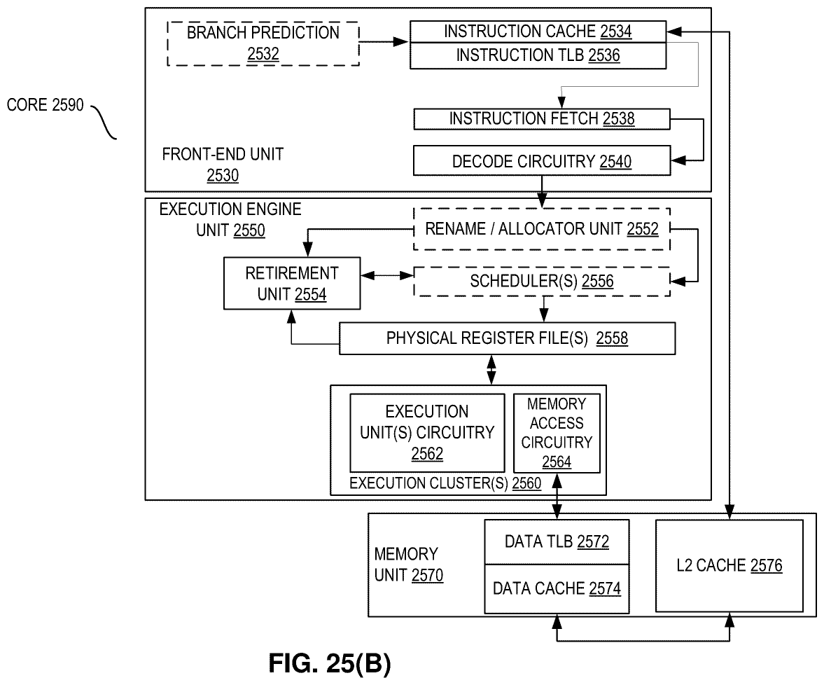

FIG. 26 illustrates examples of execution unit(s) circuitry, such as execution unit(s) circuitry 2562 of FIG. 25(B). As illustrated, execution unit(s) circuitry 2562 may include one or more ALU circuits 2601, optional vector/single instruction multiple data (SIMD) circuits 2603, load/store circuits 2605, branch/jump circuits 2607, and/or Floating-point unit (FPU) circuits 2609. ALU circuits 2601 perform integer arithmetic and/or Boolean operations. Vector/SIMD circuits 2603 perform vector/SIMD operations on packed data (such as SIMD/vector registers). Load/store circuits 2605 execute load and store instructions to load data from memory into registers or store from registers to memory. Load/store circuits 2605 may also generate addresses. Branch/jump circuits 2607 cause a branch or jump to a memory address depending on the instruction. FPU circuits 2609 perform floating-point arithmetic. The width of the execution unit(s) circuitry 2562 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

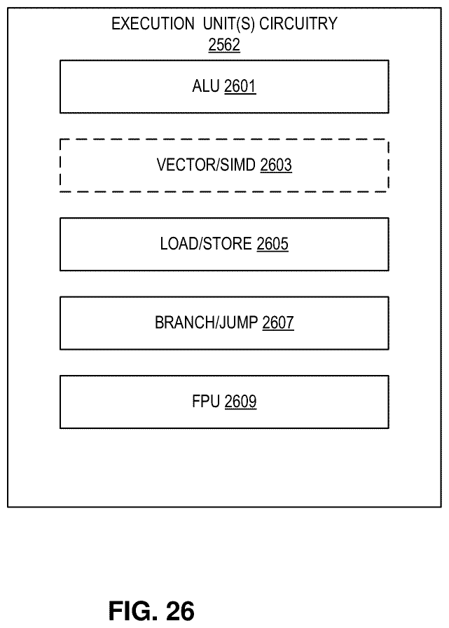

FIG. 27 is a block diagram of a register architecture 2700 according to some examples. As illustrated, the register architecture 2700 includes vector/SIMD registers 2710 that vary from 128-bit to 1,024 bits width. In some examples, the vector/SIMD registers 2710 are physically 512-bits and, depending upon the mapping, only some of the lower bits are used. For example, in some examples, the vector/SIMD registers 2710 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 2700 includes writemask/predicate registers 2715. For example, in some examples, there are 8 writemask/predicate registers (sometimes called k0 through k7) that are each 16-bit, 32-bit, 64-bit, or 128-bit in size. Writemask/predicate registers 2715 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 2715 corresponds to a data element position of the destination. In other examples, the writemask/predicate registers 2715 are scalable and consists of a set number of enable bits for a given vector element (e.g., 8 enable bits per 64-bit vector element).

The register architecture 2700 includes a plurality of general-purpose registers 2725. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 2700 includes scalar floating-point (FP) register file 2745 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 2740 (e.g., EFLAGS, RFLAGS, etc.) store status and control information for arithmetic, compare, and system operations. For example, the one or more flag registers 2740 may store condition code information such as carry, parity, auxiliary carry, zero, sign, and overflow. In some examples, the one or more flag registers 2740 are called program status and control registers.

Segment registers 2720 contain segment points for use in accessing memory. In some examples, these registers are referenced by the names CS, DS, SS, ES, FS, and GS.

Model specific registers or machine specific registers (MSRs) 2735 control and report on processor performance. Most MSRs 2735 handle system-related functions and are not accessible to an application program. For example, MSRs may provide control for one or more of: performance-monitoring counters, debug extensions, memory type range registers, thermal and power management, instruction-specific support, and/or processor feature/mode support. Machine check registers 2760 consist of control, status, and error reporting MSRs that are used to detect and report on hardware errors. Control register(s) 2755 (e.g., CR0-CR4) determine the operating mode of a processor (e.g., processor 1870, 1880, 1838, 1815, and/or 1900) and the characteristics of a currently executing task. In some examples, MSRs 2735 are a subset of control registers 2755.

One or more instruction pointer register(s) 2730 store an instruction pointer value. Debug registers 2750 control and allow for the monitoring of a processor or core's debugging operations.

Memory (mem) management registers 2765 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 2700 may, for example, be used in register file/memory 'ISAB08, or physical register file(s) circuitry 25 58.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats.

Examples of the instruction(s) described herein may be embodied in different formats. Additionally, example systems, architectures, and pipelines are detailed below.

Examples of the instruction(s) may be executed on such systems, architectures, and pipelines, but are not limited to those detailed.

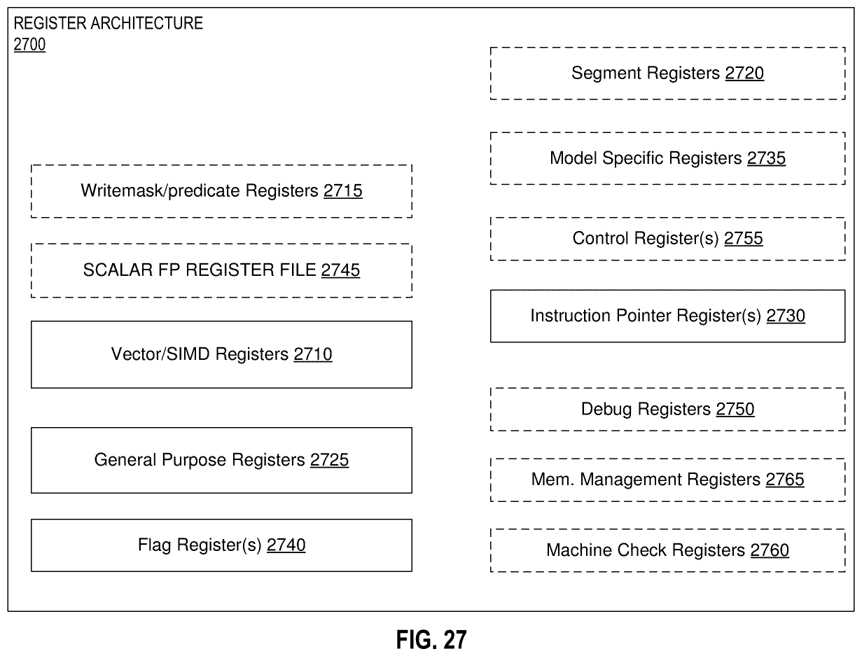

FIG. 28 illustrates examples of an instruction format. As illustrated, an instruction may include multiple components including, but not limited to, one or more fields for: one or more prefixes 2801, an opcode 2803, addressing information 2805 (e.g., register identifiers, memory addressing information, etc.), a displacement value 2807, and/oran immediate value 2809. Note that some instructions utilize some or all the fields of the format whereas others may only use the field for the opcode 2803. In some examples, the order illustrated is the order in which these fields are to be encoded, however, it should be appreciated that in other examples these fields may be encoded in a different order, combined, etc.

The prefix(es) field(s) 2801, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 2803 is used to at least partially define the operation to be performed upon a decoding of the instruction. In some examples, a primary opcode encoded in the opcode field 2803 is one, two, or three bytes in length. In other examples, a primary opcode can be a different length. An additional 3-bit opcode field is sometimes encoded in another field.

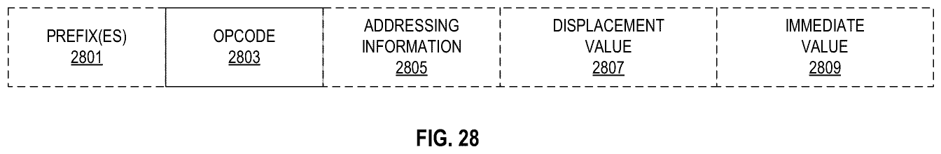

The addressing information field 2805 is used to address one or more operands of the instruction, such as a location in memory or one or more registers. FIG. 29 illustrates examples of the addressing information field 2805. In this illustration, an optional MOD R/M byte 2902 and an optional Scale, Index, Base (SIB) byte 2904 are shown. The MOD R/M byte 2902 and the SIB byte 2904 are used to encode up to two operands of an instruction, each of which is a direct register or effective memory address. Note that both of these fields are optional in that not all instructions include one or more of these fields. The MOD R/M byte 2902 includes a MOD field 2942, a register (reg) field 2944, and R/M field 2946.

The content of the MOD field 2942 distinguishes between memory access and non-memory access modes. In some examples, when the MOD field 2942 has a binary value of 11 (11b), a register-direct addressing mode is utilized, and otherwise a register-indirect addressing mode is used.

The register field 2944 may encode either the destination register operand or a source register operand or may encode an opcode extension and not be used to encode any instruction operand. The content of register field 2944, directly or through address generation, specifies the locations of a source or destination operand (either in a register or in memory). In some examples, the register field 2944 is supplemented with an additional bit from a prefix (e.g., prefix 2801) to allow for greater addressing.

The R/M field 2946 may be used to encode an instruction operand that references a memory address or may be used to encode either the destination register operand or a source register operand. Note the R/M field 2946 may be combined with the MOD field 2942 to dictate an addressing mode in some examples.

The SIB byte 2904 includes a scale field 2952, an index field 2954, and a base field 2956 to be used in the generation of an address. The scale field 2952 indicates a scaling factor. The index field 2954 specifies an index register to use. In some examples, the index field 2954 is supplemented with an additional bit from a prefix (e.g., prefix 2801) to allow for greater addressing. The base field 2956 specifies a base register to use. In some examples, the base field 2956 is supplemented with an additional bit from a prefix (e.g., prefix 2801) to allow for greater addressing. In practice, the content of the scale field 2952 allows for the scaling of the content of the index field 2954 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP) +displacement, register+displacement, etc. The displacement may be a 1-byte, 2-byte, 4-byte, etc. value. In some examples, the displacement field 2807 provides this value. Additionally, in some examples, a displacement factor usage is encoded in the MOD field of the addressing information field 2805 that indicates a compressed displacement scheme for which a displacement value is calculated and stored in the displacement field 2807.

In some examples, the immediate value field 2809 specifies an immediate value for the instruction. An immediate value may be encoded as a 1-byte value, a 2-byte value, a 4-byte value, etc.

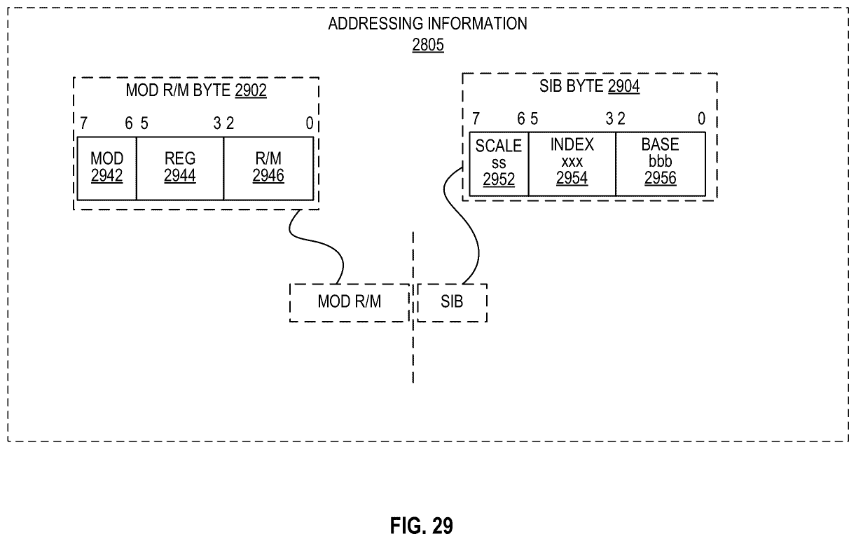

FIG. 30 illustrates examples of a first prefix 2801(A). In some examples, the first prefix 2801(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 2801(A) may specify up to three registers using 3-bit fields depending on the format: 1) using the reg field 2944 and the R/M field 2946 of the MOD R/M byte 2902; 2) using the MOD R/M byte 2902 with the SIB byte 2904 including using the reg field 2944 and the base field 2956 and index field 2954; or 3) using the register field of an opcode.

In the first prefix 2801(A), bit positions of the payload byte 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 2944 and MOD R/M R/M field 2946 alone can each only address 8 registers.

In the first prefix 2801(A), bit position 2 (R) may be an extension of the MOD R/M reg field 2944 and may be used to modify the MOD R/M reg field 2944 when that field encodes a general-purpose register, a 64-bit packed data register (e.g., a SSE register), or a control or debug register. R is ignored when MOD R/M byte 2902 specifies other registers or defines an extended opcode.

Bit position 1 (X) may modify the SIB byte index field 2954.

Bit position 0 (B) may modify the base in the MOD R/M R/M field 2946 or the SIB byte base field 2956; or it may modify the opcode register field used for accessing general purpose registers (e.g., general purpose registers 2725).

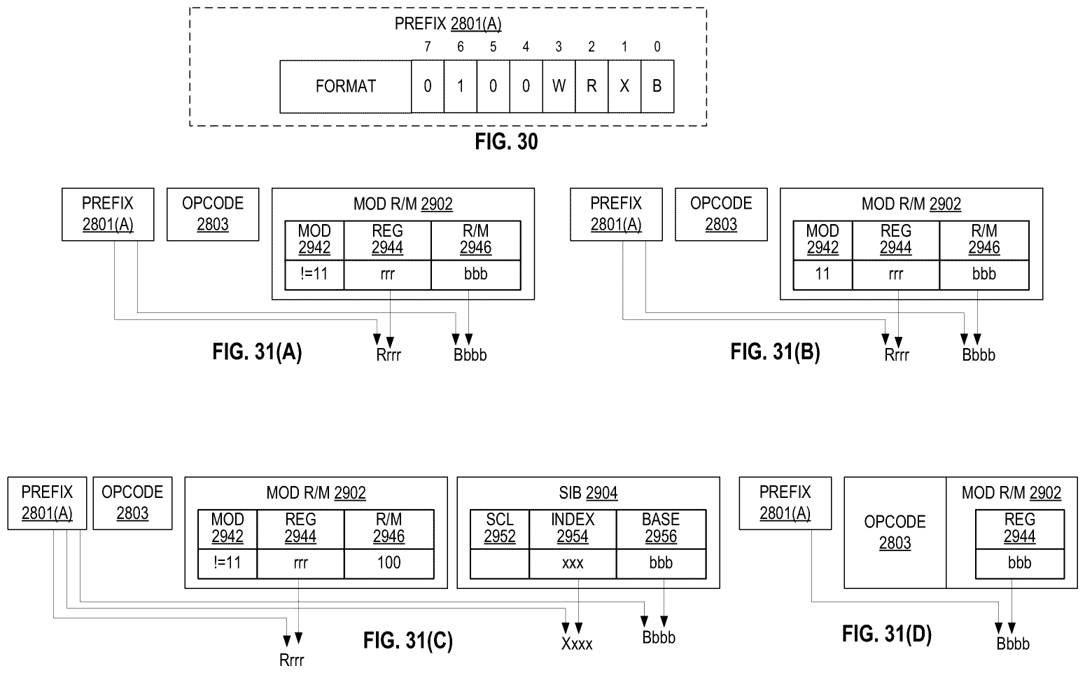

FIGS. 31(A)-(D) illustrate examples of how the R, X, and B fields of the first prefix 2801(A) are used. FIG. 31(A) illustrates R and B from the first prefix 2801(A) being used to extend the reg field 2944 and R/M field 2946 of the MOD R/M byte 2902 when the SIB byte 2904 is not used for memory addressing. FIG. 31(B) illustrates R and B from the first prefix 2801(A) being used to extend the reg field 2944 and R/M field 2946 of the MOD R/M byte 2902 when the SIB byte 2904 is not used (register-register addressing). FIG. 31(C) illustrates R, X, and B from the first prefix 2801(A) being used to extend the reg field 2944 of the MOD R/M byte 2902 and the index field 2954 and base field 2956 when the SIB byte 2904 being used for memory addressing. FIG. 31(D) illustrates B from the first prefix 2801(A) being used to extend the reg field 2944 of the MOD R/M byte 2902 when a register is encoded in the opcode 2803.

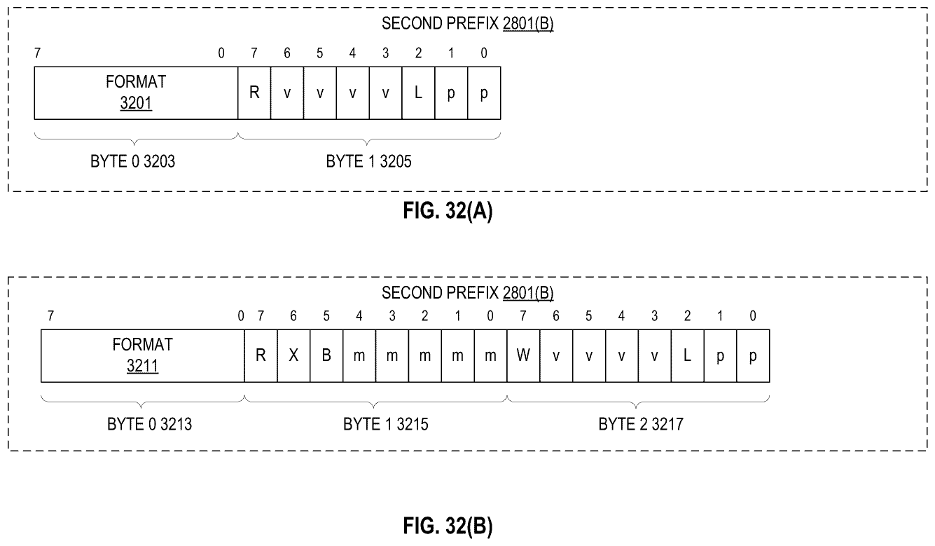

FIGS. 32(A)-(B) illustrate examples of a second prefix 2801(B). In some examples, the second prefix 2801(B) is an example of a VEX prefix. The second prefix 2801(B) encoding allows instructions to have more than two operands, and allows SIMD vector registers (e.g., vector/SIMD registers 2710) to be longer than 64-bits (e.g., 128-bit and 256-bit). The use of the second prefix 2801(B) provides for three-operand (or more) syntax. For example, previous two-operand instructions performed operations such as A=A+B, which overwrites a source operand. The use of the second prefix 2801(B) enables operands to perform nondestructive operations such as A=B+C.

In some examples, the second prefix 2801(B) comes in two forms—a two-byte form and a three-byte form. The two-byte second prefix 2801(B) is used mainly for 128-bit, scalar, and some 256-bit instructions; while the three-byte second prefix 2801(B) provides a compact replacement of the first prefix 2801(A) and 3-byte opcode instructions.

FIG. 32(A) illustrates examples of a two-byte form of the second prefix 2801(B). In some examples, a format field 3201 (byte 0 3203) contains the value C5H. In some examples, byte 1 3205 includes an “R” value in bit[7]. This value is the complement of the “R” value of the first prefix 2801(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 2946 to encode the instruction operand that references a memory address or encode either the destination register operand or a source register operand.

Instructions that use this prefix may use the MOD R/M reg field 2944 to encode either the destination register operand or a source register operand, or to be treated as an opcode extension and not used to encode any instruction operand.

For instruction syntax that support four operands, vvvv, the MOD R/M R/M field 2946 and the MOD R/M reg field 2944 encode three of the four operands. Bits[7:4] of the immediate value field 2809 are then used to encode the third source register operand.

FIG. 32(B) illustrates examples of a three-byte form of the second prefix 2801(B). In some examples, a format field 3211 (byte 0 3213) contains the value C4H. Byte 1 3215 includes in bits[7:5] “R,” “X,” and “B” which are the complements of the same values of the first prefix 2801(A). Bits[4:0] of byte 1 3215 (shown as mmmmm) include content to encode, as need, one or more implied leading opcode bytes. For example, 00001 implies a 0FH leading opcode, 00010 implies a 0F38H leading opcode, 00011 implies a 0F3AH leading opcode, etc.

Bit[7] of byte 2 3217 is used similar to W of the first prefix 2801(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in is complement form for certain vector shifts; or 3) not encode any operand, the field is reserved and should contain a certain value, such as 1111b.

Instructions that use this prefix may use the MOD R/M R/M field 2946 to encode the instruction operand that references a memory address or encode either the destination register operand or a source register operand.

Instructions that use this prefix may use the MOD R/M reg field 2944 to encode either the destination register operand or a source register operand, or to be treated as an opcode extension and not used to encode any instruction operand.

For instruction syntax that support four operands, vvvv, the MOD R/M R/M field 2946, and the MOD R/M reg field 2944 encode three of the four operands. Bits[7:4] of the immediate value field 2809 are then used to encode the third source register operand.

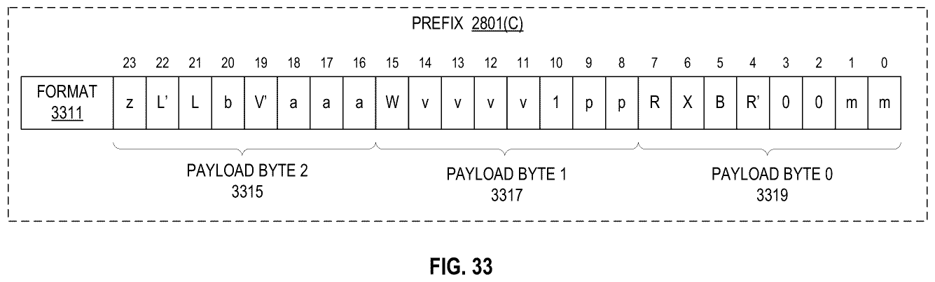

FIG. 33 illustrates examples of a third prefix 2801(C). In some examples, the third prefix 2801(C) is an example of an EVEX prefix. The third prefix 2801(C) is a four-byte prefix.

The third prefix 2801(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 27) or predication utilize this prefix. Opmask register allow for conditional processing or selection control. Opmask instructions, whose source/destination operands are opmask registers and treat the content of an opmask register as a single value, are encoded using the second prefix 2801(B).

The third prefix 2801(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 2801(C) is a format field 3311 that has a value, in some examples, of 62H. Subsequent bytes are referred to as payload bytes 3315-3319 and collectively form a 24-bit value of P[23:0] providing specific capability in the form of one or more fields (detailed herein).

In some examples, P[1:0] of payload byte 3319 are identical to the low two mm bits.

P[3:2] are reserved in some examples. Bit P[4] (R′) allows access to the high 16 vector register set when combined with P[7] and the MOD R/M reg field 2944. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 2944 and MOD R/M R/M field 2946. P[9:8] provide opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (1s complement) form and valid for instructions with 2 or more source operands; 2) encode the destination register operand, specified in is complement form for certain vector shifts; or 3) not encode any operand, the field is reserved and should contain a certain value, such as 1111b.

P[15] is similar to W of the first prefix 2801(A) and second prefix 2811(B) and may serve as an opcode extension bit or operand size promotion.

P[18:16] specify the index of a register in the opmask (writemask) registers (e.g., writemask/predicate registers 2715). In some examples, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other some examples, preserving the old value of each element of the destination where the corresponding mask bit has a 0. In contrast, when zeroing vector masks allow any set of elements in the destination to be zeroed during the execution of any operation (specified by the base operation and the augmentation operation); in some examples, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19].

P[20] encodes multiple functionalities, which differs across different classes of instructions and can affect the meaning of the vector length/rounding control specifier field (P1[22:21]).

P[23] indicates support for merging-writemasking (e.g., when set to 0) or support for zeroing and merging-writemasking (e.g., when set to 1).

Example examples of encoding of registers in instructions using the third prefix 2801(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | MOD R/M | GPR, Vector | Destination or Source |
| | | | reg | | |
| VVVV | V′ | vvvv | | GPR, Vector | 2nd Source or |
| | | | | | Destination |
| RM | X | B | MOD R/M | GPR, Vector | 1st Source or |
| | | | R/M | | Destination |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory |
| | | | | | addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

### Graphics Execution Units

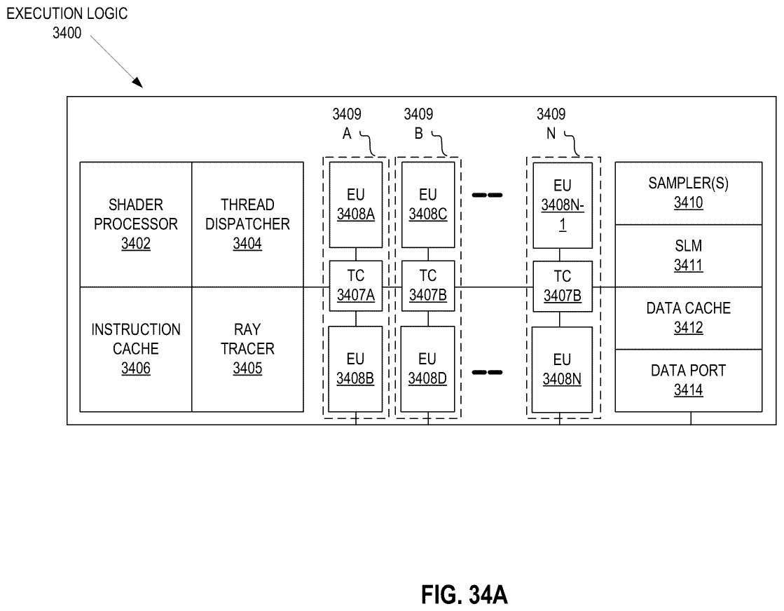

FIGS. 34A-34B illustrate thread execution logic 3400 including an array of processing elements employed in a graphics processor core according to examples described herein.

Elements of FIGS. 34A-34B having the same reference numbers (or names) as the elements of any other figure herein can operate or function in any manner similar to that described elsewhere herein, but are not limited to such. FIG. 34A is representative of an execution unit within a general-purpose graphics processor, while FIG. 34B is representative of an execution unit that may be used within a compute accelerator.

As illustrated in FIG. 34A, in some examples thread execution logic 3400 includes a shader processor 3402, a thread dispatcher 3404, instruction cache 3406, a scalable execution unit array including a plurality of execution units 3408A-3408N, a sampler 3410, shared local memory 3411, a data cache 3412, and a data port 3414. In some examples the scalable execution unit array can dynamically scale by enabling or disabling one or more execution units (e.g., any of execution units 3408A, 3408B, 3408C, 3408D, through 3408N−1 and 3408N) based on the computational requirements of a workload. In some examples the included components are interconnected via an interconnect fabric that links to each of the components. In some examples, thread execution logic 3400 includes one or more connections to memory, such as system memory or cache memory, through one or more of instruction cache 3406, data port 3414, sampler 3410, and execution units 3408A-3408N. In some examples, each execution unit (e.g. 3408A) is a stand-alone programmable general-purpose computational unit that is capable of executing multiple simultaneous hardware threads while processing multiple data elements in parallel for each thread. In various examples, the array of execution units 3408A-3408N is scalable to include any number individual execution units.

In some examples, the execution units 3408A-3408N are primarily used to execute shader programs. A shader processor 3402 can process the various shader programs and dispatch execution threads associated with the shader programs via a thread dispatcher 3404.

In some examples the thread dispatcher includes logic to arbitrate thread initiation requests from the graphics and media pipelines and instantiate the requested threads on one or more execution unit in the execution units 3408A-3408N. For example, a geometry pipeline can dispatch vertex, tessellation, or geometry shaders to the thread execution logic for processing. In some examples, thread dispatcher 3404 can also process runtime thread spawning requests from the executing shader programs.

In some examples, the execution units 3408A-3408N support an instruction set that includes native support for many standard 3D graphics shader instructions, such that shader programs from graphics libraries (e.g., Direct 3D and OpenGL) are executed with a minimal translation. The execution units support vertex and geometry processing (e.g., vertex programs, geometry programs, vertex shaders), pixel processing (e.g., pixel shaders, fragment shaders) and general-purpose processing (e.g., compute and media shaders). Each of the execution units 3408A-3408N is capable of multi-issue single instruction multiple data (SIMD) execution and multi-threaded operation enables an efficient execution environment in the face of higher latency memory accesses. Each hardware thread within each execution unit has a dedicated high-bandwidth register file and associated independent thread-state. Execution is multi-issue per clock to pipelines capable of integer, single and double precision floating point operations, SIMD branch capability, logical operations, transcendental operations, and other miscellaneous operations. While waiting for data from memory or one of the shared functions, dependency logic within the execution units 3408A-3408N causes a waiting thread to sleep until the requested data has been returned. While the waiting thread is sleeping, hardware resources may be devoted to processing other threads. For example, during a delay associated with a vertex shader operation, an execution unit can perform operations for a pixel shader, fragment shader, or another type of shader program, including a different vertex shader. Various examples can apply to use execution by use of Single Instruction Multiple Thread (SIMT) as an alternate to use of SIMD or in addition to use of SIMD. Reference to a SIMD core or operation can apply also to SIMT or apply to SIMD in combination with SIMT.

Each execution unit in execution units 3408A-3408N operates on arrays of data elements. The number of data elements is the “execution size,” or the number of channels for the instruction. An execution channel is a logical unit of execution for data element access, masking, and flow control within instructions. The number of channels may be independent of the number of physical Arithmetic Logic Units (ALUs) or Floating Point Units (FPUs) for a particular graphics processor. In some examples, execution units 3408A-3408N support integer and floating-point data types.

The execution unit instruction set includes SIMD instructions. The various data elements can be stored as a packed data type in a register and the execution unit will process the various elements based on the data size of the elements. For example, when operating on a 256-bit wide vector, the 256 bits of the vector are stored in a register and the execution unit operates on the vector as four separate 64-bit packed data elements (Quad-Word (QW) size data elements), eight separate 32-bit packed data elements (Double Word (DW) size data elements), sixteen separate 16-bit packed data elements (Word (W) size data elements), or thirty-two separate 8-bit data elements (byte (B) size data elements). However, different vector widths and register sizes are possible.

In some examples one or more execution units can be combined into a fused execution unit 3409A-3409N having thread control logic (3407A-3407N) that is common to the fused EUs. Multiple EUs can be fused into an EU group. Each EU in the fused EU group can be configured to execute a separate SIMD hardware thread. The number of EUs in a fused EU group can vary according to examples. Additionally, various SIMD widths can be performed per-EU, including but not limited to SIMD8, SIMD16, and SIMD32. Each fused graphics execution unit 3409A-3409N includes at least two execution units. For example, fused execution unit 3409A includes a first EU 3408A, second EU 3408B, and thread control logic 3407A that is common to the first EU 3408A and the second EU 3408B. The thread control logic 3407A controls threads executed on the fused graphics execution unit 3409A, allowing each EU within the fused execution units 3409A-3409N to execute using a common instruction pointer register.

One or more internal instruction caches (e.g., 3406) are included in the thread execution logic 3400 to cache thread instructions for the execution units. In some examples, one or more data caches (e.g., 3412) are included to cache thread data during thread execution. Threads executing on the execution logic 3400 can also store explicitly managed data in the shared local memory 3411. In some examples, a sampler 3410 is included to provide texture sampling for 3D operations and media sampling for media operations. In some examples, sampler 3410 includes specialized texture or media sampling functionality to process texture or media data during the sampling process before providing the sampled data to an execution unit.

During execution, the graphics and media pipelines send thread initiation requests to thread execution logic 3400 via thread spawning and dispatch logic. Once a group of geometric objects has been processed and rasterized into pixel data, pixel processor logic (e.g., pixel shader logic, fragment shader logic, etc.) within the shader processor 3402 is invoked to further compute output information and cause results to be written to output surfaces (e.g., color buffers, depth buffers, stencil buffers, etc.). In some examples, a pixel shader or fragment shader calculates the values of the various vertex attributes that are to be interpolated across the rasterized object. In some examples, pixel processor logic within the shader processor 3402 then executes an application programming interface (API)-supplied pixel or fragment shader program. To execute the shader program, the shader processor 3402 dispatches threads to an execution unit (e.g., 3408A) via thread dispatcher 3404. In some examples, shader processor 3402 uses texture sampling logic in the sampler 3410 to access texture data in texture maps stored in memory. Arithmetic operations on the texture data and the input geometry data compute pixel color data for each geometric fragment, or discards one or more pixels from further processing.

In some examples, the data port 3414 provides a memory access mechanism for the thread execution logic 3400 to output processed data to memory for further processing on a graphics processor output pipeline. In some examples, the data port 3414 includes or couples to one or more cache memories (e.g., data cache 3412) to cache data for memory access via the data port.

In some examples, the execution logic 3400 can also include a ray tracer 3405 that can provide ray tracing acceleration functionality. The ray tracer 3405 can support a ray tracing instruction set that includes instructions/functions for ray generation.

FIG. 34B illustrates exemplary internal details of an execution unit 3408, according to examples. A graphics execution unit 3408 can include an instruction fetch unit 3437, a general register file array (GRF) 3424, an architectural register file array (ARF) 3426, a thread arbiter 3422, a send unit 3430, a branch unit 3432, a set of SIMD floating point units (FPUs) 3434, and in some examples a set of dedicated integer SIMD ALUs 3435. The GRF 3424 and ARF 3426 includes the set of general register files and architecture register files associated with each simultaneous hardware thread that may be active in the graphics execution unit 3408. In some examples, per thread architectural state is maintained in the ARF 3426, while data used during thread execution is stored in the GRF 3424. The execution state of each thread, including the instruction pointers for each thread, can be held in thread-specific registers in the ARF 3426.

In some examples the graphics execution unit 3408 has an architecture that is a combination of Simultaneous Multi-Threading (SMT) and fine-grained Interleaved Multi-Threading (IMT). The architecture has a modular configuration that can be fine-tuned at design time based on a target number of simultaneous threads and number of registers per execution unit, where execution unit resources are divided across logic used to execute multiple simultaneous threads. The number of logical threads that may be executed by the graphics execution unit 3408 is not limited to the number of hardware threads, and multiple logical threads can be assigned to each hardware thread.

In some examples, the graphics execution unit 3408 can co-issue multiple instructions, which may each be different instructions. The thread arbiter 3422 of the graphics execution unit thread 3408 can dispatch the instructions to one of the send unit 3430, branch unit 3432, or SIMD FPU(s) 3434 for execution. Each execution thread can access 128 general-purpose registers within the GRF 3424, where each register can store 32 bytes, accessible as a SIMD 8-element vector of 32-bit data elements. In some examples, each execution unit thread has access to 4 Kbytes within the GRF 3424, although examples are not so limited, and greater or fewer register resources may be provided in other examples. In some examples the graphics execution unit 3408 is partitioned into seven hardware threads that can independently perform computational operations, although the number of threads per execution unit can also vary according to examples. For example, in some examples up to 16 hardware threads are supported. In an example in which seven threads may access 4 Kbytes, the GRF 3424 can store a total of 28 Kbytes. Where 16 threads may access 4 Kbytes, the GRF 3424 can store a total of 64 Kbytes. Flexible addressing modes can permit registers to be addressed together to build effectively wider registers or to represent strided rectangular block data structures.

In some examples, memory operations, sampler operations, and other longer-latency system communications are dispatched via “send” instructions that are executed by the message passing send unit 3430. In some examples, branch instructions are dispatched to a dedicated branch unit 3432 to facilitate SIMD divergence and eventual convergence.

In some examples the graphics execution unit 3408 includes one or more SIMD floating point units (FPU(s)) 3434 to perform floating-point operations. In some examples, the FPU(s) 3434 also support integer computation. In some examples the FPU(s) 3434 can SIMD execute up to M number of 32-bit floating-point (or integer) operations, or SIMD execute up to 2M 16-bit integer or 16-bit floating-point operations. In some examples, at least one of the FPU(s) provides extended math capability to support high-throughput transcendental math functions and double precision 64-bit floating-point. In some examples, a set of 8-bit integer SIMD ALUs 3435 are also present, and may be specifically optimized to perform operations associated with machine learning computations.

In some examples, arrays of multiple instances of the graphics execution unit 3408 can be instantiated in a graphics sub-core grouping (e.g., a sub-slice). For scalability, product architects can choose the exact number of execution units per sub-core grouping. In some examples the execution unit 3408 can execute instructions across a plurality of execution channels. In a further example, each thread executed on the graphics execution unit 3408 is executed on a different channel.

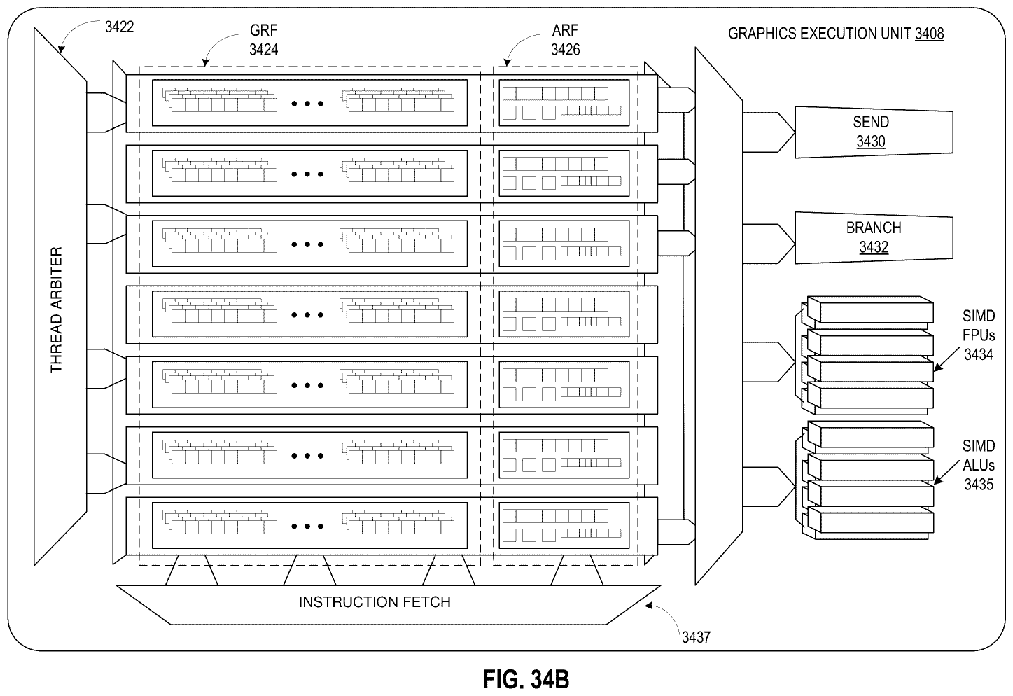

FIG. 35 illustrates an additional execution unit 3500, according to an example. In some examples, the execution unit 3500 includes a thread control unit 3501, a thread state unit 3502, an instruction fetch/prefetch unit 3503, and an instruction decode unit 3504. The execution unit 3500 additionally includes a register file 3506 that stores registers that can be assigned to hardware threads within the execution unit. The execution unit 3500 additionally includes a send unit 3507 and a branch unit 3508. In some examples, the send unit 3507 and branch unit 3508 can operate similarly as the send unit 3430 and a branch unit 3432 of the graphics execution unit 3408 of FIG. 34B.

The execution unit 3500 also includes a compute unit 3510 that includes multiple different types of functional units. In some examples the compute unit 3510 includes an ALU unit 3511 that includes an array of arithmetic logic units. The ALU unit 3511 can be configured to perform 64-bit, 32-bit, and 16-bit integer and floating point operations. Integer and floating point operations may be performed simultaneously. The compute unit 3510 can also include a systolic array 3512, and a math unit 3513. The systolic array 3512 includes a W wide and D deep network of data processing units that can be used to perform vector or other data-parallel operations in a systolic manner. In some examples the systolic array 3512 can be configured to perform matrix operations, such as matrix dot product operations. In some examples the systolic array 3512 support 16-bit floating point operations, as well as 8-bit and 4-bit integer operations. In some examples the systolic array 3512 can be configured to accelerate machine learning operations. In such examples, the systolic array 3512 can be configured with support for the bfloat 16-bit floating point format. In some examples, a math unit 3513 can be included to perform a specific subset of mathematical operations in an efficient and lower-power manner than ALU unit 3511. The math unit 3513 can include a variant of math logic that may be found in shared function logic of a graphics processing engine provided by other examples (e.g., math logic 422 of the shared function logic 420 of FIG. 4). In some examples the math unit 3513 can be configured to perform 32-bit and 64-bit floating point operations.

The thread control unit 3501 includes logic to control the execution of threads within the execution unit. The thread control unit 3501 can include thread arbitration logic to start, stop, and preempt execution of threads within the execution unit 3500. The thread state unit 3502 can be used to store thread state for threads assigned to execute on the execution unit 3500. Storing the thread state within the execution unit 3500 enables the rapid preemption of threads when those threads become blocked or idle. The instruction fetch/prefetch unit 3503 can fetch instructions from an instruction cache of higher level execution logic (e.g., instruction cache 3406 as in FIG. 34A). The instruction fetch/prefetch unit 3503 can also issue prefetch requests for instructions to be loaded into the instruction cache based on an analysis of currently executing threads. The instruction decode unit 3504 can be used to decode instructions to be executed by the compute units. In some examples, the instruction decode unit 3504 can be used as a secondary decoder to decode complex instructions into constituent micro-operations.

The execution unit 3500 additionally includes a register file 3506 that can be used by hardware threads executing on the execution unit 3500. Registers in the register file 3506 can be divided across the logic used to execute multiple simultaneous threads within the compute unit 3510 of the execution unit 3500. The number of logical threads that may be executed by the graphics execution unit 3500 is not limited to the number of hardware threads, and multiple logical threads can be assigned to each hardware thread. The size of the register file 3506 can vary across examples based on the number of supported hardware threads. In some examples, register renaming may be used to dynamically allocate registers to hardware threads.

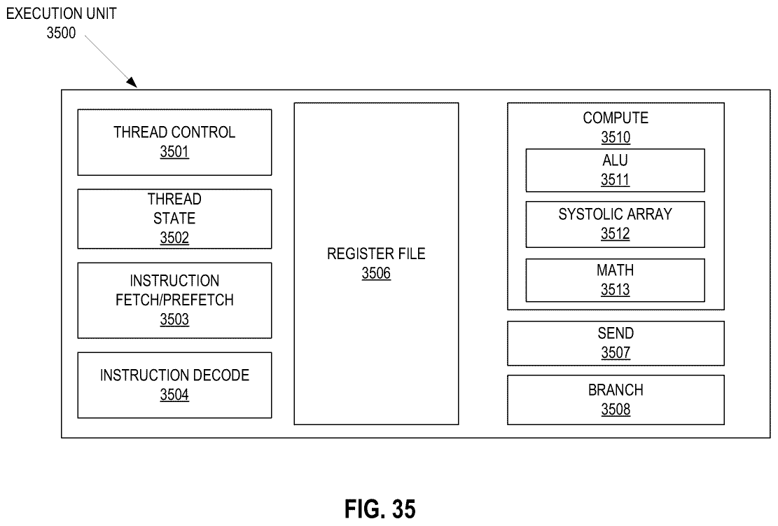

FIG. 36 is a block diagram illustrating a graphics processor instruction formats 3600 according to some examples. In one or more example, the graphics processor execution units support an instruction set having instructions in multiple formats. The solid lined boxes illustrate the components that are generally included in an execution unit instruction, while the dashed lines include components that are optional or that are only included in a sub-set of the instructions. In some examples, instruction format 3600 described and illustrated are macro-instructions, in that they are instructions supplied to the execution unit, as opposed to micro-operations resulting from instruction decode once the instruction is processed.

In some examples, the graphics processor execution units natively support instructions in a 128-bit instruction format 3610. A 64-bit compacted instruction format 3630 is available for some instructions based on the selected instruction, instruction options, and number of operands. The native 128-bit instruction format 3610 provides access to all instruction options, while some options and operations are restricted in the 64-bit format 3630. The native instructions available in the 64-bit format 3630 vary by example. In some examples, the instruction is compacted in part using a set of index values in an index field 3613. The execution unit hardware references a set of compaction tables based on the index values and uses the compaction table outputs to reconstruct a native instruction in the 128-bit instruction format 3610. Other sizes and formats of instruction can be used.

For each format, instruction opcode 3612 defines the operation that the execution unit is to perform. The execution units execute each instruction in parallel across the multiple data elements of each operand. For example, in response to an add instruction the execution unit performs a simultaneous add operation across each color channel representing a texture element or picture element. By default, the execution unit performs each instruction across all data channels of the operands. In some examples, instruction control field 3614 enables control over certain execution options, such as channels selection (e.g., predication) and data channel order (e.g., swizzle). For instructions in the 128-bit instruction format 3610 an exec-size field 3616 limits the number of data channels that will be executed in parallel. In some examples, exec-size field 3616 is not available for use in the 64-bit compact instruction format 3630.

Some execution unit instructions have up to three operands including two source operands, src0 3620, src1 3622, and one destination 3618. In some examples, the execution units support dual destination instructions, where one of the destinations is implied. Data manipulation instructions can have a third source operand (e.g., SRC2 3624), where the instruction opcode 3612 determines the number of source operands. An instruction's last source operand can be an immediate (e.g., hard-coded) value passed with the instruction.

In some examples, the 128-bit instruction format 3610 includes an access/address mode field 3626 specifying, for example, whether direct register addressing mode or indirect register addressing mode is used. When direct register addressing mode is used, the register address of one or more operands is directly provided by bits in the instruction.

In some examples, the 128-bit instruction format 3610 includes an access/address mode field 3626, which specifies an address mode and/or an access mode for the instruction. In some examples the access mode is used to define a data access alignment for the instruction. Some examples support access modes including a 16-byte aligned access mode and a 1-byte aligned access mode, where the byte alignment of the access mode determines the access alignment of the instruction operands. For example, when in a first mode, the instruction may use byte-aligned addressing for source and destination operands and when in a second mode, the instruction may use 16-byte-aligned addressing for all source and destination operands.

In some examples, the address mode portion of the access/address mode field 3626 determines whether the instruction is to use direct or indirect addressing. When direct register addressing mode is used bits in the instruction directly provide the register address of one or more operands. When indirect register addressing mode is used, the register address of one or more operands may be computed based on an address register value and an address immediate field in the instruction.

In some examples instructions are grouped based on opcode 3612 bit-fields to simplify Opcode decode 3640. For an 8-bit opcode, bits 4, 5, and 6 allow the execution unit to determine the type of opcode. The precise opcode grouping shown is merely an example. In some examples, a move and logic opcode group 3642 includes data movement and logic instructions (e.g., move (mov), compare (cmp)). In some examples, move and logic group 3642 shares the five most significant bits (MSB), where move (mov) instructions are in the form of 0000xxxxb and logic instructions are in the form of 0001xxxxb. A flow control instruction group 3644 (e.g., call, jump (jmp)) includes instructions in the form of 0010xxxxb (e.g., 0x20). A miscellaneous instruction group 3646 includes a mix of instructions, including synchronization instructions (e.g., wait, send) in the form of 0011xxxxb (e.g., 0x30). A parallel math instruction group 3648 includes component-wise arithmetic instructions (e.g., add, multiply (mul)) in the form of 0100xxxxb (e.g., 0x40). The parallel math group 3648 performs the arithmetic operations in parallel across data channels. The vector math group 3650 includes arithmetic instructions (e.g., dp4) in the form of 0101xxxxb (e.g., 0x50). The vector math group performs arithmetic such as dot product calculations on vector operands. The illustrated opcode decode 3640, in some examples, can be used to determine which portion of an execution unit will be used to execute a decoded instruction. For example, some instructions may be designated as systolic instructions that will be performed by a systolic array. Other instructions, such as ray-tracing instructions (not shown) can be routed to a ray-tracing core or ray-tracing logic within a slice or partition of execution logic.

### Graphics Pipeline

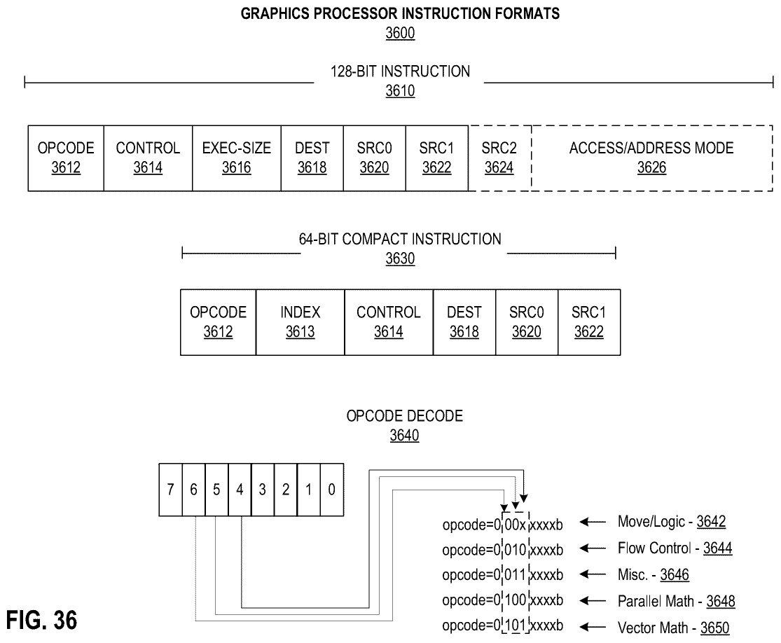

FIG. 37 is a block diagram of another example of a graphics processor 3700. Elements of FIG. 37 having the same reference numbers (or names) as the elements of any other figure herein can operate or function in any manner similar to that described elsewhere herein, but are not limited to such.

In some examples, graphics processor 3700 includes a geometry pipeline 3720, a media pipeline 3730, a display engine 3740, thread execution logic 3750, and a render output pipeline 3770. In some examples, graphics processor 3700 is a graphics processor within a multi-core processing system that includes one or more general-purpose processing cores.

The graphics processor is controlled by register writes to one or more control registers (not shown) or via commands issued to graphics processor 3700 via a ring interconnect 3702. In some examples, ring interconnect 3702 couples graphics processor 3700 to other processing components, such as other graphics processors or general-purpose processors. Commands from ring interconnect 3702 are interpreted by a command streamer 3703, which supplies instructions to individual components of the geometry pipeline 3720 or the media pipeline 3730.

In some examples, command streamer 3703 directs the operation of a vertex fetcher 3705 that reads vertex data from memory and executes vertex-processing commands provided by command streamer 3703. In some examples, vertex fetcher 3705 provides vertex data to a vertex shader 3707, which performs coordinate space transformation and lighting operations to each vertex. In some examples, vertex fetcher 3705 and vertex shader 3707 execute vertex-processing instructions by dispatching execution threads to execution units 3752A-3752B via a thread dispatcher 3731.

In some examples, execution units 3752A-3752B are an array of vector processors having an instruction set for performing graphics and media operations. In some examples, execution units 3752A-3752B have an attached L1 cache 3751 that is specific for each array or shared between the arrays. The cache can be configured as a data cache, an instruction cache, or a single cache that is partitioned to contain data and instructions in different partitions.

In some examples, geometry pipeline 3720 includes tessellation components to perform hardware-accelerated tessellation of 3D objects. In some examples, a programmable hull shader 3711 configures the tessellation operations. A programmable domain shader 3717 provides back-end evaluation of tessellation output. A tessellator 3713 operates at the direction of hull shader 3711 and contains special purpose logic to generate a set of detailed geometric objects based on a coarse geometric model that is provided as input to geometry pipeline 3720. In some examples, if tessellation is not used, tessellation components (e.g., hull shader 3711, tessellator 3713, and domain shader 3717) can be bypassed.

In some examples, complete geometric objects can be processed by a geometry shader 3719 via one or more threads dispatched to execution units 3752A-3752B, or can proceed directly to the clipper 3729. In some examples, the geometry shader operates on entire geometric objects, rather than vertices or patches of vertices as in previous stages of the graphics pipeline. If the tessellation is disabled the geometry shader 3719 receives input from the vertex shader 3707. In some examples, geometry shader 3719 is programmable by a geometry shader program to perform geometry tessellation if the tessellation units are disabled.

Before rasterization, a clipper 3729 processes vertex data. The clipper 3729 may be a fixed function clipper or a programmable clipper having clipping and geometry shader functions. In some examples, a rasterizer and depth test component 3773 in the render output pipeline 3770 dispatches pixel shaders to convert the geometric objects into per pixel representations. In some examples, pixel shader logic is included in thread execution logic 3750. In some examples, an application can bypass the rasterizer and depth test component 3773 and access un-rasterized vertex data via a stream out unit 3723.

The graphics processor 3700 has an interconnect bus, interconnect fabric, or some other interconnect mechanism that allows data and message passing amongst the major components of the processor. In some examples, execution units 3752A-3752B and associated logic units (e.g., L1 cache 3751, sampler 3754, texture cache 3758, etc.) interconnect via a data port 3756 to perform memory access and communicate with render output pipeline components of the processor. In some examples, sampler 3754, caches 3751, 3758 and execution units 3752A-3752B each have separate memory access paths. In some examples the texture cache 3758 can also be configured as a sampler cache.

In some examples, render output pipeline 3770 contains a rasterizer and depth test component 3773 that converts vertex-based objects into an associated pixel-based representation. In some examples, the rasterizer logic includes a windower/masker unit to perform fixed function triangle and line rasterization. An associated render cache 3778 and depth cache 3779 are also available in some examples. A pixel operations component 3777 performs pixel-based operations on the data, though in some instances, pixel operations associated with 2D operations (e.g. bit block image transfers with blending) are performed by the 2D engine 3741, or substituted at display time by the display controller 3743 using overlay display planes. In some examples, a shared L3 cache 3775 is available to all graphics components, allowing the sharing of data without the use of main system memory.

In some examples, graphics processor media pipeline 3730 includes a media engine 3737 and a video front-end 3734. In some examples, video front-end 3734 receives pipeline commands from the command streamer 3703. In some examples, media pipeline 3730 includes a separate command streamer. In some examples, video front-end 3734 processes media commands before sending the command to the media engine 3737. In some examples, media engine 3737 includes thread spawning functionality to spawn threads for dispatch to thread execution logic 3750 via thread dispatcher 3731.

In some examples, graphics processor 3700 includes a display engine 3740. In some examples, display engine 3740 is external to processor 3700 and couples with the graphics processor via the ring interconnect 3702, or some other interconnect bus or fabric. In some examples, display engine 3740 includes a 2D engine 3741 and a display controller 3743. In some examples, display engine 3740 contains special purpose logic capable of operating independently of the 3D pipeline. In some examples, display controller 3743 couples with a display device (not shown), which may be a system integrated display device, as in a laptop computer, or an external display device attached via a display device connector.

In some examples, the geometry pipeline 3720 and media pipeline 3730 are configurable to perform operations based on multiple graphics and media programming interfaces and are not specific to any one application programming interface (API). In some examples, driver software for the graphics processor translates API calls that are specific to a particular graphics or media library into commands that can be processed by the graphics processor. In some examples, support is provided for the Open Graphics Library (OpenGL), Open Computing Language (OpenCL), and/or Vulkan graphics and compute API, all from the Khronos Group. In some examples, support may also be provided for the Direct3D library from the Microsoft Corporation. In some examples, a combination of these libraries may be supported. Support may also be provided for the Open Source Computer Vision Library (OpenCV). A future API with a compatible 3D pipeline would also be supported if a mapping can be made from the pipeline of the future API to the pipeline of the graphics processor.

### Graphics Pipeline Programming

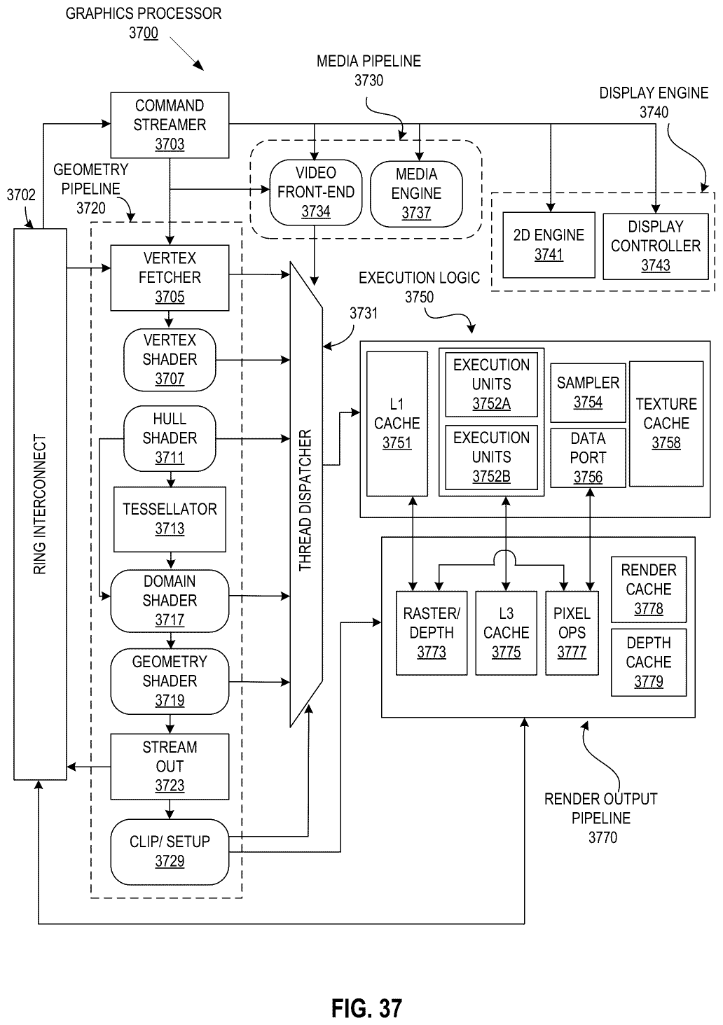

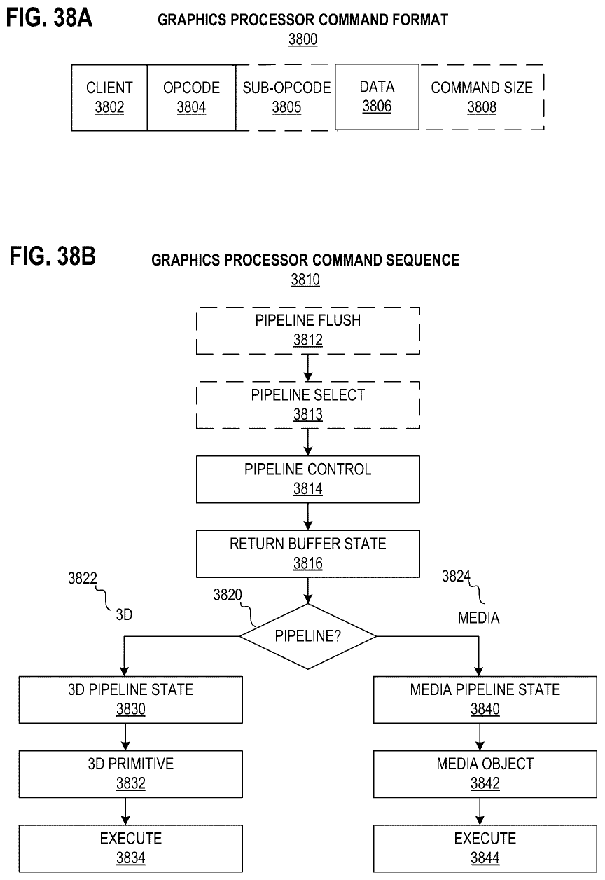

FIG. 38A is a block diagram illustrating a graphics processor command format 3800 according to some examples. FIG. 38B is a block diagram illustrating a graphics processor command sequence 3810 according to an example. The solid lined boxes in FIG. 38A illustrate the components that are generally included in a graphics command while the dashed lines include components that are optional or that are only included in a sub-set of the graphics commands. The exemplary graphics processor command format 3800 of FIG. 38A includes data fields to identify a client 3802, a command operation code (opcode) 3804, and data 3806 for the command. A sub-opcode 3805 and a command size 3808 are also included in some commands.

In some examples, client 3802 specifies the client unit of the graphics device that processes the command data. In some examples, a graphics processor command parser examines the client field of each command to condition the further processing of the command and route the command data to the appropriate client unit. In some examples, the graphics processor client units include a memory interface unit, a render unit, a 2D unit, a 3D unit, and a media unit. Each client unit has a corresponding processing pipeline that processes the commands. Once the command is received by the client unit, the client unit reads the opcode 3804 and, if present, sub-opcode 3805 to determine the operation to perform. The client unit performs the command using information in data field 3806. For some commands an explicit command size 3808 is expected to specify the size of the command. In some examples, the command parser automatically determines the size of at least some of the commands based on the command opcode. In some examples commands are aligned via multiples of a double word. Other command formats can be used.

The flow diagram in FIG. 38B illustrates an exemplary graphics processor command sequence 3810. In some examples, software or firmware of a data processing system that features an example of a graphics processor uses a version of the command sequence shown to set up, execute, and terminate a set of graphics operations. A sample command sequence is shown and described for purposes of example only as examples are not limited to these specific commands or to this command sequence. Moreover, the commands may be issued as batch of commands in a command sequence, such that the graphics processor will process the sequence of commands in at least partially concurrence.

In some examples, the graphics processor command sequence 3810 may begin with a pipeline flush command 3812 to cause any active graphics pipeline to complete the currently pending commands for the pipeline. In some examples, the 3D pipeline 3822 and the media pipeline 3824 do not operate concurrently. The pipeline flush is performed to cause the active graphics pipeline to complete any pending commands. In response to a pipeline flush, the command parser for the graphics processor will pause command processing until the active drawing engines complete pending operations and the relevant read caches are invalidated. Optionally, any data in the render cache that is marked ‘dirty’ can be flushed to memory. In some examples, pipeline flush command 3812 can be used for pipeline synchronization or before placing the graphics processor into a low power state.

In some examples, a pipeline select command 3813 is used when a command sequence requires the graphics processor to explicitly switch between pipelines. In some examples, a pipeline select command 3813 is required only once within an execution context before issuing pipeline commands unless the context is to issue commands for both pipelines. In some examples, a pipeline flush command 3812 is required immediately before a pipeline switch via the pipeline select command 3813.

In some examples, a pipeline control command 3814 configures a graphics pipeline for operation and is used to program the 3D pipeline 3822 and the media pipeline 3824. In some examples, pipeline control command 3814 configures the pipeline state for the active pipeline. In some examples, the pipeline control command 3814 is used for pipeline synchronization and to clear data from one or more cache memories within the active pipeline before processing a batch of commands.

In some examples, return buffer state commands 3816 are used to configure a set of return buffers for the respective pipelines to write data. Some pipeline operations require the allocation, selection, or configuration of one or more return buffers into which the operations write intermediate data during processing. In some examples, the graphics processor also uses one or more return buffers to store output data and to perform cross thread communication. In some examples, the return buffer state 3816 includes selecting the size and number of return buffers to use for a set of pipeline operations.

The remaining commands in the command sequence differ based on the active pipeline for operations. Based on a pipeline determination 3820, the command sequence is tailored to the 3D pipeline 3822 beginning with the 3D pipeline state 3830 or the media pipeline 3824 beginning at the media pipeline state 3840.

The commands to configure the 3D pipeline state 3830 include 3D state setting commands for vertex buffer state, vertex element state, constant color state, depth buffer state, and other state variables that are to be configured before 3D primitive commands are processed. The values of these commands are determined at least in part based on the particular 3D API in use. In some examples, 3D pipeline state 3830 commands are also able to selectively disable or bypass certain pipeline elements if those elements will not be used.

In some examples, 3D primitive 3832 command is used to submit 3D primitives to be processed by the 3D pipeline. Commands and associated parameters that are passed to the graphics processor via the 3D primitive 3832 command are forwarded to the vertex fetch function in the graphics pipeline. The vertex fetch function uses the 3D primitive 3832 command data to generate vertex data structures. The vertex data structures are stored in one or more return buffers. In some examples, 3D primitive 3832 command is used to perform vertex operations on 3D primitives via vertex shaders. To process vertex shaders, 3D pipeline 3822 dispatches shader execution threads to graphics processor execution units.

In some examples, 3D pipeline 3822 is triggered via an execute 3834 command or event. In some examples, a register write triggers command execution. In some examples execution is triggered via a ‘go’ or ‘kick’ command in the command sequence. In some examples, command execution is triggered using a pipeline synchronization command to flush the command sequence through the graphics pipeline. The 3D pipeline will perform geometry processing for the 3D primitives. Once operations are complete, the resulting geometric objects are rasterized and the pixel engine colors the resulting pixels. Additional commands to control pixel shading and pixel back end operations may also be included for those operations.

In some examples, the graphics processor command sequence 3810 follows the media pipeline 3824 path when performing media operations. In general, the specific use and manner of programming for the media pipeline 3824 depends on the media or compute operations to be performed. Specific media decode operations may be offloaded to the media pipeline during media decode. In some examples, the media pipeline can also be bypassed and media decode can be performed in whole or in part using resources provided by one or more general-purpose processing cores. In some examples, the media pipeline also includes elements for general-purpose graphics processor unit (GPGPU) operations, where the graphics processor is used to perform SIMD vector operations using computational shader programs that are not explicitly related to the rendering of graphics primitives.

In some examples, media pipeline 3824 is configured in a similar manner as the 3D pipeline 3822. A set of commands to configure the media pipeline state 3840 are dispatched or placed into a command queue before the media object commands 3842. In some examples, commands for the media pipeline state 3840 include data to configure the media pipeline elements that will be used to process the media objects. This includes data to configure the video decode and video encode logic within the media pipeline, such as encode or decode format. In some examples, commands for the media pipeline state 3840 also support the use of one or more pointers to “indirect” state elements that contain a batch of state settings.

In some examples, media object commands 3842 supply pointers to media objects for processing by the media pipeline. The media objects include memory buffers containing video data to be processed. In some examples, all media pipeline states must be valid before issuing a media object command 3842. Once the pipeline state is configured and media object commands 3842 are queued, the media pipeline 3824 is triggered via an execute command 3844 or an equivalent execute event (e.g., register write). Output from media pipeline 3824 may then be post processed by operations provided by the 3D pipeline 3822 or the media pipeline 3824. In some examples, GPGPU operations are configured and executed in a similar manner as media operations.

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof.

The instruction converter may be on processor, off processor, or part on and part off processor.

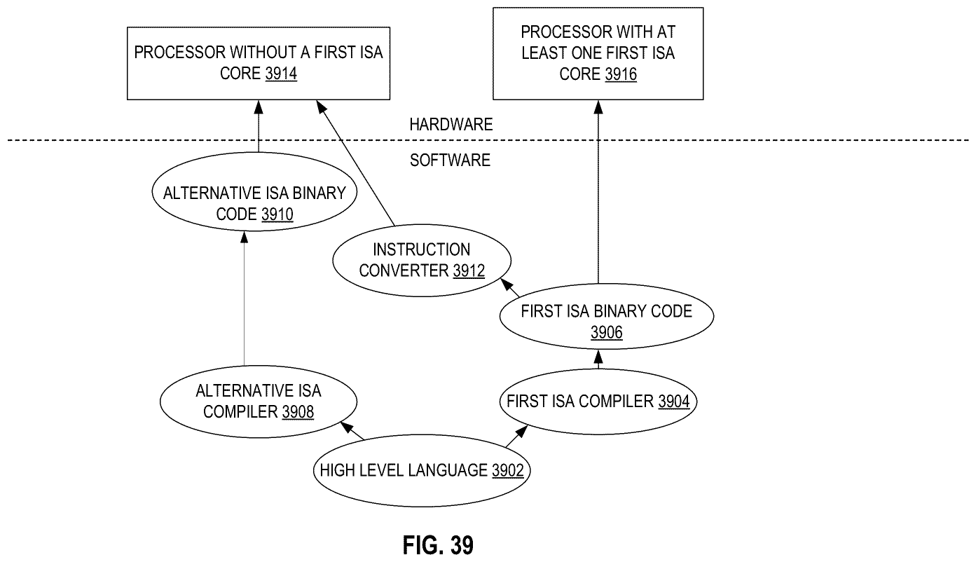

FIG. 39 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 39 shows a program in a high-level language 3902 may be compiled using a first ISA compiler 3904 to generate first ISA binary code 3906 that may be natively executed by a processor with at least one first ISA core 3916. The processor with at least one first ISA core 3916 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 3904 represents a compiler that is operable to generate first ISA binary code 3906 (e.g., object code) that can, with or without additional linkage processing, be executed on the processor with at least one first ISA core 3916. Similarly, FIG. 39 shows the program in the high-level language 3902 may be compiled using an alternative ISA compiler 3908 to generate alternative ISA binary code 3910 that may be natively executed by a processor without a first ISA core 3914. The instruction converter 3912 is used to convert the first ISA binary code 3906 into code that may be natively executed by the processor without a first ISA core 3914. This converted code is not necessarily to be the same as the alternative ISA binary code 3910; however, the converted code will accomplish the general operation and be made up of instructions from the alternative ISA.

Thus, the instruction converter 3912 represents software, firmware, hardware, or a combination thereof that, through emulation, simulation or any other process, allows a processor or other electronic device that does not have a first ISA processor or core to execute the first ISA binary code 3906.

### IP Core Implementations

One or more aspects of at least some examples may be implemented by representative code stored on a machine-readable medium which represents and/or defines logic within an integrated circuit such as a processor. For example, the machine-readable medium may include instructions which represent various logic within the processor. When read by a machine, the instructions may cause the machine to fabricate the logic to perform the techniques described herein. Such representations, known as “IP cores,” are reusable units of logic for an integrated circuit that may be stored on a tangible, machine-readable medium as a hardware model that describes the structure of the integrated circuit. The hardware model may be supplied to various customers or manufacturing facilities, which load the hardware model on fabrication machines that manufacture the integrated circuit. The integrated circuit may be fabricated such that the circuit performs operations described in association with any of the examples described herein.

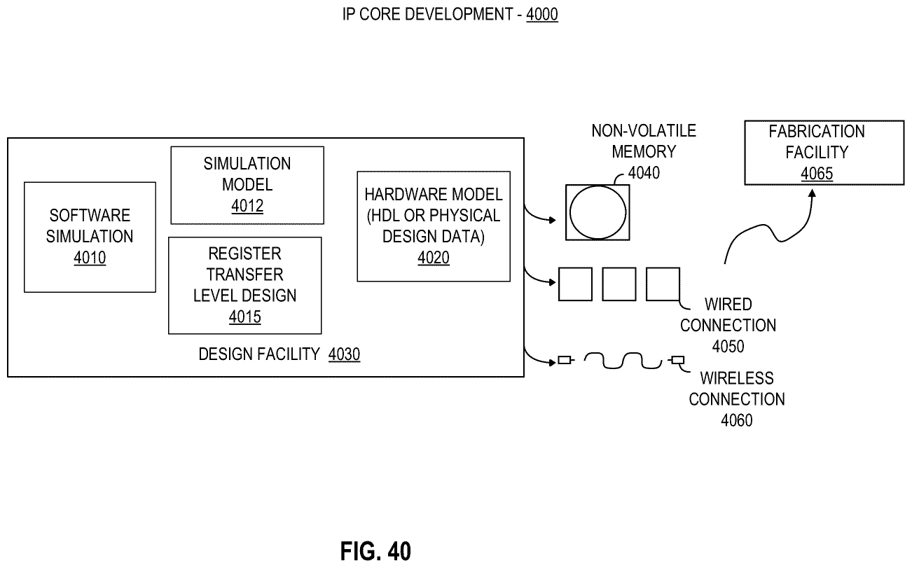

FIG. 40 is a block diagram illustrating an IP core development system 4000 that may be used to manufacture an integrated circuit to perform operations according to some examples. The IP core development system 4000 may be used to generate modular, re-usable designs that can be incorporated into a larger design or used to construct an entire integrated circuit (e.g., an SOC integrated circuit). A design facility 4030 can generate a software simulation 4010 of an IP core design in a high-level programming language (e.g., C/C++). The software simulation 4010 can be used to design, test, and verify the behavior of the IP core using a simulation model 4012. The simulation model 4012 may include functional, behavioral, and/or timing simulations. A register transfer level (RTL) design 4015 can then be created or synthesized from the simulation model 4012. The RTL design 4015 is an abstraction of the behavior of the integrated circuit that models the flow of digital signals between hardware registers, including the associated logic performed using the modeled digital signals. In addition to an RTL design 4015, lower-level designs at the logic level or transistor level may also be created, designed, or synthesized. Thus, the particular details of the initial design and simulation may vary.

The RTL design 4015 or equivalent may be further synthesized by the design facility into a hardware model 4020, which may be in a hardware description language (HDL), or some other representation of physical design data. The HDL may be further simulated or tested to verify the IP core design. The IP core design can be stored for delivery to a 3 party fabrication facility 4065 using non-volatile memory 4040 (e.g., hard disk, flash memory, or any non-volatile storage medium). Alternatively, the IP core design may be transmitted (e.g., via the Internet) over a wired connection 4050 or wireless connection 4060. The fabrication facility 4065 may then fabricate an integrated circuit that is based at least in part on the IP core design. The fabricated integrated circuit can be configured to perform operations in accordance with at least some examples described herein.

References to “some examples,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Examples include, but are not limited to:

1. An apparatus comprising:
decoder circuitry to decode an instance of a single instruction, the instance of the single instruction to include an opcode that is to indicate to execution circuitry to perform a binding of information to a platform by encrypting at least a portion of information of an input data structure with a platform-specific wrapping key;
execution circuitry to execute the decoded instance of the single instruction according to the opcode to generate and store an output data structure.

2. The apparatus of example 1, wherein an address for the input data structure is to be provided by an implicit operand.

3. The apparatus of any of examples 1-2, wherein a format for the input data structure and the output data structure comprises a field for a message authentication code (MAC), a field for an initialization vector, a field for encryption data, and a field for control and data.

4. The apparatus of example 3, wherein an initialization vector and encryption data of the input data structure are to be encrypted in the output data structure.

5. The apparatus of example 4, wherein the encryption data of the input data structure is plaintext.

6. The apparatus of example 5, wherein the plaintext data comprises two 256-bit keys.

7. The apparatus of example 6, wherein the control and data of the input data structure comprises a challenge and a key generation control.

8. The apparatus of example 7, wherein the two 256-bit keys are to be exclusive Ored with a with random keys when the key generation control has a value of 1.

9. The apparatus of example 3, wherein the initialization vector of the output data structure is to be a randomly generated value.

10. The apparatus of any of examples 1-9, wherein a zero flag is set to 0 when the execution of the instance of the single instruction is successfully completed.

11. A method comprising:
decoding an instance of a single instruction, the instance of the single instruction to include an opcode that is to indicate to execution circuitry to perform a binding of information to a platform by encrypting at least a portion of information of an input data structure with a platform-specific wrapping key;
executing the decoded instance of the single instruction according to the opcode to generate and store an output data structure.

12. The method of example 11, wherein an address for the input data structure is to be provided by an implicit operand.

13. The method of any of examples 11-12, wherein a zero flag is set to 0 when the execution of the instance of the single instruction is successfully completed.

14. The method of any of examples 11-13, wherein a format for the input data structure and the output data structure comprises a field for a message authentication code (MAC), a field for an initialization vector, a field for encryption data, and a field for control and data.

15. The method of example 14, wherein an initialization vector and encryption data of the input data structure are to be encrypted in the output data structure.

16. The method of example 14, wherein the encryption data of the input data structure is plaintext two 256-bit keys.

17. The method of example 16, wherein the control and data of the input data structure comprises a challenge and a key generation control.

18. The method of example 17, wherein the two 256-bit keys are to be exclusive Ored with a with random keys when the key generation control has a value of 1.

19. A system comprising:
memory to at least store an instance of a single instruction;
decoder circuitry to decode an instance of the single instruction, the instance of the single instruction to include an opcode that is to indicate to execution circuitry to perform a binding of information to a platform by encrypting at least a portion of information of an input data structure with a platform-specific wrapping key;
execution circuitry to execute the decoded instance of the single instruction according to the opcode to generate and store an output data structure.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
decoder circuitry to decode an instance of a single instruction, the instance of the single instruction to include an opcode that is to indicate to execution circuitry to perform a binding of information to a platform by encrypting at least a portion of information of an input data structure with a platform-specific wrapping key; and
execution circuitry to execute the decoded instance of the single instruction according to the opcode to generate and store an output data structure.

2. The apparatus of claim 1, wherein an address for the input data structure is to be provided by an implicit operand.

3. The apparatus of claim 1, wherein a format for the input data structure and the output data structure comprises a field for a message authentication code (MAC), a field for an initialization vector, a field for encryption data, and a field for control and data.

4. The apparatus of claim 3, wherein an initialization vector and encryption data of the input data structure are to be encrypted in the output data structure.

5. The apparatus of claim 4, wherein the encryption data of the input data structure is plaintext.

6. The apparatus of claim 5, wherein the plaintext data comprises two 256-bit keys.

7. The apparatus of claim 6, wherein the control and data of the input data structure comprises a challenge and a key generation control.

8. The apparatus of claim 7, wherein the two 256-bit keys are to be exclusive Ored with a with random keys when the key generation control has a value of 1.

9. The apparatus of claim 3, wherein the initialization vector of the output data structure is to be a randomly generated value.

10. The apparatus of claim 1, wherein a zero flag is set to 0 when the execution of the instance of the single instruction is successfully completed.

11. A method comprising:
decoding an instance of a single instruction, the instance of the single instruction to include an opcode that is to indicate to execution circuitry to perform a binding of information to a platform by encrypting at least a portion of information of an input data structure with a platform-specific wrapping key; and
executing the decoded instance of the single instruction according to the opcode to generate and store an output data structure.

12. The method of claim 11, wherein an address for the input data structure is to be provided by an implicit operand.

13. The method of claim 11, wherein a zero flag is set to 0 when the execution of the instance of the single instruction is successfully completed.

14. The method of claim 11, wherein a format for the input data structure and the output data structure comprises a field for a message authentication code (MAC), a field for an initialization vector, a field for encryption data, and a field for control and data.

15. The method of claim 14, wherein an initialization vector and encryption data of the input data structure are to be encrypted in the output data structure.

16. The method of claim 14, wherein the encryption data of the input data structure is plaintext two 256-bit keys.

17. The method of claim 16, wherein the control and data of the input data structure comprises a challenge and a key generation control.

18. The method of claim 17, wherein the two 256-bit keys are to be exclusive Ored with a with random keys when the key generation control has a value of 1.

19. A system comprising:
memory to at least store an instance of a single instruction;
decoder circuitry to decode an instance of the single instruction, the instance of the single instruction to include an opcode that is to indicate to execution circuitry to perform a binding of information to a platform by encrypting at least a portion of information of an input data structure with a platform-specific wrapping key; and
execution circuitry to execute the decoded instance of the single instruction according to the opcode to generate and store an output data structure.
